(19) United States
(12) Patent Application Publication
(10) Pub. No.: US 2019/0089579 A1
(43) Pub. Date: Mar. 21, 2019

(54) METHOD AND APPARATUS FOR A UNIFIED RADIO LINK FAILURE

(71) Applicant: FutureWei Technologies, Inc., Plano, TX (US)

(72) Inventors: Aimin Justin Sang, San Diego, CA (US); Bin Liu, San Diego, CA (US); Xuelong Wang, Beijing (CN); Qinghai Zeng, Shenzhen (CN)

(21) Appl. No.: 16/133,486

(22) Filed: Sep. 17, 2018

Related U.S. Application Data
(63) Continuation of application No. 16/111,034, filed on Aug. 23, 2018.
Application No. 16/111,034 is a continuation-in-part of application No. PCT/US2018/039368, filed on Jun. 25, 2018.
(60) Provisional application No. 62/557,052, filed on Sep. 11, 2017.
(60) Provisional application No. 62/524,362, filed on Jun. 23, 2017.

(51) Int. Cl. H04L 12/24; H04L 12/26

(52) U.S. Cl. CPC H04L 41/0668; H04L 43/08

(57) ABSTRACT

A method is provided for radio link failure (RLF) operations based on link failure recovery (LR), beam failure recovery (BFR) and radio link monitoring (RLM), and for unifying indications from modules for BFR/LR or RLM to RLF, or vice versa. The method is applicable to downlink at a user equipment, or to uplink at a network device, or to any direct links of a peer-to-peer network device. Based on configured criteria, the unification method combines or filters multiple indications and measured link metrics from multiple paths of each module or from multiple modules, and sends the filtered or combined results from a physical layer of the device to assist the RLF operations. Similar RLF operations may utilize the upper layer status to generate downwards indications to assist lower-layer RLM or BFR/LR operations.

### CROSS-REFERENCE TO RELATED APPLICATIONS

This application is a continuation of U.S. patent application Ser. No. 16/111,034 filed on Aug. 23, 2018 and entitled “System and Method for Radio Link Monitoring and Radio Link Recovery”, which is a continuation-in-part application of PCT Application Serial No. PCT/US18/39368, which claims the benefit of priority to U.S. Provisional Patent Application Ser. No. 62/524,362 filed on Jun. 23, 2017 and entitled “System and Method for a Unified RLF Detection and Full-Diversity BFR Mechanism in NR”, and U.S. Provisional Patent Application Ser. No. 62/557,052 filed on Sep. 11, 2017 and entitled “System and Method for a Unified RLF Detection and Full-Diversity BFR Mechanism in NR”, the contents of which are incorporated by reference in their entirety.

### TECHNICAL FIELD

The present disclosure relates to the field of communications networks, and in particular, a system and method for radio link failure (RLF) detection, radio link recovery (RLR), beam failure recovery (BFR), and radio link monitoring (RLM).

### BACKGROUND

Wireless communications systems are widely employed to provide various communications services to user equipments (UEs). A wireless communications system may include a plurality of base stations (BSs), each providing wireless communications services to multiple UEs over radio links in a coverage area. A radio link between a BS and a UE in a network may deteriorate in quality to a level that communications between the BS and the UE may not be able to continue. In this case, the UE may declare a radio link failure (RLF), and determine that a radio resource control (RRC) reestablishment is needed for connecting the UE to the network. Conventionally, the RLF is an upper layer process, and radio link monitoring (RLM) may be performed in a physical layer, which generates link indications and sends the link indications to the RLF within a device. The RLF is a relatively slow and costly process that involves over-the-air radio resource control (RRC) signaling.

This background information is intended to provide information that may be of possible relevance to the present disclosure. No admission is necessarily intended, nor should be construed, that any of the preceding information constitutes prior art against the present disclosure.

### SUMMARY

It is an object of the present disclosure to obviate or mitigate at least one disadvantage of the prior art, and to propose a solution to new design issues of new radio systems.

Technical advantages are generally achieved, by embodiments of this disclosure which describe a system and method for radio link monitoring and link (failure) recovery.

According to one aspect of the present disclosure, there is provided a method for radio link failure operations. The method includes: measuring, by a user equipment (UE), a reference signal received over one or more network-configured communication paths of a radio link extending between the user UE and one or more network devices in a wireless network; receiving at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the UE; unifying at least the first network-configured indication and the second network-configured indication according to a network configuration to obtain a unified network-configured indication; and performing a radio link failure operation according to the unified network-configured indication.

Optionally, in any of the preceding aspects, the first network-configured indication and the second network-configured indication are unified at the RLF module, a radio link monitoring (RLM) module, or a beam failure recovery (BFR) or link recovery (LR) (BFR/LR) module.

Optionally, in any of the preceding aspects, the first network-configured indication and the second network-configured indication are unified in a distributed manner across different protocol layers.

Optionally, in any of the preceding aspects, the first network-configured indication and the second network-configured indication are unified in a distributed manner across multiple paths.

Optionally, in any of the preceding aspects, the network configuration requires that the first network-configured indication and the second network-configured indication are used as direct inputs to the radio link failure operation.

Optionally, in any of the preceding aspects, the network configuration requires that the first network-configured indication and the second network-configured indication are used as inputs to the radio link failure operation only after unification of the first network-configured indication and the second network-configured indication.

Optionally, in any of the preceding aspects, the network configuration requires that a link recovery success status indication is converted into one or multiple in-sync (IS) indications or a link recovery failure indication is converted into one or multiple out-of-sync (OOS) indications.

Optionally, in any of the preceding aspects, the network configuration requires that a link recovery operation generated link connectivity indication is replaced with one or more in-sync (IS) indications or out-of-sync (OOS) indications.

Optionally, in any of the preceding aspects, the network configuration requires that a link recovery in-sync (IS) indication or out-of-sync (OOS) indication is treated as a weighted RLM indication in the unification, the weight being a digital number or a linear scalar.

Optionally, in any of the preceding aspects, the network configuration requires that one or more BFR/LR generated in-sync (IS) indications or out-of-sync (OOS) indications are used to modify periodic RLM IS or OOS indications or to modify an RLF state machine.

Optionally, in any of the preceding aspects, unifying the first network-configured indication and the second network-configured indication further includes: combining or filtering at least the first network-configured indication and the second network-configured indication using logic or mathematical operations, or combining or filtering the assessed radio link quality over a mathematical summation of multiple paths or over a moving-average of any specific path, and assessing the combined or filtered radio link quality corresponding to a configured criterion.

Optionally, in any of the preceding aspects, the method further includes the network configuration for: determining filtering and combination parameters for link quality states over the one or more network-configured communication paths, the RLM module, the BFR/LR module; or determining filtering and combination parameters for the one or more network-configured indications based on configuration(s) of the RLM module, the BFR/LR module, the one or more network-configured communication paths, or combinations thereof, wherein performing the radio link failure operation according to the one or more network-configured indications and the network configuration comprises filtering or combining the one or more network-configured indications in accordance with the filtering and combination parameters.

Optionally, in any of the preceding aspects, the method further includes: selecting a location of unification operations at the RLF module, the RLM module, the BFR/LR module; selecting an application of the unification operations to a specific one of the one or more network-configured communication paths; selecting a module or path for sending the unified indications to the RLF module after performance of the RLM or BFR/LR operation; determining whether the one or more network-configured indications are to be reported in series or parallel by a specific one of the RLF module or the BFR/LR module; or configuring parameters of an RLF state machine based on the one or more network-configured indications.

According to another aspect of the present disclosure, there is provided a user equipment (UE) that includes: a processor; and a non-transitory computer readable storage medium storing programming for execution by the processor. The programming includes instructions to: measure a reference signal received over one or more network-configured communication paths of a radio link extending between a user equipment (UE) and one or more network devices in a wireless network; receive at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the UE; and unify the first network-configured indication and the second network-configured indication according to the network configuration.

Optionally, in any of the preceding aspects, the first network-configured indication and the second network-configured indication are unified at the RLF module, a radio link monitoring (RLM) module, or a beam failure recovery (BFR) or link recovery (LR) (BFR/LR) module.

Optionally, in any of the preceding aspects, the first network-configured indication and the second network-configured indication are unified in a distributed manner across different protocol layers.

Optionally, in any of the preceding aspects, the first network-configured indication and the second network-configured indication are unified in a distributed manner across multiple paths.

Optionally, in any of the preceding aspects, the network configuration requires that the first network-configured indication and the second network-configured indication are used as direct inputs to a radio link failure operation.

Optionally, in any of the preceding aspects, the network configuration requires that the first network-configured indication and the second network-configured indication are used as inputs to a radio link failure operation only after unification of the first network-configured indication and the second network-configured indication.

Optionally, in any of the preceding aspects, the network configuration requires that a link recovery success status indication is converted into one or multiple in-sync (IS) indications or a link recovery failure indication is converted into one or multiple out-of-sync (OOS) indications.

Optionally, in any of the preceding aspects, the network configuration requires that a link recovery operation generated link connectivity indication is replaced with one or more in-sync (IS) indications or out-of-sync (OOS) indications.

Optionally, in any of the preceding aspects, the network configuration requires that a link recovery in-sync (IS) indication or out-of-sync (OOS) indication is treated as a weighted RLM indication, the weight being a digital number or a linear scalar.

According to yet another aspect of the present disclosure, there is provided a method for radio link failure operations. The method includes: measuring, by a network device, a reference signal received over one or more network-configured communication paths of a radio link extending between the network device and one or more user equipments (UEs) in a wireless network; receiving at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the network device; unifying at least the first network-configured indication and the second network-configured indication according to a network configuration to obtain a unified network-configured indication; and performing a radio link failure operation according to the unified network-configured indication.

According to yet another aspect of the present disclosure, there is provided a network device that includes: a processor; and a non-transitory computer readable storage medium storing programming for execution by the processor. The programming includes instructions to: measure, by a network device, a reference signal received over one or more network-configured communication paths of a radio link extending between the network device and one or more user equipments (UEs) in a wireless network; receive at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the network device; unify at least the first network-configured indication and the second network-configured indication according to a network configuration to obtain a unified network-configured indication; and perform a radio link failure operation according to the unified network-configured indication.

According to yet another aspect of the present disclosure, there is provided a method for radio link failure (RLF) operations. The method includes: sending, by an RLF module in a device, an RLF status message indicating an RLF, radio resource control (RRC), radio link control (RLC), random access channel (RACH), sounding, or handover states to either a radio link monitoring (RLM) module or a beam failure recovery (BFR) or link recovery (LR) (BFR/LR) module of the device, wherein the RLF status message instructs the RLM module or the BFR/LR module to modify an RLM or BFR/LR operation according to the RLF, RRC, RLC, RACH, sounding, or handover states of a user equipment (UE), the device being either the UE or a network device serving the UE.

Optionally, in any of the preceding aspects, the device is the network device.

Optionally, in any of the preceding aspects, the device is the UE.

Optionally, in any of the preceding aspects, the method further includes: determining which path, including an uplink or downlink path, reserved or contention-based RACH resources, are considered to obtain the RLF, RRC, RLC, RACH, sounding, or handover states; indicating to RLF module the availability of an alternative path at upper layer; determining what messages are generated by the RLF module to indicate to the lower layers; and determining how to optimize the BFR/LR module or RLM state machine based the upper level messages.

According to yet another aspect of the present disclosure, there is provided a device that includes: a processor; and a non-transitory computer readable storage medium storing programming for execution by the processor. The programming includes instructions to: send, by an radio link failure (RLF) module in the device, an RLF status message indicating an RLF, radio resource control (RRC), radio link control (RLC), random access channel (RACH), sounding, or handover states to either a radio link monitoring (RLM) module of the device or a beam failure recovery (BFR) or link recovery (LR) (BFR/LR) module of the device, wherein the RLF status message instructs the RLM module or the BFR/LR module to modify an RLM or BFR/LR operation according to the RLF, RRC, RLC, RACH, sounding, or handover states of a user equipment (UE), the device being either the UE or a network device serving the UE.

According to yet another aspect of the present disclosure, there is provided a method that includes: receiving a radio link failure (RLF) status message from an RLF module of a device at either a radio link monitoring (RLM) module or a beam failure recovery (BFR) or link recovery (LR) (BFR/LR) module of the device, the RLF status message indicating an RLF, radio resource control (RRC), radio link control (RLC), random access channel (RACH), sounding, or handover states of a user equipment, the device being either the UE or a network device serving the UE; and performing, by the RLM module or the BFR/LR module, an RLM or BFR/LR operation according to the RLF, RRC, RLC, RACH, sounding, or handover states.

According to yet another aspect of the present disclosure, there is provided a device that includes: a processor; and a non-transitory computer readable storage medium storing programming for execution by the processor. The programming includes instructions to: receive a radio link failure (RLF) status message from an RLF module of a device at either a radio link monitoring (RLM) module or a beam failure recovery (BFR) or link recovery (LR) (BFR/LR) module of the device, the RLF status message indicating an RLF, radio resource control (RRC), radio link control (RLC), random access channel (RACH), or RACH, sounding, handover status of a user equipment, the device being either the UE or a network device serving the UE; and perform, by the RLM module or the BFR/LR module, an RLM or BFR/LR operation according to the RLF, RRC, RLC, RACH, sounding, or handover states

### BRIEF DESCRIPTION OF THE DRAWINGS

Further features and advantages of the present disclosure will become apparent from the following detailed description, taken in combination with the appended drawings, in which:

FIG. 1 illustrates a diagram of an embodiment electronic device (ED);

FIG. 2 illustrates a diagram of an embodiment 5G core network (CN) architecture;

FIG. 3 illustrates a diagram of another embodiment 5G CN architecture;

FIG. 4 illustrates a diagram of an embodiment next generation radio access network (RAN) architecture;

FIG. 5 illustrates a diagram of an embodiment 5G RAN architecture;

FIG. 6 illustrates a diagram of a radio link monitoring (RLM) and radio link failure (RLF) detection procedure in a legacy LTE system;

FIG. 7 illustrates a diagram of a layered architecture and operations for RLF detection in a multi-beam new radio system;

FIG. 8 illustrates a diagram of RLF phases in a RLF procedure in the legacy LTE system;

FIG. 9 illustrates a diagram of an embodiment structure for RLF detection;

FIG. 10 illustrates a diagram of an embodiment end-to-end and cross-layer framework for RLF detection;

FIG. 11 illustrates a diagram of another embodiment end-to-end and cross-layer framework for RLF detection;

FIG. 12 illustrates a flowchart of an embodiment method for beam failure recovery (BFR) and RLF detection;

FIG. 13 illustrates a flowchart of another embodiment method for BFR and RLF;

FIG. 14 illustrates a flowchart of another embodiment method for interactions among BFR, RLM, and RLF detection modules;

FIG. 15 illustrates a flowchart of another embodiment method for interactions among BFR, RLM, and RLF detection modules;

FIG. 16 illustrates a flowchart of another embodiment method for interactions among BFR, RLM, and RLF detection modules;

FIG. 17 illustrates a flowchart of an embodiment method for determining radio link recovery or beam failure recovery (BFR) indications; and

FIG. 18 illustrates a flowchart of an embodiment method for radio link monitoring (RLM).

### DETAILED DESCRIPTION OF ILLUSTRATIVE EMBODIMENTS

For the purposes of this application, the following list of acronyms is provided to aid in the understanding of the disclosure. As is known to someone skilled in the art, various acronyms may have a plurality of meaning, therefore the meaning of any acronym should be interpreted in view of the appropriate context of the disclosure.
RRM: Radio Resource Management
5G: Fifth Generation
NextGen: Next Generation
CN: Core Network
CA: Carrier Aggregation
BLER: Block Error Rate
LF: Low Frequency
BFR: Beam (link) Failure Recovery, which can be considered an example of link recovery
LR: Link Recovery
NR: New Radio (i.e., 5G access)
CH: Channel
UE: User Equipment, or device
QCL: Quasi-CoLocation
CN: Core Network
PCell/PSCell/SCell: Primary, Primary Secondary, or Secondary cell
DCI in PDCCH: Downlink control Information in Physical Downlink Control Channel
UCI in PUCCH/PUSCH: Uplink Control information in Physical Uplink Control Channel/Physical Uplink Shared Channel
RS: Reference Signal at L1 (may be UL uplink or DL downlink)
RLF: Radio Link Failure
DL/UL: Downlink or Uplink
RLM: Radio Link Monitoring
CDM: Code Division Multiplexing
KPI: Key Performance Index
CE: control element
TDM: Time Division Multiplexing
RAR: Random Access Response
RAN: Radio Access Network
E-UTRAN: Evolved Universal Terrestrial Radio Access, basically referring to 4G LTE radio access network or RAN
MCG/SCG: Master Cell Group or Secondary Cell Group
HetNet: Heterogeneous Network
BRF: Beam (failure) Recovery Failure
MC: Multi-connectivity
SRS: Sounding Reference Signal
CORESET: Control resource set, signaled by SI
CC: Component carrier
SUL: Supplemental Uplink
FDM: Frequency Division Multiplexing
RNC: Radio Network Controller in 3G
SR: Scheduling Request
RMSI: remaining minimum system information (MSI), e.g., SIB1
OSI: other SI (e.g., SIB2-SIB3)
NGC: Next Generation Core (5G)
gNB: next generation (5G) of eNB (or LTE base station), which may include one CU (Central Unit) and one or more DUs (Distributed Units)
SIB: System Information Block
CA: Carrier Aggregation
IS: In-Sync
OOS: Out-of-Sync
HF: High Frequency
L2: Layer 2
DC: Dual Connectivity
CRS: cell-specific RS
CF: central frequency
TOS: Time of Staying
TTT: Time To Trigger
BWP: Bandwidth Part
HO: Handover
HOF: Handover Failure
MAC: Medium Access Control
UDN: Ultra-Dense Network
EPC: Evolved Packet Core—4G Core Network
CRS: cell specific RS at L1 along DL (i.e., from the network to the UE)
PDCCH: Physical Downlink Control Channel
L1/L3: Layer 1 or Layer 3 (typically referring to PHY layer or RRC layer, respectively)
MM: Mobility Management, referring to switching of serving nodes due to UE's mobility, and often incurring L2 (Layer 2) or L3 (Layer 3) signaling and even data transfer or split between the nodes and with the UE for the switch.
BM: Beam Management, referring to any beam-specific operations, particularly beam alignment, beam measurement or beam monitoring, beam refinement, beam tracking, and beam switching with respect to the same serving node, node family (e.g., a TRP and its parent cell or a gNB), or strictly synchronized nodes (e.g., multiple TRPs that literally cannot be distinguished by UE from beam operations' perspective).
TRP: Transmission And Reception Point (the unit of a serving node inside yet at the edge of a network, talking to the UE over the air radio), typically referring to RRH with or without PHY or MAC.
CSI-RS/DM-RS/SS Block/PSS/SSS/SRS: Channel State Information-Reference Signal, Demodulation Reference Signal, Synchronization Signal Block, Primary Synchronization Signal, Second Synchronization Signal, or Sounding Reference Signal. These reference signals (RS) are collectively referred to as xSS or xRS in this disclosure. For example, x may be “P”, “S”, “DM”, or “CSI”.
NG-C: Next Generation (Core Network) Control Plane in 5G
NG-U: Next Generation (Core Network) User Plane in 5G
MSI: Minimum System Information (e.g., MIB+SIB1)
CU: central unit, normally hosting L3 radio resource control (RRC) or packet data convergence protocol (PDCP) layers
DU: distributed unit, normally hosting radio link control (RLC), or MAC, or PHY, etc.

Embodiments of the present disclosure provide methods for radio link failure (RLF) operations based on link failure recovery (LR), beam failure recovery (BFR) and radio link monitoring (RLM), and for unifying indications from modules for BFR/LR or RLM to RLF, or vice versa. The method is applicable to downlink at a user equipment, or to uplink at a network device, or to any direct links of a peer-to-peer network device. Based on configured criteria, the unification method combines or filters multiple indications and measured link metrics from multiple paths of each module or from multiple modules, and sends the filtered or combined results from a physical layer of the device to assist the RLF operations. Similar RLF operations may utilize the upper layer status to generate downwards indications to assist lower-layer RLM or BFR/LR operations.

In some embodiments, a device may measure a reference signal received over one or more communication paths of a radio link to estimate the link quality for radio link operations (BFR/LR) and RLM. Based on configured criteria, the device may generate RLM or BFR/LR indications based on an assessed link quality metric or a link recovery operation status, combine or filter the indications and metrics from multiple paths of each module or from multiple modules, and send the filtered or combined results from a physical layer of the device to assist the RLF operations

In some embodiments, a device may measure a reference signal received over one or more communication paths of a radio link to generate reference signal measurements, and select, from the one or more communications paths, at least one path for link quality assessment of a radio link operation based on the reference signal measurements and a configured criterion. The device may generate a radio link indication based on an assessed link quality metric or a link recovery operation status associated with the selected at least one path, and send the radio link indication from a physical layer of the device to a upper layer of the device.

In some embodiments, a device may measure reference signals received over one or more beams of a serving link between a user equipment (UE) and one or more network devices in a wireless network to generate reference signal measurements. The device may select, from the one or more beams, at least one beam based on the measured reference signals in accordance with a network configured RLM criterion. The device may further derive a serving link quality from the selected at least one beam according to the network configured RLM criteria, and assess the derived serving link quality by following the network configured RLM criteria to generate one or more first or periodic RLM indications. The device may also send the one or more first or periodic RLM indications to a same layer or an upper layer of the device.

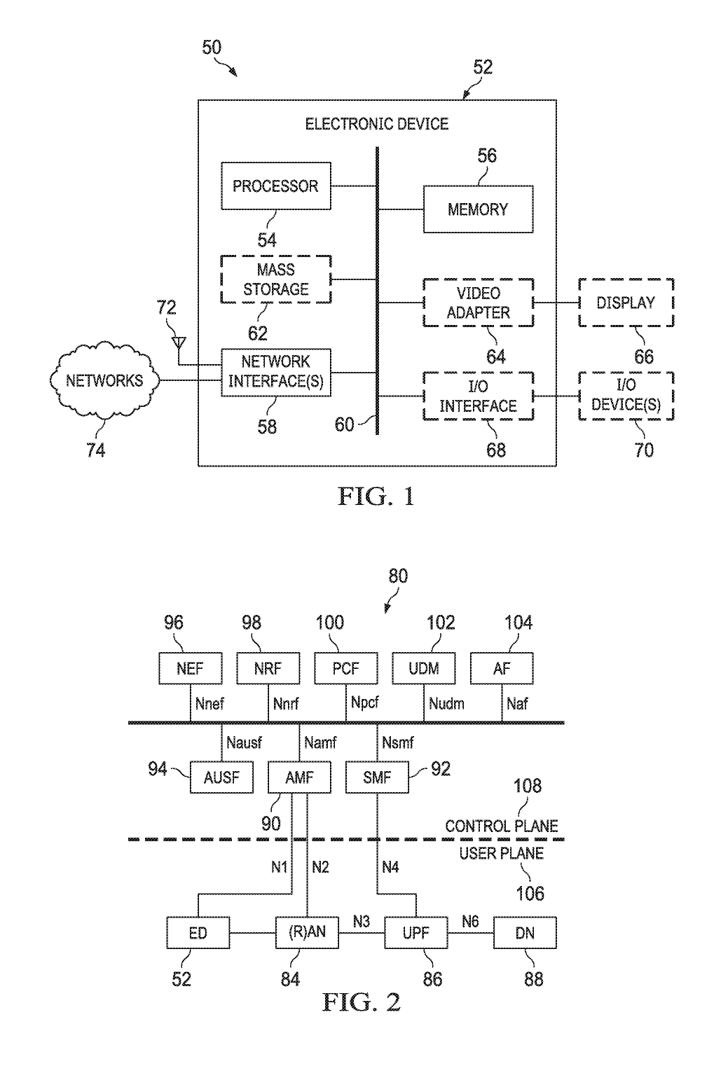

Throughout the disclosure, the same element appearing in different figures is referenced using the same numeral number. FIG. 1 is a block diagram of an embodiment electronic device (ED) 52 illustrated within a computing and communications environment 50 that may be used for implementing the devices and methods disclosed herein. In some embodiments, the ED 52 may be an element of communications network infrastructure, such as a base station (BS), e.g., a NodeB, an evolved Node B (eNodeB, or eNB), a next generation NodeB (also referred to as a gNodeB or gNB), a home subscriber server (HSS), a Mobility Management Entity (MME), a gateway (GW) such as a packet gateway (PGW) or a serving gateway (SGW), or various other nodes or functions within a core network (CN) or a Public Land Mobility Network (PLMN). For clarity, a gNB may be a next generation (5G) of eNB (e.g., a LTE base station), which may include one central unit (CU) and one or more distributed units (DUs). A CU may host L3 radio resource control (RRC), or packet data convergence protocol (PDCP) protocol layers. A DU may host radio link control (RLC), and/or Medium Access Control (MAC), and/or a physical layer (PHY), etc.

In other embodiments, the ED 52 may be a device that connects to the network infrastructure over a radio interface, such as a mobile phone, smart phone or other such device that may be classified as a User Equipment (UE). In some embodiments, ED 52 may be a Machine Type Communications (MTC) device (also referred to as a machine-to-machine (m2m) device), or another such device that may be categorized as a UE despite not providing a direct service to a user. In some references, an ED may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, a device may contain multiple instances of a component, such as multiple processors, memories, transmitters, receivers, etc. The ED 52 typically includes a processor 54, such as a Central Processing Unit (CPU), and may further include specialized processors such as a Graphics Processing Unit (GPU) or other such processor, a memory 56, a network interface 58 and a bus 60 to connect the components of ED 52. ED 52 may optionally also include components such as a mass storage device 62, a video adapter 64, and an I/O interface 68 (shown in dashed lines).

The memory 56 may include any type of non-transitory system memory, readable by the processor 54, such as static random access memory (SRAM), dynamic random access memory (DRAM), synchronous DRAM (SDRAM), read-only memory (ROM), or a combination thereof. In an embodiment, the memory 56 may include more than one type of memory, such as ROM for use at boot-up, and DRAM for program and data storage for use while executing programs. The bus 60 may be one or more of any type of several bus architectures including a memory bus or memory controller, a peripheral bus, or a video bus.

The ED 52 may also include one or more network interfaces 58, which may include at least one of a wired network interface and a wireless network interface. As illustrated in FIG. 1, network interface 58 may include a wired network interface to connect to one or more networks 74, and also may include a radio access network interface 72 for connecting to other devices over a radio link. When ED 52 is a network infrastructure element, the radio access network interface 72 may be omitted for nodes or functions acting as elements of the PLMN other than those at the radio edge (e.g. an eNB). When ED 52 is infrastructure at the radio edge of a network, both wired and wireless network interfaces may be included. When ED 52 is a wirelessly connected device, such as a User Equipment, radio access network interface 72 may be present and it may be supplemented by other wireless interfaces such as WiFi network interfaces. The network interfaces 58 allow the electronic device 52 to communicate with remote entities such as those connected to a network 74.

The mass storage 62 may include any type of non-transitory storage device configured to store data, programs, and other information and to make the data, programs, and other information accessible via the bus 60. The mass storage 62 may include, for example, one or more of a solid state drive, a hard disk drive, a magnetic disk drive, or an optical disk drive. In some embodiments, mass storage 62 may be remote to the electronic device 52 and accessible through use of a network interface such as interface 58. In the illustrated embodiment, the mass storage 62 is distinct from the memory 56 where it is included, and may generally perform storage tasks compatible with higher latency, but may generally provide lesser or no volatility. In some embodiments, the mass storage 62 may be integrated with a heterogeneous memory 56.

The optional video adapter 64 and the I/O interface 68 (shown in dashed lines) provide interfaces to couple the ED 52 to external input and output devices. Examples of input and output devices include a display 66 coupled to the video adapter 64 and one or more I/O devices 70 such as a touch-screen coupled to the I/O interface 68. Other devices may be coupled to the ED 52, and additional or fewer interfaces may be utilized. For example, a serial interface such as Universal Serial Bus (USB) (not shown) may be used to provide an interface for an external device. Those skilled in the art will appreciate that in embodiments in which the ED 52 is part of a data center, I/O interface 68 and Video Adapter 64 may be virtualized and provided through network interface 58.

In some embodiments, ED 52 may be a standalone device, while in other embodiments ED 52 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks including pools of computing and storage resources connected to one another by connectivity resources. The connectivity resources may take the form of physical connections such as Ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

FIG. 2 illustrates a diagram of an embodiment architecture 80 of a 5G core network (5GCN). The 5GCN may also be referred to as a Next Generation Core (NGC) Network (NGCN, or NCN). This illustration depicts logical connections between nodes and functions, and its illustrated connections should not be interpreted as direct physical connection. A ED 52 forms a radio access network connection with a (Radio) Access Network node (R)AN 84, which is connected to a User Plane (UP) Function (UPF) 86 such as a UP Gateway over a network interface such as an N3 interface. The UPF 86 connects to a Data Network (DN) 88 over a network interface such as an N6 interface. DN 88 may be a data network used to provide an operator service, or it may be outside the scope of the standardization of the Third Generation Partnership Project (3GPP).

3GPP is a collaboration between groups of telecommunications associations, known as the Organizational Partners. The initial scope of 3GPP was to make a globally applicable third-generation (3G) mobile phone system specification based on evolved Global System for Mobile Communications (GSM) specifications within the scope of the International Mobile Telecommunications-2000 project of the International Telecommunication Union (ITU). The scope was later enlarged to include the development and maintenance of many telecommunications standards and systems.

In some embodiments, the DN 88 may represent an Edge Computing network or resource, such as a Mobile Edge Computing (MEC) network. ED 52 also connects to an Access and Mobility Management Function (AMF) 90. The AMF 90 is responsible for authentication and authorization of access requests, as well as Mobility management functions. Mobility management function may include switching of serving nodes due to UE's mobility, and often incur L2 (Layer 2) or L3 (Layer 3) signaling and even data transfer/split between the nodes and the UE for the switching.

The AMF 90 may perform other roles and functions as defined by the 3GPP Technical Specification (TS) 23.501. In a service based view, AMF 90 can communicate with other functions through a service based interface denoted as Namf. A Session Management Function (SMF) 92 is a network function that is responsible for allocation and management of IP addresses that are assigned to a UE as well as selection of a UPF 86 (or a particular instance of a UPF 86) for traffic associated with a particular session of ED 52. The SMF 92 can communicate with other functions, in a service based view, through a service based interface denoted as Nsmf. An Authentication Server Function (AUSF) 94, provides authentication services to other network functions over a service based Nausf interface. A Network Exposure Function (NEF) 96 can be deployed in the network to allow servers, functions and other entities such as those outside a trusted domain to have exposure to services and capabilities within the network. In one such example, an NEF 96 can act much like a proxy between an application server outside the illustrated network and network functions such as a Policy Control Function (PCF) 100, the SMF 92 and the AMF 90, so that an external application server can provide information that may be of use in the setup of parameters associated with a data session. The NEF 96 can communicate with other network functions through a service based Nnef network interface. The NEF 96 may also have an interface to non-3GPP functions. A Network Repository Function (NRF) 98, provides network service discovery functionality. The NRF 98 may be specific to a Public Land Mobility Network (PLMN) or a network operator, with which it is associated. The service discovery functionality can allow network functions and UEs connected to the network to determine where and how to access existing network functions, and may present a service based interface Nnrf. The PCF 100 communicates with other network functions over a service based Npcf interface, and can be used to provide policy and rules to other network functions, including those within the control plane. Enforcement and application of the policies and rules is not necessarily the responsibility of the PCF 100, and is instead typically the responsibility of the functions to which the PCF 100 transmits the policy. In one such example the PCF 100 may transmit policy associated with session management to the SMF 92. This may be used to allow for a unified policy framework with which network behavior can be governed. A Unified Data Management Function (UDM) 102 can use a service based Nudm interface to communicate with other network functions, and can provide data storage facilities to other network functions. Unified data storage can allow for a consolidated view of network information that can be used to ensure that the most relevant information can be made available to different network functions from a single resource. This may help make implementation of other network functions easier, as they do not need to determine where a particular type of data is stored in the network. The UDM 102 may be implemented as a UDM Front End (UDM-FE) and a User Data Repository (UDR). The PCF 100 may be associated with the UDM 102 because it may be involved with requesting and providing subscription policy information to the UDR, but it should be understood that typically the PCF 100 and the UDM 102 are independent functions. The PCF 100 may have a direct interface to the UDR. The UDM-FE receives requests for content stored in the UDR, or requests for storage of content in the UDR, and is typically responsible for functionality such as the processing of credentials, location management and subscription management. The UDR-FE may also support any or all of Authentication Credential Processing, User Identification handling, Access Authorization, Registration/Mobility management, subscription management, and Short Message Service (SMS) management. The UDR is typically responsible for storing data provided by the UDM-FE. The stored data is typically associated with policy profile information (which may be provided by PCF 100) that governs the access rights to the stored data. In some embodiments, the UDR may store policy data, as well as user subscription data which may include any or all of subscription identifiers, security credentials, access and mobility related subscription data and session related data. An Application Function (AF) 104 represents the non-data plane (also referred to as the non-user plane) functionality of an application deployed within a network operator domain and within a 3GPP compliant network. The AF 104 interacts with other core network functions through a service based Naf interface, and may access network capability exposure information, as well as provide application information for use in decisions such as traffic routing. The AF 104 can also interact with functions such as the PCF 100 to provide application specific input into policy and policy enforcement decisions. It should be understood that in many situations the AF 104 does not provide network services to other NFs, and instead is often viewed as a consumer or user of services provided by other NFs. An application outside the 3GPP network, can perform many of the same functions as AF 104 through the use of NEF 96.

The ED 52 communicates with network functions that are in the User Plane (UP) 106, and the Control Plane (CP) 108. The UPF 86 is a part of the CN UP 106 (DN 88 being outside the 5GCN). (R)AN 84 may be considered as a part of a UP, but because it is not strictly a part of the CN, it may not be considered to be a part of the CN UP 106. AMF 90, SMF 92, AUSF 94, NEF 96, NRF 98, PCF 100, and UDM 102 are functions that reside within the CN CP 108, and are often referred to as Control Plane Functions. AF 104 may communicate with other functions within CN CP 108 (either directly or indirectly through the NEF 96), but is typically not considered to be a part of the CN CP 108.

Those skilled in the art will appreciate that there may be a plurality of UPFs connected in series between the (R)AN 84 and the DN 88, and multiple data sessions to different DNs can be accommodated through the use of multiple UPFs in parallel.

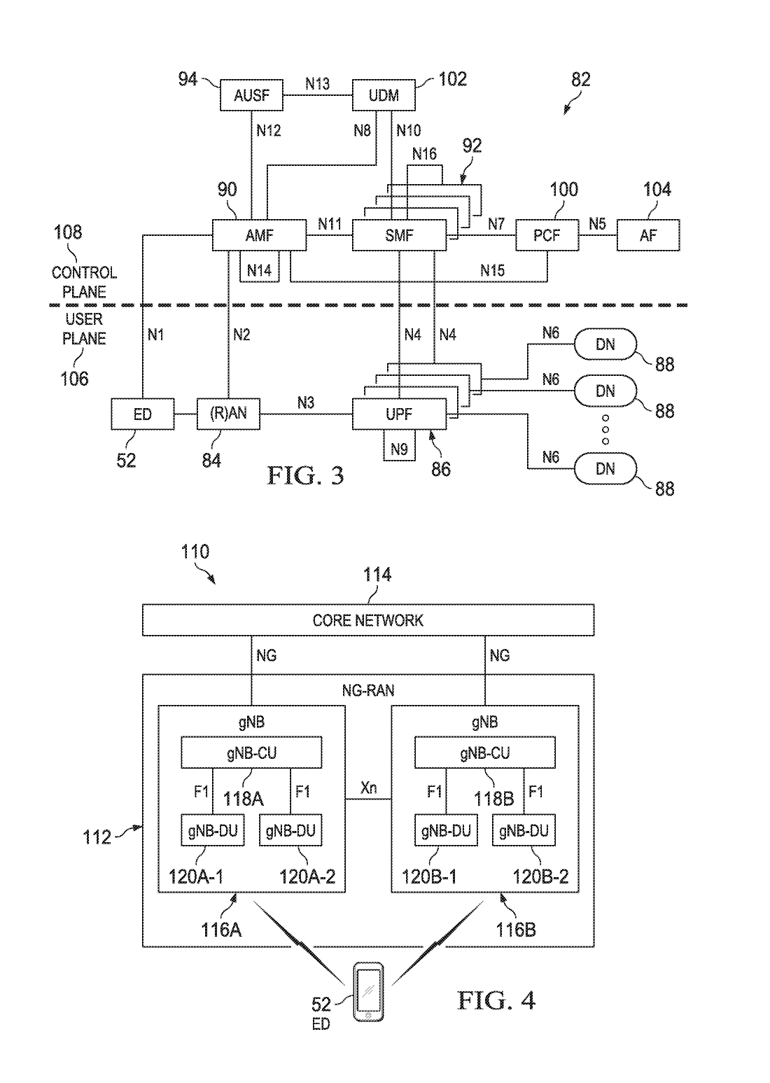

FIG. 3 illustrates a diagram of an embodiment architecture 82 of a reference point representation of a 5G CN. For the sake of clarity, some of the network functions illustrated in FIG. 2 are omitted in FIG. 3, but it should be understood that the omitted functions (and those not illustrated in either FIG. 1 or FIG. 2) can interact with the illustrated functions in FIG. 3.

The ED 52 connects to both the (R)AN 84 (in a user plane 106) and the AMF 90 (in the control plane 108). The ED-to-AMF connection is an N1 connection. The (R)AN 84 also connects to the AMF 90, over an N2 connection. The (R)AN 84 connects to the UPF function 86 over and N3 connection. The UPF 86 is associated with a PDU session, and connects to the SMF 92 over an N4 interface to receive session control information. If the ED has multiple PDU sessions active, the multiple PDS sessions can be supported by multiple different UPFs, each of which is connected to an SMF over an N4 interface. It should be understood that from the perspective of the reference point representation, multiple instances of either an SMF 92 or an UPF 86 are considered as distinct entities. The UPFs 86 each connect to a DN 88 outside the 5GCN over an N6 interface. The SMF 92 connects to the PCF 100 over an N7 interface, and the PCF 100 connects to an AF 104 over an N5 interface. The AMF 90 connects to the UDM 102 over an N8 interface. Two UPFs in the UP 106 may connect to each other over an N9 interface. The UDM 102 may connect to an SMF 92 over an N10 interface. The AMF 90 and AMF 92 connect to each other over an N11 interface. The N12 interface connects the AUSF 94 to the AMF 90. The AUSF 94 may connect to the UDM 102 over the N13 interface. A plurality of AMFs may be connected to one other over an N14 interface. The PCF 100 can connect to an AMF 90 over an N15 interface. If there is a plurality of SMFs in a network, they can communicate with one another over an N16 interface.

It should also be understood that any or all of the functions and nodes, discussed above with respect to the architectures 80 and 82 of the 5GCN, may be virtualized within a network, and the network itself may be provided as a network slice of a larger resource pool.

FIG. 4 illustrates a diagram of an embodiment architecture no for implementation of a Next Generation Radio Access Network (NG-RAN) 112. The NG-RAN 112 may also be referred to as a 5G RAN. In this example, one ED (e.g., ED 52) may communicate with multiple gNBs, or may communication with multiple DUs for each gNB (simultaneously), over the same frequency carrier or different frequency carriers, or using some resource multiplexing approach. An ED-DU radio link may include multiple beams or beam pairs (not shown). The NG-RAN 112 is the radio access network that connects an ED 52 to a core network 114. Those skilled in the art will appreciate that the core network 114 may be a 5GCN. In other embodiments, the core network 114 may be a 4G Evolved Packet Core (EPC) network. Nodes within the NG-RAN 112 connect to the 5GCN 114 over an NG interface. The NG interface may include both an N2 interface connecting to a control plane and an N3 interface connecting to a user plane. The N3 interface can provide a connection to a CN UPF. The NG-RAN 112 includes a plurality of radio access nodes, which may be referred to as next generation NodeBs (gNBs). In the NG-RAN 112, a gNB 116A and a gNB 116B are able to communicate with each other over an Xn interface. Within a single gNB 116A, the functionality of the gNB may be decomposed into a centralized unit (gNB-CU) 118A, and a set of distributed units (e.g., a gNB-DU 120A-1 and a gNB-DU 120A-2, collectively referred to as 120A). The gNB-CU 118A is connected to a gNB-DU 120A over an F1 interface. Similarly, the gNB 116B has a gNB-CU 118B connecting to a set of distributed units gNB-DU 120B-1 and gNB-DU 120B. Each gNB DU may be responsible for one or more cells providing radio coverage within the PLMN.

The division of responsibilities between a gNB-CU and a gNB-DU are being defined by 3GPP. Different functions, such as the radio resource management or radio resource monitoring (e.g., radio link monitor or RLM) functionality, may be placed in a CU or a DU, and may also be placed on an ED for monitoring of one or multiple radio links or one or multiple beams per link between the ED and DU(s). As with all functional placements, there may be advantages and disadvantages for placing a particular function in one or the other location. It should be understood that any or all of the functions discussed above with respect to the NG-RAN 112 may be virtualized within a network, and the network itself may be provided as a network slice of a larger resource pool, as will be discussed below.

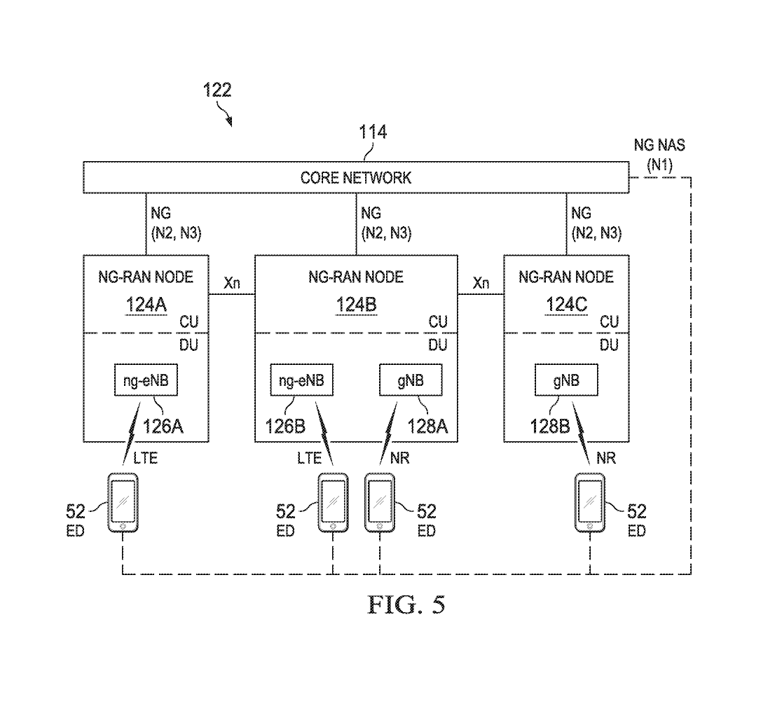

FIG. 5 illustrates a diagram of an embodiment architecture 122 of a RAN for a 5G network (i.e., a next generation RAN, or a NG-RAN). The 5G network may support interworked New Radio (NR) and LTE radio interfaces for the same ED. That is, one interface (with an LTE ng-eNB) may be an omni-directional radio links on a carrier, while another interface (with NR gNB) may be omni-directional links on another carrier, coupled with multi-beam radio links on yet another carrier. The NG-RAN includes a plurality of NG-RAN nodes such as a NG-RAN Node 124A, a NG-RAN Node 124B, and a NG-RAN Node 124C, collectively referred to as NG-RAN Node 124. A NG-RAN Node 124 is typically a radio edge node through which an ED 52 connects to the NG-RAN. Each NG-RAN node 124 can be split into a CU and DU. The type of connection provided to ED 52 may vary depending on capabilities of the ED 52 and capabilities of a particular NG-RAN Node 124. The NG-RAN Node 124A includes, as part of its DU, a next generation evolved NodeB (ng-eNB) 126A which may provide an LTE connection to an ED 52. The NG-RAN Node 124C includes, as part of its DU a gNB 128B which may provide a Next generation Radio access (NR) connection to an ED 52. It should be noted that the NG-RAN Node 124A may not provide an NR connection to an ED 52 because of its lack of a gNB, and the NG-RAN Node 124C may not provide an LTE connection to an ED 52 because of its lack of a ng-eNB. It should be further noted that, with reference to FIG. 5, describing a gNB as part of a DU indicates that the DU is able to provide a Next Generation radio access technology (RAT) connection to an ED, and describing an ng-eNB as part of a DU indicates that the DU is able to provide an LTE RAT connection to an ED. The NG-RAN Node 124B includes, within its DU, both a ng-eNB 126B and a gNB 128A. This allows the NG-RAN Node 124B to provide both LTE and NR connections to an ED 52.

An NG-RAN Node 124 can communicate with another NG-RAN Node 124 over an Xn interface. Although not shown, the NG-RAN Node 124A may have an Xn interface connection to the NG-RAN Node 124C. The NG-RAN Node 124 may connect to a Core Network 114 over a connection through an NG interface, such as an N2 or N3 interface. An ED 52 may connect to the Core Network 114 over an NG Network Access Stratum (NG NAS) interface, such as an N1 interface.

While an ED (or a UE) accesses a wireless network (e.g., a 5G network) through a RAN (e.g., a NG-RAN) for communication services, the UE may monitor quality of downlink (i.e., from the 5G network to the UE) radio links. The UE may declare a radio link failure (RLF) if radio link quality of a radio link is degraded such that communications between the UE and the network cannot be continued reliably. For example, according to 3GPP TR 38.802, in NR, a beam failure event may occur when the quality of one or more beam pair links (BPLs) of an associated control channel falls low enough (e.g. compared with a threshold, or upon time-out of an associated timer). Generally, in LTE, a UE may declare a RLF in a higher layer (i.e., L3) when one of the following situations occurs: 1) An indication generated by radio link control (RLC) indicating that the maximum number of (automatic repeat request, ARQ) re-transmission has been reached; 2) An indication generated by MAC indicating that an random access problem occurs while none of timers T300, T301, T304, and T311 is running; 3) Failure to receive an handover command during T312 when T310 is running, e.g., upon T312 expiry; and 4) Detection of a PHY layer problem based on radio link monitoring (RLM) of a downlink omni-directional cell-specific reference signal (CRS). The problem may be detected when a number (e.g., N310) of consecutive out-of-syncs (OOSs) are detected without detection of a number (e.g., N311) of consecutive in-syncs (ISS) before T310 expiry), e.g., upon T310 expiry and T311 starts.

In the case for detecting a RLF based on RLM, a UE may monitor downlink radio link quality based on cell-specific reference signals (CRSs), and compare a radio link measurement to an OOS threshold, such as Qout (e.g., −8 dB) and an IS threshold, such as Qin (e.g., −6 dB), as specified in 3GPP TS 36.133 for LTE systems. For example, the radio link measurement may be a measurement of a CRS signal interference to noise ratio (SINR) (also referred to as CIR) for a primary cell (PCell) or a primary secondary cell (PSCell). The same threshold levels may be applicable in cases with and without using discontinuous reception (DRX). When DRX is used, a periodic IS or OOS may be generated based on a DRX cycle if configured.

In LTE, the threshold Qout is defined as a level at which a downlink radio link cannot be reliably received, and which corresponds to a 10% block error rate (BLER) (for Qin, corresponds to a 2% BLER) of a hypothetical PDCCH transmission from a serving cell, taking into account of physical control format indicator channel (PCFICH) errors with transmission parameters specified in Table 7.6.1-1 in 3GPP TS 36.133. In LTE, when a CRS SINR of a PCell or a PSCell under estimation becomes worse than Qout, an OOS event occurs, and Layer 1 (L1) of a UE may send an OOS indication (e.g., periodically) to a higher (or upper) layer, and the upper layer may start a timer (e.g., T310). For example, when a predetermined number (e.g., N310) of consecutive OOS indications are observed (or received) by an upper layer, timer T310 will be started. T310 may be referred to as a RLF timer. When the CRS SINR of the PCell or PSCell is above Qin, L1 of the UE may send an IS indication (e.g., periodically) to the upper layer. T310 may be stopped if a predetermined number (e.g., N311) of consecutive IS indications are observed (or received) by the upper layer. When T310 expires, and when no IS indicator is observed over the last period (e.g., 200 ms) of T310, RLF may be declared, and RRC connection reestablishment and T311 are triggered.

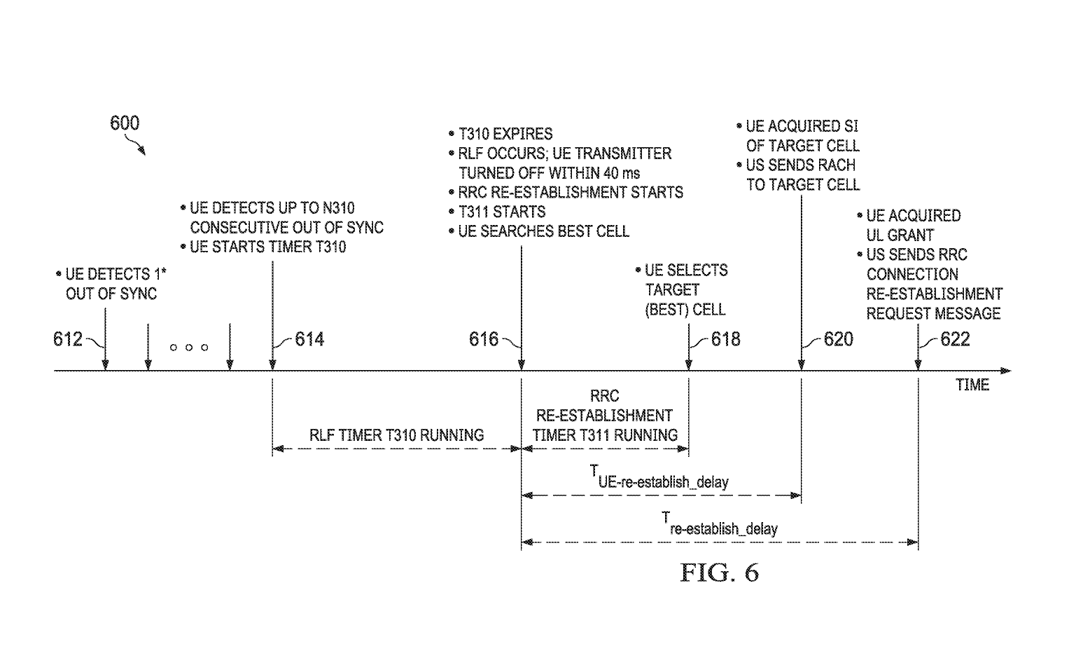

FIG. 6 illustrates a diagram of a RLM and RLF detection procedure 600 according to their interactions as defined by 3GPP TS 36.521. A RLM and RLF detection procedure may also be referred to as a RLF procedure in the present disclosure. A RLF procedure may generally refer to a procedure for detecting and declaring RLF at a UE, and recovering RRC connection of the UE with a network, based on physical layer measurements (e.g., RLM) and indications. FIG. 6 illustrates actions taken by a UE for detecting a RLF and re-establishing a RRC connection in a timeline. As shown, a UE detects a first OOS at time point 612. The UE may continue to detect OOS events until at time point 614, where the UE detects up to N310 consecutive OOSs. At 614, the UE starts timer T310. The timer T310 runs and expires at time point 616. This indicates that no N311 consecutive IS indications are observed during running of T310. At 616, the UE determines that RLF occurs. In this case, the UE's transmitter may be turned off within a predetermined time period, e.g., 40 ms. The UE also starts a RRC re-establishment timer T311 to start a RRC re-establishment procedure and search for another cell (e.g., the UE may search for the best cell that provides strongest signal strength). While the T311 is running, the UE selects a target cell (e.g., the best cell) at time point 618. At time point 620, the UE acquires synchronization information (SI) of the target cell, and sends a random access channel (RACH) signal to the target cell. At time point 622, the UE acquires a UL grant from the target cell, and sends a RRC connection re-establishment request message to the target cell. The time duration between time points 616 and 620 is referred to as a UE re-establishment delay, i.e., T_{UE-re-establish}_{_}_{delay}, and the time duration between time points 616 and 622 is referred to as a re-establishment delay, i.e., T_{re-establish}_{_}_{delay}.

For purposes of clarity, the timer T310 may be used to determine how long a PHY related problem has occurred. In some embodiments, T310 may start when a UE detects a PHY layer related problem, e.g., when the UE receives N310 consecutive OOS indications from lower layers. T310 stops when the UE receives N311 consecutive IS indications from lower layers, upon a Handover procedure being triggered, or upon initialization of a connection re-establishment procedure. At expiry of T310, if security is not activated, the UE may enter an RRC_IDLE state; or otherwise, the UE initiates the connection re-establishment procedure.

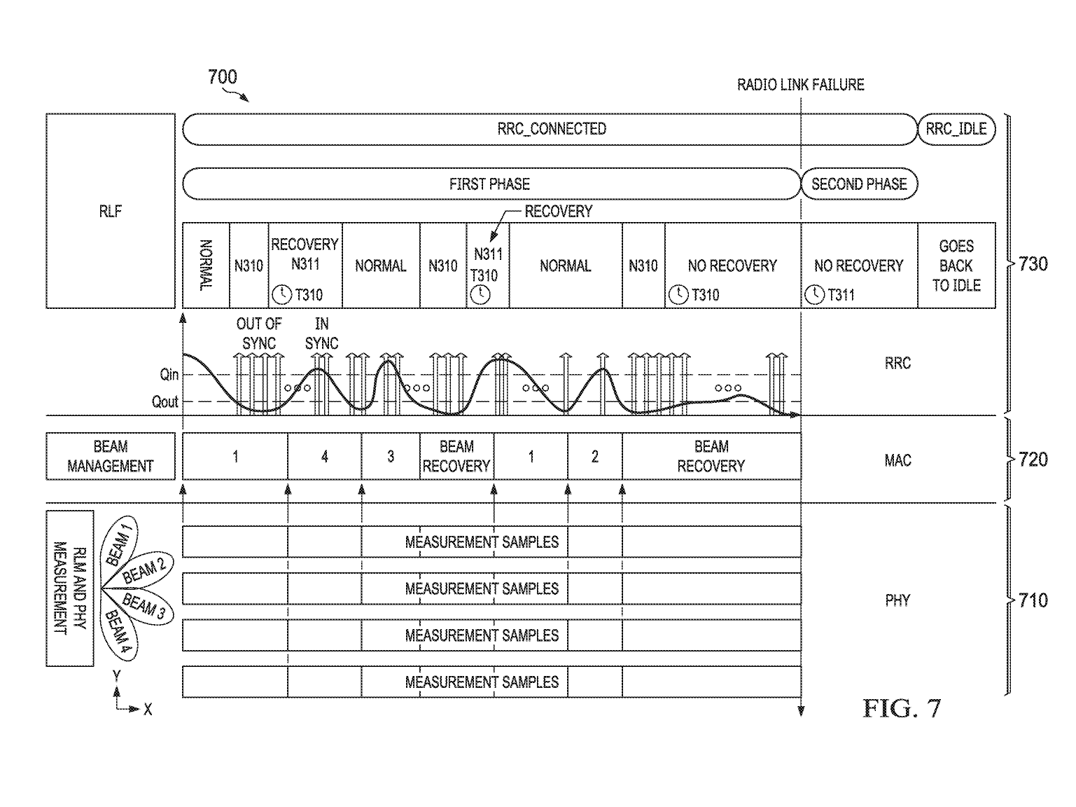

FIG. 7 illustrates a diagram 700 of a layered architecture and operations for RLF detection at a UE in a multi-beam RAN systems. In FIG. 7, the X axis represents time, and a PHY layer (L1) 710, a MAC layer (L2) 720 and a RRC layer (L3) 730 are shown to be separated along the Y axis. The UE performs RLM and measurements in the PHY layer 710. A RLM function or module in the PHY layer 710 compares measurement samples of link (or beam) quality metrics with an IS threshold Qin and an OOS threshold Qout. When a measurement sample is less than the Qout, an OOS indication is generated, and when a measurement sample is greater than the Qin, an IS indication is generated. The measurement samples may include metrics of CRSs, such as a received signal strength indication (RSSI), a CIR or SINR, reference signal received power (RSRP), or reference signal received quality (RSRQ). In one example, the UE may perform filtering and sampling of CRS pilot-based measurements (e.g., RSSIs and CIRs) in the PHY layer 710 to generate filtered measurement samples. For example, the UE may perform sampling at an interval of toms in a 200 MS or looms sliding window. The UE may then compare the filtered measurement samples with the Qout (e.g., −8 dB) and the Qin (e.g., −6 dB), and determine whether the filtered measurement samples are mapped to a group of symbol blocks at the receiver that satisfies PDCCH BLER >10% or PDCCH BLER <2%. The IS indications and the OOS indications may be sent to a higher layer, such as the RRC layer 730. In one example, the RLM module in the PHY layer 710 may send the IS indications and the OOS indications to a RLF module in the RRC layer 730.

The UE may be in a RRC—connected state or a RRC_idle state. During the RRC_connected state, in the RRC layer 730, if no OOS indication is received, the UE operates in a normal state. When the UE receives IS or OOS indications, the UE may perform L3 filtering of the OOS and IS indications. The UE compares the number of consecutive OOS indications with N310, and compares the number of consecutive IS indications >=N311. When the UE receives N310 consecutive OOS indications, or when the number of consecutive OOS indications >=N310, T310 is triggered and started. If a predetermined number (N311) of IS indications are received during T310, or when the number of IS indications >=N311, T310 is reset, and the UE recovers its RRC connection and continues to operate normally. If T310 expires, which indicates that the RRC connection is not recovered, the UE may start T311 for re-establishing the RRC connection. If re-establishing the RRC connection fails, the UE goes back to idle state. T310 may be set to 500˜1000 ms, or 50 ms for small cell, as a RLF detection period.

At the RRC layer (L3 layer), three RLF timers, i.e., T310, T311 and T312, are used for RLF detection. T310 starts upon detecting physical layer problems for a PCell or a PSCell. T310 starts upon receiving N310 consecutive OOS indications from lower layers, e.g., the PHY layer 710. T310 stops when the UE receives N311 consecutive ISs from the lower layers before T310 expires, or upon a handover procedure is triggered, or upon a connection re-establishment procedure is initiated. T310 expiry triggers T311 and RLF declaration, and hence initiates the connection re-establishment procedure. T311 starts upon initiating the RRC connection re-establishment procedure, and stops upon selection of a suitable cell, e.g., an evolved universal mobile telecommunications system (UMTS) terrestrial radio access (E-UTRA) cell, or a cell using another radio access technology (RAT). T311 expiry may trigger the UE to enter RRC_IDLE mode. T312 starts upon a measurement report being triggered for a measurement identity, for which T312 has been configured, while T310 is running. T312 stops upon receiving N311 consecutive IS indications from the lower layers, upon a handover procedure is triggered, upon a connection re-establishment procedure is triggered, or upon expiry of T310. T312 expiry may trigger declare of RLF and initiation of the connection re-establishment procedure, if context information and/or security information are prepared. Otherwise, if no context information or security information is prepared, the UE may enter RRC_IDLE mode. For purposes of clarity, the timer T312 may be used to determine how long a UE waits for receiving an N312 IS indication from layer 1 when establishing a dedicated channel in a connected state.

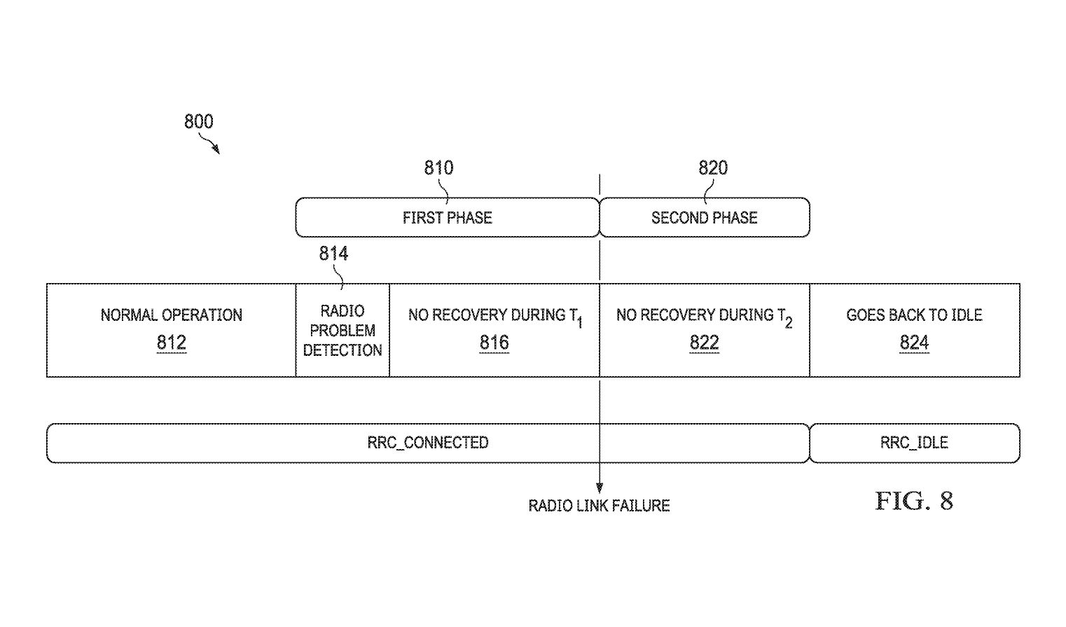

FIG. 8 illustrates a diagram of RLF phases of a UE in a RLF procedure in a legacy LTE system. The RLF phases are provided based on 3GPP TS 36.300. As shown, the RLF procedure may include two phases, i.e., a first phase 810 and a second phase 820. The first phase 810 may be referred to as a RLF detection phase, and the second phase 820 may be referred to as a RRC recovery phase. The first phase 810 may be triggered in a phase 812 where the UE is in a normal operation communicating with a network over a radio link. The first phase 810 includes a phase 814 where the UE performs radio problem detection, e.g., by counting, at the RLF layer, consecutive RLF OOS indications sent from the physical layer against a N310 threshold. When the UE detects a problem on the link in the phase 814, e.g., when N310 consecutive OOS indications are observed, timer T1 (e.g., T310) is started, and the UE enters a phase 816 for link recovery. During the phase 816, the UE monitors IS indications and OOS indications. In LTE, only one source of IS or OOS from one specific path (e.g., omni-directional CRS based monitoring) of a serving link is generated from RLM at physical layer. If N311 consecutive IS indications are observed, the UE determines that the link is recovered and the UE goes back to normal operation again. In this case, T310 is reset. If T310 expires, i.e., the RRC connection is not recovered, the UE determines that a RLF is detected and declares the RLF, the first phase 810 ends, and the UE enters the second phase 820. During the second phase 820, a timer T2 (e.g., T311) is started, and the UE enters a phase 822 to recover a RRC connection with the network using a RRC re-establishment procedure. The phase 822 (also the second phase 820) ends upon T311 expires, which indicates that the RRC connection with the network is not recovered during T2. Then the UE enters phase 824, where the UE goes back to an idle mode. The second phase 820 may also ends when timer T312 expires. During the first and the second phases, the UE may be in an RRC_connected state. The UE may enter an RRC_idle state upon the end of the second phase 820.

RAN WG2 (RAN2) has reached certain agreements on mobility RLF and RLM. For example, an agreement includes that a RLF may be detected based on three options including PHY indications of OOSs and ISs, a radio link control (RLC) failure (e.g., after ARQ retry), and a RACH failure (e.g., after a scheduling request (SR) retry). In other words, a UE in a connected mode may declare a RLF upon expiry of a timer (e.g., T310 or T312), which is due to DL OOS detection, random access procedure failure detection, or RLC (e.g., ARQ retransmission) failure detection. It is for future study whether or not the maximum ARQ retransmission number is the only criterion for RLC failure detection. In another example, an agreement includes that, in a NR RLM procedure, the physical layer generates OOS and IS indications and the RRC layer declares a RLF. However, NR RLM for a multi-beam link is yet to be defined. In yet another example, an agreement includes a RAN2 preference that IS and OOS indications should be a per cell indication for RLF detection. However, RAN2 left some problems open. For example, a problem may be how a UE generates and sends beam failure recovery (BFR) and RLM (e.g., OOS, IS) indications for RRC declared (e.g., cell-specific) RLF in a case of a multiple-beam link. In another example, a problem may include what a uniform procedure is (or whether there may be a uniform procedure) for BFR-RLF interactions regardless of multi-beam and single-beam RLM operations.

In LTE carrier aggregation (CA) and dual connectivity (DC), RLF detection and RLM are based only on a PCell at a master eNB (MeNB), or a PSCell at a secondary eNB (SeNB). For CA (and also single carrier), RRC connection re-establishment may be triggered when a PCell experiences RLF. A UE does not monitor RLF of SCells. RLF of a SCell is monitored by an eNB. For DC, the first phase of a RLF procedure (as illustrated in FIG. 8) is supported for a PCell and a PSCell. RRC re-establishment is triggered when the PCell experiences RLF. However, upon detecting RLF on the PSCell, re-establishment procedure is not triggered at the end of the first phase. Instead, the UE informs a MeNB of the detected RLF on the PSCell.

Currently, the LTE's RLM and RLF (with channel metrics thresholds Qout and Qin) are generally based on SINR from omni-directional CRS measurements and table-lookup based hypothetical PDCCH channel Block Error Rates (BLERs). However, there are no cell-specific CRSs in new radio (NR) any more, and, other reference signals may be used instead, such as synchronization signal (SS) blocks, physical broadcast channel demodulation-reference signals (PBCH DM-RSs), and channel state information-reference signals (CSI-RSs). These reference signals are not generally formally defined yet in 3GPP standards. Further, the LTE RLF with DC or CA is generally based only on a PCell at a MeNB, or a PSCell at a SeNB, as discussed above. However, uplink (UL) or downlink (DL) data transmissions may also be performed in an available physical uplink control channel (PUCCH) of a SCell group even if a PCell fails. Moreover, within a cell using CA, one carrier may fail but another carrier may still be alive. In addition, the lack of formal definitions of multi-beam RLM and BFR in NR also makes the design for RLF detection very challenging. It would be appreciated if some or all of various communication resources in NR systems, e.g., various reference signals, various cells (e.g., PCell, PSCell, SCell), multiple carriers, control channels, multiple beams, etc., may be considered in performing RLM, BFR, and link failure (e.g., beam link) detection.

However, existing NR proposals for NR RLF failed to explore the “full diversity” of BFR (i.e., to explore some or all of beam recovery possibilities that are available at the physical layer within a time limit) before generating indications to the upper layer, and thus may trigger arbitrary or unreliable indications based on transient BFR statuses. This may tangle cell-level RLF state machines and beam-level BFR state machines all together regardless of their vastly different time scales, hence causing generally unstable or non-optimized RLF behaviors. RAN WG1 (RAN1) also hasn't decided the criteria of beam failure and beam recovery failure (BRF) for NR systems yet. In RAN, the criteria of beam failure and BRR continue to be an area of research. Outstanding technical issues include, for example, but are not limited to, how the physical layer (PHY) can generate and provide (cell-specific) out-of-sync (OOS), in-sync (IS) indications or other indications for a RLF declared in the radio resource control (RRC) layer, and how to define a single procedure for interactions between a RLF entity or module, a RLM entity or module, and beam failure recovery (BFR) entity or module for both multi-beam and single-beam operations. It would be appreciated that mechanisms may be defined for multi-beam related RLM, BFR and RLF, and interactions between RLM, BFR and RLF modules in NR. RAM is designing UE triggered beam (failure) recovery procedure, targeting to overcome a sudden beam quality drop. However, no “full-diversity” indications have been considered yet in each step of a BFR procedure, particularly for step-wise generation of IS and OSS indications, and (cell-level) indication unification before sending the IS and OSS indications to a RLF module. For example, how the newly introduced PHY features in NR, such as the beamformed directional reference signals noted by xSS or xRS (instead of omni-directional cell specific RSs (CRSs) in LTE) may be used for NR RLF and beam failure detection are not defined yet. Further, the definition of RLF (e.g., link-level, cell-level, multi-cell RLF) for a UE is unclear, due to various reasons, such as multi-beam composition of each serving channel or link, spatially uncorrelated or non-quasi-co-located (QCLed) channels between control and data information, non-ideal UL and DL beam correspondence, multiple serving cells (PCell/SCell/PSCell) available at the same time, or different carriers or reference signals available for use. Moreover, interactions between L1 (or L2 or both layers) BFR state machine and the upper layer (L2 or L3) RLF state machine are unclear. For example, indication exchange in-between the L1 BFR state machine and the upper layer RLF state machine is not clear. It would be appreciated that a RLM module and a BFR module embedded in a UE may monitor downlink radio links (e.g., RSRP, RSRQ, etc.), interact with a RLF module within the same UE through in-device indications (e.g., beam-, channel- or cell-specific radio link quality metrics, or IS, OOS, or yet-to-be-defined RLF or BFR indications) for deriving link- or cell-level RLF status, and reporting the measured single or multi-beam link quality metrics and RLF status to the network.

Embodiments of the present disclosure provide methods and apparatuses for radio link monitoring, radio link failure detection, link failure recovery, and RLF declaration in NR systems. Embodiments of the disclosure provide a much-needed, modular and single and/or multi-beam unified procedure for RLF, and a mechanism for RLF-BFR interaction, to enable low-cost, scalable, and reliable RLF detection in NR systems. According to the embodiments, lower-layer BFR state machines and upper-layer RLF state machines may be properly decoupled with simple interactions. A RLF module may not need to know or care what has caused OOSs or ISs, and a BFR module masks lower-layer beam-specific dynamics (i.e., beam failure) from the RLF through an integration and unification module (IUM).

Embodiments in the following are described using beam failure detection and beam failure recovery (BFR) as illustrative examples. One of ordinary skill in the art would recognize that the embodiments may also be applied for detecting and declaring other link failure, such as non-beamformed radio link failure that may be detected by monitoring a different reference signal or recovered by using an alternative path, e.g., over other RATs, or cells, or carriers, or channels, or bandwidth parts (BWPs) other than the failed serving path. The embodiments aim to design a single procedure for interactions between a RLF functionality (or a RLF module), a RLM functionality (or a RLM module) and a BFR functionality (or a BFR module) within a UE, e.g., in cases of multi-beam or single-beam radio link operations in a single serving cell or across multiple serving cells. Throughout the disclosure, the terms of “RLF module”, “RLF functionality” and “RLF” are used interchangeably. Similarly, the terms of “RLM module”, “RLM functionality” and “RLM” are used interchangeably, and the terms of “BFR module”, “BFR functionality” and “BFR” are used interchangeably.

An embodiment unified 5G NR RLF detection mechanism effectively interacts with an embodiment underlying full-diversity BFR mechanism. A BFR mechanism refers generally to a BFR process (or procedure) that includes detection of a link (beam) failure and recovery of a failed link. The BFR process may be typically performed, e.g., by a BFR module, at the physical layer of a UE. The BFR module monitors serving link quality metrics on a serving link (e.g., over a specific serving beam) and detects whether a link problem has occurred (link or beam failure has occurred). If a link problem is detected or identified, the BFR module may attempt to solve the problem (e.g., recover failed link, or find an alternative beam, or realign the failed beam). If the problem can be solved, and the failed link or beam is recovered, the UE does not count the detection of the link problem as an OOS event for determining a RLF.

The “full diversity” BFR mechanism refers to a BFR process that generally has, exhaustively or selectively but sufficiently timely, considered multi-dimensional diversified factors or choices in any or all steps of the BFR process, and has reached a conclusion about BFR status (e.g., success or failure) before sending any BFR indications about its status to an upper layer (e.g., a RLM module or a RLF module). However, this does not preclude BFR or RLM to generate link quality indications as ISs or OOSs if deemed as necessary, e.g., based on network configurations or timers. By adopting the “full diversity” approach, such indications may be avoided or reduced if BFR can succeed by exploring the other “diversity” factors. These multi-dimensional diversified factors or choices may be referred to as communication paths, or communication and signaling paths. A communication path may include a combination of resources that is usable by a UE to connect to and communicate with a wireless network over a radio link. A resource herein may include a different radio access technology (RAT), a cell, a communication channel, a beam (or BPL), a carrier, a communication direction, or a reference or synchronization signal. A UE may communicate with a wireless network through one or multiple cells, such as a PCell, a PSCell or a SCell. A cell may support one or multiple carriers for communication with the UE. The UE may also communicate with the network using multiple beams. In this case, beamformed directional reference signals may be sent to the UE. Examples of reference signals may include a SS block or synchronization signal (e.g., a PSS, a SSS), a DM-RS, a CSI-RS, or other reference signals that may be used in the wireless network, e.g., a 5G (NR) network. For purposes of clarity, reference signals in this disclosure are generally represented using xSS or xRS. A communication channel for uplink may include different transmission media, e.g., an uplink RACH preamble versus a MAC Control Element, or a scheduling request over a supplemental uplink carrier versus a main carrier versus a secondary carrier. A communication channel for downlink may include a control channel (e.g., PDCCH) versus a data channel (e.g., a PDSCH) versus a broadcasted PBCH. A communication direction may include an uplink direction that may still work versus a failing downlink direction. As an illustrative example, a communication path may include a combination of resources, such as a beam or beam pair link (e.g., a serving beam of a specific direction), a carrier (e.g., a serving main carrier), and a cell (e.g., a serving cell, such as a PCell, a PSCell or a SCell). A UE may connect to a network using the serving beam over the serving carrier through the PCell. The communication path may also include other resources or information that are used by a UE for connecting and/or communicating to a network, such as a control channel or a data channel in which the UE is communicating with the network, one or more reference signals that are communicated to the UE, a communication direction, e.g., uplink or downlink, in which the UE communicates with the network.

Multiple communication paths may be available for connection and communications between the UE and the network for a radio link, e.g., in cases of multiple beams, multiple carriers and multiple cells available. For example, the UE may communicate with the network using a same beam and a same carrier but different cells (e.g., a PCell and a SCell). In another example, the UE may communicate with the network using different beams over a same carrier or cell. In yet another example, the UE may communicate with the network using different beam links over different carriers or different cells. In these cases, when a failure occurs in the radio link, the UE may select another available communication path to recover the radio link in a fast physical layer process that may be transparent to RLF or slower upper layers, and thus be able to continue to communicate with the network. As a result, the UE may not need to send any indication about the failure occurred in the radio link. For example, a UE detects a beam link failure has occurred on a serving beam link during communications with a network over a radio link. The UE may perform a BFR or link recovery process at the physical layer before generating an OOS indication to indicate the beam link failure. In the BFR process, the UE may identify a second beam path that is available for recovering the failed beam link. The UE may then use the identified second beam path to continue communications and to sustain the radio link between UE and the network without generating any OOS indication. In this way, the BFR process recovers a failed link, and generally reduces OOS indications generated, thus may consequently reduce the need to declare RLF at the upper layer. Communication paths available for a UE to select may be pre-configured, or dynamically configured. Communication paths configured for a UE may be viewed as specific points (or instances) in a multi-dimension space, formed by variable such as beam, reference signal, carrier, cell, channel, and/or others. Selecting a communication path may be performed by searching, in the multi-dimension space, a specific point from a plurality of selectable points, e.g., according to a criterion.

A link failure recovery process may include multiple steps of link recovery operations for detecting a link failure and recovering a failed link. Taking BFR for example, a link failure occurs possibly due to serving beam mis-alignment or blockage or signal deterioration. In some embodiments, a BFR process includes four BFR steps or link recovery operations, that is, BPL or beam failure detection (step 1), new beam identification (step 2), beam recovery request (step 3), and BFR recovery response monitoring (step 4). The four BFR steps are performed sequentially. At step 1 (i.e., the step of BPL failure detection), in one embodiment, a UE may measure the serving beam pair links in a configured serving (e.g., control) channel (CH) by measuring specific reference signals (e.g., xSSs, and/or xRSs) in any or all of UE-specific serving cells (e.g., a PCell, a PSCell or a SCell). For example, a UE is communicating with a wireless network using a communication path over a radio link. The UE may detect whether there is link failure occurring in the radio link based on measurements of a link quality metric, such as RSRP, performed by the UE on two communication paths based on SSBs and CSI-RSs that are carried over two BPLs, respectively. In one embodiment of “full diversity” exploration, when the RSRP of both reference signals, e.g., SSBs and CSI-RSs, drops below a threshold for a certain period of time, the UE may indicate that it detects a link failure; Otherwise, i.e., when the RSRP of one of the two types of reference signals drops below the threshold, the UE may determine that the link is still working with one path (BFL) becomes misaligned. At step 2 (i.e., the step of new beam identification), in one embodiment, upon the UE determines that a BPL failure is detected, the UE may explore one or more feasible (or available) beam pairs (i.e., communication paths), based on a configuration of a source or a target serving channel, to determine whether there is alternative communication paths (e.g., one or more beam pairs) available for recovering the radio link. An available beam pair may be for DL or UL transmission. An available beam pair may be for control or data transmissions. An available beam pair may also be in any of serving cells of the UE (e.g., a PCell, a SCell and/or a PSCell). An available beam pair may be carrying any or all reference signals. The UE may identify one or more beam pairs (carrying a specific reference signal) that may be used to recover the radio link, and use one, some or all of the identified beam pairs to recover the radio link.

At step 3 (i.e., the step of beam recovery request), upon the UE identifying an available beam pair for recovery, the UE may send a beam recovery request to the network. The request may be used to determine whether an UL transmission may be received by the network. The UE may explore and evaluate a “full diversity” of feasible (or available) UL paths for transmitting the beam recovery request to the network. For example, the UE may evaluate various control or data channels, including a RACH, a PUCCH, a PUSCH, etc. to determine a path (e.g., a specific channel or multiple channels in combination) for transmitting the beam recovery request. The UE may also evaluate multiple paths or options for signaling the beam recovery request. For example, the beam recover request may be signaled in different layers, including L1, L2 or L3 signaling, and, e.g., in uplink control information (UCI), in a medium access control (MAC) Control Element (CE), in a scheduling request (SR), in a sounding reference signal (SRS). The UE may evaluate various cells and/or frequency carriers for transmitting the beam recovery request. For example, the beam recovery request may be transmitted in any or all UE-specific serving cells (a PCell, a SCell, and/or a PSCell). The beam recovery request may be transmitted using the same carrier, or mixed carriers of a low frequency (LF) or a high frequency (HF).

At step 4 (i.e., the step of BFR recovery response monitoring), after sending the beam recovery request in an UL path, the UE may monitor a BFR recovery response transmitted by the network in response to the beam recovery request. By receiving the BFR recovery response, the UE may determine that the link failure may be recovered using the selected communication path at step 2. The UE may explore and evaluate a full diversity of feasible DL paths to determine a DL path or multiple DL paths for monitoring the BFR recovery response. In one embodiment, a successful reception of the response over any selected DL path within a configured time limit may be considered a successful response. The UE may evaluate various channels, carriers, serving cells, and/or signaling, and determine a DL path or multiple DL paths to monitor the response within a time limit. For example, the UE may evaluate various control and data channels (e.g., a physical downlink control channel (PDCCH), a physical downlink shared channel (PDSCH), etc.), L1, L2 and/or L3 signaling (e.g., downlink control information (DCI), radio resource control (RRC), a MAC CE, etc.), one or multiple serving cells (e.g., a PCell, a SCell and/or a PSCell), and/or one or multiple carriers in each cell, etc. The UE may perform evaluation based on various reference signals, e.g., SS blocks, PSSs, SSSs, xRSs, etc.

In some embodiments, each of the four steps of the embodiment BFR process above may attempt to, exhaustively or selectively but timely (e.g., based on a network configured timer-constraint) and sufficiently (e.g., with retries of request-response under network configured maximum retry count limit), resolve a beam failure at L1 and/or L2 without triggering a RLF action (e.g., RLF declare) at an upper layer. Performing of the BFR process may trigger generation and sending of a BFR indication. The indication may be a timer-based (e.g., as periodically in LTE), a periodic, aperiodic, or event-based indication (e.g., an OOS indication or an IS indication for a link connectivity, or a BFR operation success or failure status). The indication may be a BFR failure indication or an 00S indication indicating that the BFR has failed. In one embodiment, failure of any of the above four steps may sufficiently causally trigger an indication to be sent to an upper-layer RLF or RLM, indicating that the BFR has failed. The Step 1 may cause BFR failure in situations such as Step 1 fails to generate IS indications in time i.e., detect the recovery of the failed link quality correctly, or Step 1 fails to trigger Step 2 (e.g., by identifying a feasible alternative path). In one embodiment, upon the timely and successfully accomplishment of all of the four steps in the BFR process above, the BFR process may be determined to be successfully performed. That is, a link failure is detected, a new beam pair is identified for recover the link, a beam recovery request is sent, and a BFR recovery response is received in response, each of which is accomplished within a predetermined time period. In this case, a BFR success indication (indicating that BFR has succeeded), or an IS indication, may be sent to a RLF or a RLM. In one embodiment, RLF status, timers, and other information in the upper layers may be transmitted or indicated to the lower layer (e.g., L1 or L2), which may be used to generally optimize (e.g., reset, postpone, early terminate, or accelerate upon an event of RLF declaration or link recovery) a BFR state machine, or the BFR process.

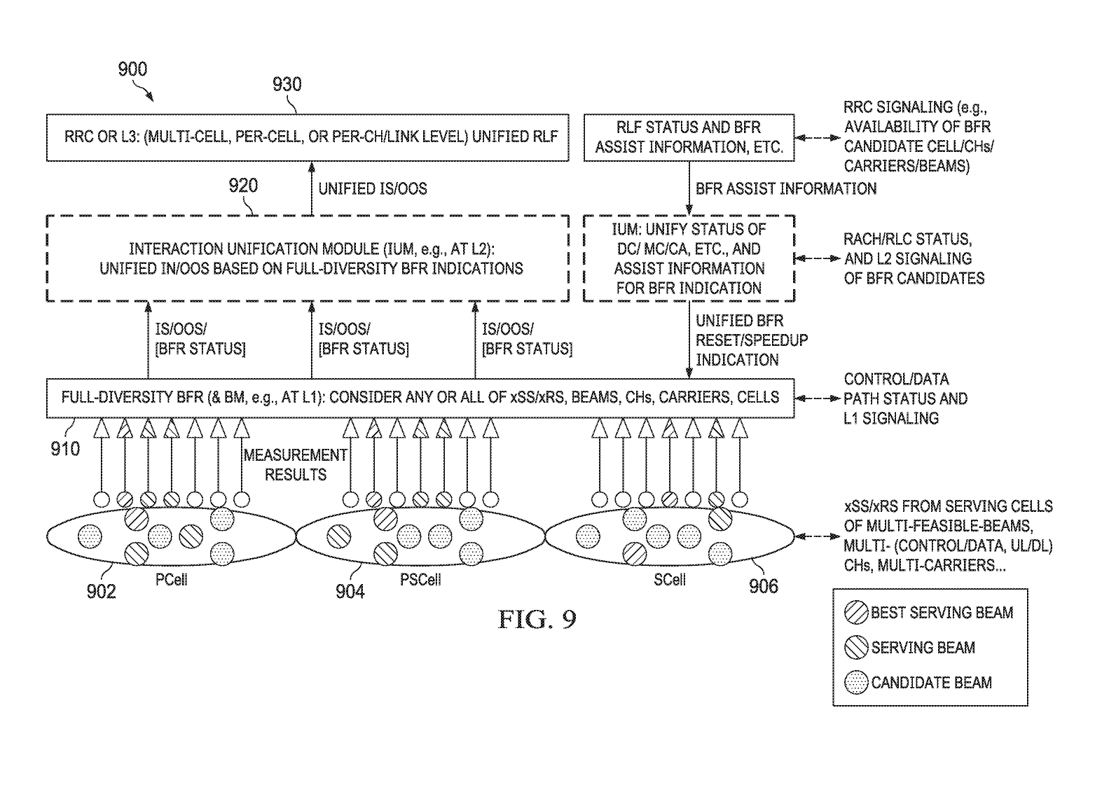

FIG. 9 illustrates a diagram of an embodiment structure 900 at a UE for RLF detection involving underlying BFR and beam management (BM) or RLM. FIG. 9 illustrates an embodiment of a full-diversity BFR and RLF mechanism, and interactions between different modules at the UE. In this example, the UE may communicate with a network through multiple cells, e.g., a PCell 902, a PSCell 904 and a SCell 906, using multiple beams. FIG. 9 illustrates multiple beams in each cell 902, 904, 906. FIG. 9 shows one or more beams in each cell as serving beam(s), one best serving beam for each cell, and multiple candidate beams in each cell. The embodiment structure 900 includes a BFR module 910, an integration and unification module (IUM) 920, and a RLF module 930 embedded in the UE.

The BFR module 910 may be located at layer 1 (i.e., L1). The UE may perform a full-diversity BFR process, e.g., the four steps of the BFR process described above by exploring one or multiple options or communication paths at each step. The BFR module 910 may consider different communication paths when performing each of the four steps. Each communication path may include a reference signal (e.g., an xSS or an xRS), a beam, a channel, a carrier, a cell, or any combination thereof. The BFR module 910 may monitor downlink radio links, e.g., monitoring link quality metrics such as RSRP, RSRQ, and etc., by reusing RLM measurements or by using an independent measurement mechanism. The UE may perform measurements to generate measurement results on the cells 902, 904, 906, using different types of reference signals received from one or more its serving cells in one or multiple feasible beams, in one or multiple channels (including, e.g., a control channel, a data channel, an uplink channel, a downlink channel, etc.), and/or in multiple carriers. The BFR module 910 may interact with the RLF module 930 within the same UE through in-device indications. For example, the BFR module 910 may generate and report various indications to the RLF module 930, for the RLF module 930 to derive link-level or cell-level RLF status.

The indications communicated by the BFR module 910 may be generally referred to as BFR status indications, BFR indications, radio link indications, or link recovery (status) indications. The BFR indications may be generated periodically, aperiodically, based on events, timer or counter. The terms of “BFR status indication” and “link recovery indication” may be used interchangeably in this disclosure. A link recovery indication may include an aperiodic indication (e.g., the same IS indication as defined for RLM) corresponding to a link recovery (or BFR) success, or an aperiodic indication (e.g., the same OOS indication as defined for RLM) corresponding to a link recovery (or BFR) failure, or a periodic or event-based link recovery status (or BFR status) to indicate success or failure. A link recovery status may include failure detection instance, identified new beams, measured reference signal strength or control or data channel quality, feasibility of an identified beam path according to a configured criterion, stepwise success or failure under a configured, timer or counter based constraint, or final success or failure status of the link recovery (e.g., BFR) process. In some embodiments, a BFR status indication may include beam-specific, channel-specific, carrier-level or cell-specific radio link quality metrics (e.g., measured single or multi-beam link quality metrics). A BFR status indication may include an IS indication, an OOS indication, or yet-to-be-defined RLF or BFR indication. For example, as discussed above, the BFR module 910 may generate an OOS indication when any of the four steps in the BFR process fails. The BFR module 910 may generate an IS indication when all of the four steps in the BFR process succeed. A BFR status indication may further include an indication indicating whether or not a link failure (e.g., beam failure) is detected, whether or not a link recovery (e.g., BFR) fails, whether or not a link (or beam) recovery request upon a new communication path is identified is sent successfully, and/or whether or not a link (or beam) recovery response is successfully received. A BFR status indication may also indicate a communication path that is identified for recovering a failed link.

The BFR module 910 performs a BFR process, and determines what indications to be generated and reported to the upper layers. A BFR process succeeds if all of the four BFR steps in the above succeed. For example, step 1 succeeds upon a BPL quality drop is detected, or a BPL quality recovery is detected correctly within the time limit; step 2 succeeds upon a new beam (e.g., a new communication path) is identified; step 3 succeeds upon a beam recovery request is successfully sent; and step 4 succeeds upon a BFR recovery response is successfully received. If any of the steps for recovering a failed link (referred to as recovery steps), e.g., steps 2-4 , the UE may generate a BFR failure indication, e.g., a special OOS indication or an explicit aperiodic BFR failure. If all the four steps succeed, the UE may generate a BFR success indication, e.g., a special IS indication or an explicit aperiodic BFR success. In this case, BFR succeeds, and the failed link may be recovered. That is, when a link failure is detected, the UE determines whether the failed link (or path) may be recovered before sending an OOS indication to the upper layer in either Step 1 or thereafter. If the BFR succeeds at physical layer very quickly, the UE may not send an OOS indication to the upper layer, thus reducing or even avoiding triggering the upper layer RLF. The BFR module 910 may explore various options to accomplish its due missions (e.g., determining whether the failed link can be recovered), as much as possible and as quickly as possible (e.g., with time constraints) before sending any indication (or trigger of RLF) to the upper layer (e.g., L2 or L3). The UE may, at each of the recovery steps in the BFR process described above, explore various available choices or paths for making quick and solid determination of BFR success or failure with time constraints. For example, a failed control CH (or beam) in cell 1 is detected in steps (with OOS indications), yet the failed CH is not detected as recovered (without IS indications), a beam recovery request in step 3 may be piggy-backed in a medium access control (MAC) control element (CE) over a UL data CH (or beam) or a RACH in cell 2 (which is identified in Step 2), as long as time allows (e.g., based on a timer). Determining success or failure of early steps (with the recovery steps performed sequentially since failure detection) or exploring more diversity paths at each step may allow determination of a BFR success or failure to be done as fast as possible, and therefore save unnecessary later steps or redundant diversity exploration and unnecessary indications to RLF. Each step may provide indications directly to the RLF module 930, or indirectly to the RLF module 930 through the IUM 920.

The UE may also perform RLM functions, such as performing RLM channel metrics (e.g., RSRP or RSRQ) measurements, generate periodic or aperiodic IS and OOS indications or other indications, and send the indications to the RLF module 930. The RLM functions may be performed by a RLM module at L1 (not shown). The RLM module may be separate or independent from the BFR module 910, or integrated with the BFR module 910. The RLF module 930 may receive the indications generated by the RLM module, and count consecutive IS or OOS indications for timer-based RLF operations, as performed in the existing LTE systems.

The IUM 920 is configured for facilitate interaction between the BFR module 910 and the RLF module 930. The IUM 920 may be used to unify (e.g., combine, filter, or forward) various indications from the RLM and the BFR, or indications from multiple paths of the failing link in the BFR, and to generate unique event- or timer-driven indications (e.g., IS, OOS) for the upper layer (L2 or L3) RLF module 930. The IUM 920 may filter or unify L1 or L2 multi-dimensional OOS or IS for link connectivity, or BFR success/failure status indications into unified per-cell OOS and IS indications. The IUM module 930 may also forward indications as is. New indications may also be created that are different than the OOS and IS indications, and used together with the OOS and IS indications. In one example, the IUM 920 may receive BFR status indications from the BFR module 910, e.g., indication generated based on the BFR recovery steps in the above, and/or indications generated by a RLM module. The IUM 920 may collect various indications, generate a unified indication, e.g., a combined IS or OOS indication stream, and report the unified indication stream to the RLF module 930. The IUM 920 may derive unified IS and OOS indications in sequence, or in parallel, each at a configured level across one or multiple serving cells (a PSCell, a SCell, a PCell, etc.), carriers, reference signals (e.g., xSSs and xRSs), cell groups (e.g., a secondary cell group (SCG), a master cell group (MCG), etc.), CHs (per cell or per-carrier, etc.), beams (per CH), etc. For example, a unified indication generated by the IUM 920 may be cell specific, carrier specific, beam specific, or channel specific. In one example, the IUM 920 may generate a unified indication specific to a beam pair link over which the UE is communicating with a base station, based on BFR status indications that are related to the beam and reported by the BFR module 910 and/or a RLM module. The unified indications generated by the IUM may be referred to generally as RLF indications, e.g., an RLF IS or OOS indication. The RLF indications will be used by the RLF module to determine RLF.

The IUM 920 may also consider RLF state machines and other upper layer information to assist the lower layer BFR operations as well. The IUM 920 may derive unified BFR assistance indication in sequence, or multiple of them in parallel, from upper layer information. For example, the IUM 920 may collect, from upper layers, information about RLF status, DC status, Multi-connectivity (MC) status, CA status, handover status, Radio Resource Management (RRM) status, RRC status, and other BFR assistance information, unify the information to generate BFR assistance indications , and communicate the BFR assistance indications with the BFR module 910.

The IUM 920 may be implemented as hardware or software, or a combination thereof. The IUM 920, as shown, is located at layer 2 (i.e., L2). However, IUM unification functions may be centralized or distributed at any or all specific layers (L1˜L3), i.e., as an independent module or integrated into a RLF module or a BFR module. In some embodiments, the IUM 920 may be located at a single protocol layer, or distributed across multiple protocol layers. The IUM 920 may be located in a single or multiple modules, e.g., the BFR module 910, a beam management (BM) module (not shown), a RLM module (not shown), and/or the RLF module 930. For clarity, BM may refer to any beam-specific operations, including beam alignment, beam refinement, beam tracking, and beam switching with respect to the same serving node, node family (e.g., a transmission and reception point (TRP) and its parent cell or gNB), or strictly synchronized nodes (e.g., multiple TRPs that literally cannot be distinguished by UE from beam operations' perspective). For purposes of clarity, a TRP is intended to refer to a unit of a serving node inside or at the edge of a network that talks to a UE over the air radio. A TRP may typically refer to a remote radio head (RRH) with or without PHY or MAC.

In general, going upward from the lower layers to the upper layers in FIG. 9, the IUM 920 may derive unified IS and OOS indications in a time sequence, or in parallel, each at a configured level for a target radio link across one or multiple serving cells or carriers (e.g., a PSCell, a SCell, and/or a PCell, etc.), corresponding to one or multiple reference signals (e.g., a xSS and/or a xRS), in a single or multiple cell groups (e.g., a SCG and/or a MCG, etc.), for a single or multiple CHs (in each cell or over each carrier, etc.), based on a single or multiple serving beams (per CH), etc. Going downward from the upper layers to the lower layers, the IUM 920 may derive unified BFR assistance indications in a time sequence, or in parallel, from upper layer information. The upper layer information may include information about DC, MC, CA, HO, RLF, RLM, RRM, RRC status, etc. to assist or optimize BFR operations at the UE. IUM unification functions may work from lower BFR to upper layers RLF (to generate unified IS, OOS indications), or reversely from upper layer RLF to the lower layer BFR (to generate unified BFR assistance information), at a single UE or network devices, or operate end-to-end (involving UE-side and network-side signaling). Unification functions may be based on other numerical formats of CH_quality, for example, rather than AND and OR combinations of per-beam or per-CH IS or OOS, etc.

The RLF module 930 may receive unified indications from the IUM 920, and determine whether or not a RLF should be declared based on the indications. For example, the RLF module 930 may receive IS and OOS indications, and count consecutive IS or OOS indications for timer-based RLF operations, as performed in the existing LTE systems. A RLF may be cell specific, channel specific. A RLF may be declared for multiple cells. A RLF declared may be per cell, or per channel. A RLF declared may be on a link level. The RLF module 930 may be located at layer 3 (i.e., L3, or RRC layer). The UE may communicate with a (remote) network device, e.g., a base station, at each of layers L1-L3. For example, at L1, the UE may communicate with the base station using L1 signaling, e.g., for information such as control or data path status. At L2, the UE may communicate with the base station in L2 signaling, e.g., regarding RACH or RLC status, or BFR candidate paths. At L3, the UE may communicate with the base station, e.g., using RRC signaling, for information about the availability of BFR candidate cells, channels, carriers and/or beams. The layer-specific signaling provides over-the-air inputs for each layer of link operations within the UE.

The embodiment RLF mechanism shown in FIG. 9 may be referred to as a unified RLF mechanism, because unification of multi-source indications in-between different modules is provided and used for determination of RLF. The embodiment BFR and RLF mechanisms keep the RLF state machine at Layer 3 (in LTE system) as intact as possible, handle multi-beam BFR at L1 (or L2) as comprehensively and timely as possible. The RLF module may only consider IS and OOS indications, network configured or pre-determined, that are unified from full-diversity BRF indication (including BFR status), such as aperiodic or event-driven IS or OOS indications, or any other (e.g., multi-beam RLM generated periodic) IS or OOS indications. As a result, RLF detection may be performed using a uniform procedure, regardless of single or multiple underlying serving beams, reference signals, cells, CHs, and carriers, etc.

In some embodiments, each of the four steps of the embodiment BFR process discussed above performed by a UE may use multi-beam RLM measurements as inputs. The UE may select and consolidate multiple feasible beams, similar to those used in multi-beam radio resource management (RRM) in NR, or as an extension to the multi-beam RRM in NR. The UE may derive CH-level or cell-level RLM metrics by measuring multiple beams based on configuration received from a network. Failure or timeout of a step in the BFR process may trigger generation of a (per-CH or per-cell) RLF OOS indications, e.g., with or without an IUM function. In some embodiments, an OOS (or an IS) indication may be generated if an OOS (or an IS) generation condition (or criterion) is met, and/or if a layer-specific indication frequency control timer or periodic timer is triggered for a measured cell or a CH per carrier.

In some embodiments, each specific beam may carry a specific xSS and/or xRS of a serving carrier (or a CH and/or a cell), and a UE's PHY layer may adopt revised or similar RLM mechanisms as used in LTE (e.g., performing L1 sampling and filtering on link quality metrics, and defining IS and OOS generation intervals). Each of the four BFR steps in the embodiment BFR process may have its signaling and/or decision mechanisms regardless of the number of serving beams, CHs, or cells available for the UE to use. In this case, an IS or an OOS indication may be generated upon an indication (e.g., for IS or OOS) generation condition is met. An indication generation condition may be channel specific, or cell specific. In one embodiment, an indication generation condition may include a multi-beam CH-specific OOS generation condition, which may be met in various situations. For example, a multi-beam CH-specific OOS generation condition may be met when the following Criterion 1 and Criterion 3, or Criterion 2 and Criterion 3 are satisfied.
Criterion 1: a filtered and/or sampled RLM metrics is less than an OOS threshold (e.g., Qout), i.e., the RLM metrics <Qout;
Criterion 2: a hypothetical BLER of a CH (e.g., a PDCCH) is greater than an OOS threshold (e.g., threshold_OOS) based on a UE- or a channel-specific xRS (e.g., a CSI-RS or a DMRS);
Criterion 3: a timer to control an OOS generation frequency is triggered.

Criterion 1 is generally equivalent to Criterion 2. Criteria for generating an IS indication may also be defined similarly. For example, a multi-beam CH-specific IS generation condition may be met when the following Criterion 4 and Criterion 6, or Criterion 5 and Criterion 6 are satisfied. CH-specific indications may become beam-specific if there is only one beam per channel.
Criterion 4: a filtered and/or sampled RLM metrics is great than an IS threshold (e.g., Qin), i.e., the RLM metrics>Qin;
Criterion 5: a hypothetical BLER of a CH (e.g., a PDCCH) is less than an IS threshold (e.g., threshold_IS) based on a UE- or a channel-specific xRS (e.g., a CSI-RS or a DMRS);
Criterion 6: a timer to control an IS generation frequency is triggered.

In some embodiments, an indication generation condition may include a common OOS generation condition. The common OOS generation condition may be met upon a UE failing to receive and decode cell-specific common signals, e.g., PSSs, SS blocks or PBCHs (with a corresponding DMRS), for a count limit (e.g., of combined OOSs generated separately for each signal), or over a certain time period (e.g., using a timer). An example of the time period may include one or multiple cycles of beam sweeping, where each cycle may be equivalent to one SS-block-burst set period.

One or more RLF OOS (and IS) indication generation conditions may be defined to unify and generate RLF OOS and IS indications using IUM functions. IUM functions (e.g., unification functions) may be per-CH, per-signal, per-carrier, per-cell, multi-cell, per-cell group, or any combination thereof, based on scenarios or configurations for generation or reporting of indications. In some embodiments, a per-cell RLF OOS indication may be generated by the IUM functions (e.g., an IUM), upon any one of the following conditions A-E is met, or when periodically the conditions are found to be met.

Condition A: a CH-specific OOS generation condition of a common DL control CH (e.g., a common PDCCH) is met; or

Condition B: a CH-specific OOS generation condition of a UE-specific DL control CH (e.g., a UE-specific PDCCH) is met; or

Condition C: a common OOS generation condition is met; or

Condition D: a link or BFR status is determined indicating either eventual link or BFR failure or stepwise (out of the multiple steps in a BFR process) failure, or upon criteria-based channel quality drop occurring, as described above; or

Condition E: a link (or BFR, or BM) event, or a control timer for reporting or generating indications, is triggered.

A CH-specific OOS generation condition may be determined using the Criteria 1-3 described above. A common OOS generation condition may be determined similarly as described above.

In some embodiments, the above Conditions A-E may be used in combination for determining whether an RLF OOS indication may be generated by an IUM module, e.g., using logical AND, or mixed OR and AND, etc., or using other mathematical operations. One, multiple, or all of the Conditions A-E may be combined, by OR or AND, with other orthogonal conditions to define IUM functions. In one embodiment, weighted sum of Conditions A-E may be used to determine generation of a RLF OOS indication. In a case where a weight of 1 or 0 is used, Conditions A-E may be viewed to be equally considered (i.e., by average) or to be priority-based. For example, a RLF OOS may be generated by only considering a PSCell or a PCell, or a specific xRS. Which of the Conditions A-E will be used, and how the Conditions A-E are combined may be pre-configured and configurable.

A per-cell RLF IS indication may also be generated by the IUM module (functions) upon one or more conditions are met. For example, a per-cell RLF IS indication may be generated when a CH-specific IS generation condition of a common DL control CH (e.g., a common PDCCH) is met, when a CH-specific IS generation condition of a UE-specific DL control CH (e.g., a UE-specific PDCCH) is met, when a common IS generation condition is met, when a link or BFR status is determined indicating BFR success (or link recovery success), upon channel quality satisfying a predetermined criterion, or when a link (or BFR, or BM) event, or a control timer for reporting or generating indications, is triggered. An RLF indication, either OOS or IS indication, may be per-cell, per-channel, per-carrier, or per signal. This may depend on whether the link or its BFR status is cell-, beam-, channel-, carrier-, or signal-specific.

In some embodiments, multi-cell OOSs or ISs may be unified by an IUM, e.g., by applying one or more RLF OOS or IS indication generation conditions (e.g., a combination of Conditions A-E) to multiple serving cells (e.g., a PSCell, a PCell, and/or a SCell), or cell groups all together, or by only combining cell-level RLF OOS or IS indications that are generated by the IUM per-cell.

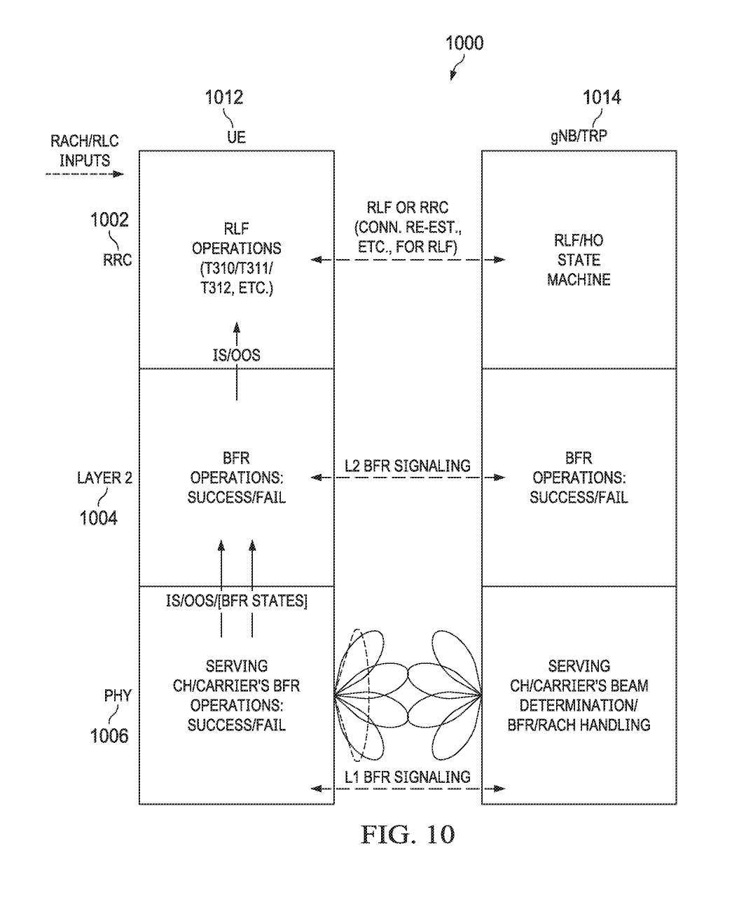

FIG. 10 illustrates a diagram of an embodiment end-to-end and cross-layer framework 1000 for RLF detection. FIG. 10 illustrates end-to-end and layer-by-layer signaling between a user-side device, e.g., a UE 1012, or any other user devices capable of wireless communication (e.g., a tablet, a PC, etc.), and a network device, e.g., a gNB or TRP 1014 taking place in layer 1002 (L3), layer 1004 (L2), and 1006 (PHY layer, or L1). Note that the layering illustrated in FIG. 10 is demonstrative in nature, and may vary in different embodiments. For example, functions in L2 1004 may be considered as part of a RLM module (which may span multiple protocol layers) that performs unification functions of an IUM, e.g., the IUM 920 in FIG. 9. Additionally, in different embodiments, L2 1004 in the UE 1012 may be simply removed, and BFR operations in lower layer may directly provide causal (with sufficiency) foundation to trigger IS, OOS or other BFR indications to the upper layer RLF state machine. Further, the illustration of BFR operations in L2 1004 is merely for example purposes.

In the PHY layer 1006, the UE 1012 may communicate L1 BFR signaling with the gNB/TRP 1014. The UE 1012 may also monitor (DL) beamformed reference signals from the gNB/TRP 1014 as part of a multi-beam RLM process and/or the full diversity BFR process as described above. Note that the full diversity BFR process may derive BFR (success or failure) status, IS, or OOS indications, by considering a multi-dimensional resource space formed by beams, signals, cells, and channels, etc., over the air in layer 1006. In the layer 1004, the UE 1012 and/or the gNB/TRP 1014 may jointly determine if the BFR process succeeds or fails through L2 BFR related signaling (e.g., in a MAC CE). In layer 1002 (or RRC layer), RLF operations with a plurality of timers and counters may be set up and performed based on IS and OOS (and possible BFR state) indications reported from the lower layer, in conjunction with other orthogonal inputs from RLF, RACH, or RLC state machines, and over-the-air RRC signaling exchange regarding RLF or HO states of the gNB/TRP 1014 and UE-side states of the UE 1012, to derive RLF state machine in the gNB/TRP 1014.

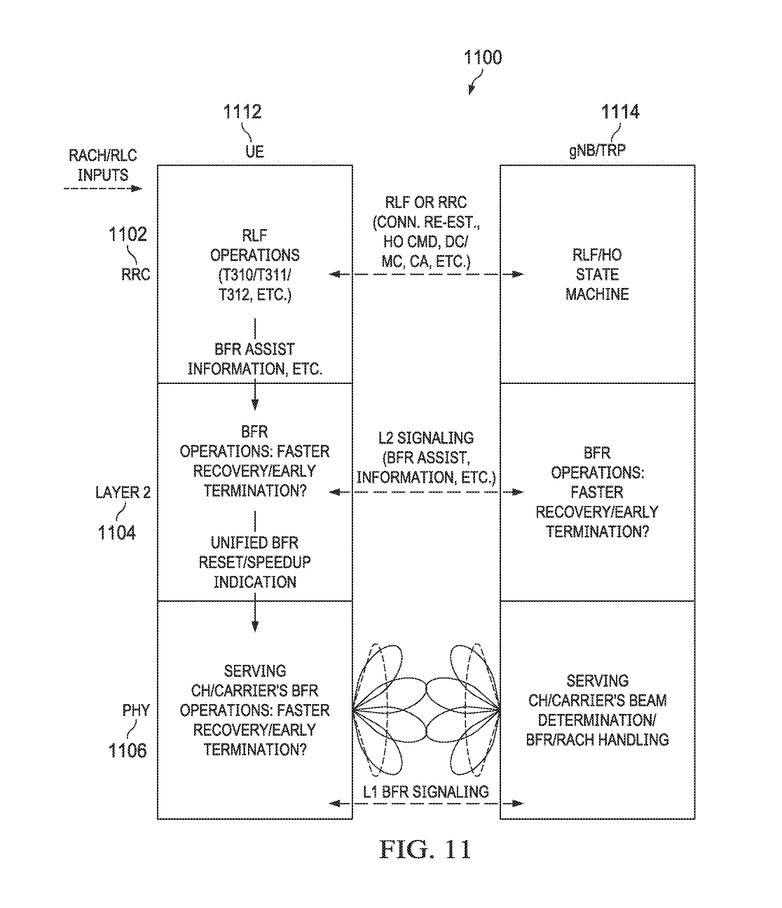

FIG. 11 illustrates a diagram of another embodiment end-to-end and cross-layer framework 1100. FIG. 11 is generally similar to FIG. 10. However, FIG. 10 illustrates indications reported bottom-up or upward from the lower layer to the upper layer, while FIG. 11 illustrates an opposite direction, i.e., indications are sent top-down or downwards from the upper layer to the lower layer. FIG. 11 illustrates end-to-end and layer-by-layer signaling between a user-side device, e.g., a UE 1112 (or any other user devices including a tablet, PC, etc.), and a network device, e.g., a gNB or TRP 1114 occurring at a layer 1102 (L3), layer 1104 (L2), and layer 1106 (PHY layer). Note that the layering here is merely for illustration purposes and may change in different embodiments. FIG. 11 shows that the upper layer 1102 (including RLF operations, etc.) may assist to optimize a lower layer (e.g., L2 1104 or PHY 1106 for BFR operations) operations, while in FIG. 10, a lower layer (e.g., PHY layer 1006 or L2 1004 for BFR) assists an upper layer (e.g., L3 1002 for RLF) operations. In one example, functions in L2 1104 may be considered as part of a RLM (which may span multiple protocol layers) for performing unification functions. The L2 1104 in the UE 1112 may be simply removed, and the BFR operations in the lower layer 1106 may directly take inputs (e.g., BFR assistance information or indications) from the L3 1102 to optimize generation of BFR indications. The BFR operations in L2 1104 may exist in a case when L2 BFR signaling (e.g., MAC CE) is available.

Information of the upper layer RLF state machine, together with relevant BFR assistance information, are sent from the upper layer to the low layer to help terminate a BFR process earlier and determine a BFR failure or reset a BFR state machine, or speed up a BFR process and determine a BFR success or link recovery. Such assistance information may include information communicated based on RLF or RRC over-the-air signaling (e.g., a HO command, RRC connection re-establishment, DC, MC, or CA signaling related to carrier or cell addition or removal), or positioning-based beam discovery or recovery assistance, or any alternative communication path over another carrier or cell in a PCell, a PSCell or a SCell in DC, CA, or MC enabled systems. In the example shown in FIG. 11, the UE 1112 communicates with the gNB/TRP 1114 using L1 BFR signaling in the PHY layer 1106, using L2 BFR signaling in the L2 layer 1104, and using RLF or RRC signaling or data paths in the RRC layer 1102.

In the L2 1104, the UE 1112 and the gNB/TRP 1114 may jointly determine if the BFR operations may be optimized through L2 BFR related signaling (e.g., MAC CE). In the PHY layer 1106, the UE 1112 communicates L1 BFR signaling with the gNB/TRP 1114, and monitors (DL) beamformed reference signals from the gNB/TRP 1114 as part of multi-beam RLM and/or the full diversity BFR process described above. The full diversity BFR operations may derive BFR (e.g., success or failure) status, IS, or OOS indications, by considering multi-dimensional beams, signals, cells, and channels, etc., over the air in layer 1106, and also considering information including the upper-layer provided BFR reset or speedup indications, or BFR assistance information. In the PHY layer 1006, BFR operations with a plurality of timers and counters and over-the-air signaling (BFR request and response) may be set up, and performed based on beamformed reference signals, new beam identification, or in conjunction with other orthogonal inputs from upper layer. Thus, the BFR operations may be generally optimized, e.g., the BFR operations may be expedited or performed more efficiently.

In some embodiments, for both FIG. 10 and FIG. 11, the UE-side BFR and RLF operations may be mirrored to the gNB/TRP side for UL based RLM. A gNB/TRP may be from a PCell, a PSCell, or a SCell, communicating with a UE over different carriers simultaneously in addition to a monitored carrier. A monitored link or CH may be a control channel, a data channel, or a combination thereof, which may be used to decide a target link (BFR or RLF) status. IUM functions for unification of IS, OOS, or BFR reset, BFR speedup indications may be located anywhere between L1 (PHY) and L3 (RRC), or integrated into L1 or L3, or distributed in any layers. Interactions between a RLF module and BFR module on a UE or a network device (e.g., a gNB or TRP) may involve the IUM functions, e.g., as provided by an IUM (e.g., the IUM 920 in FIG. 9), at L2. RLF, IS, OOS, link and/or BFR states may be for multi-cell, per-cell, per-CH, per-signal, or per-carrier, per-link, or as a combination thereof.

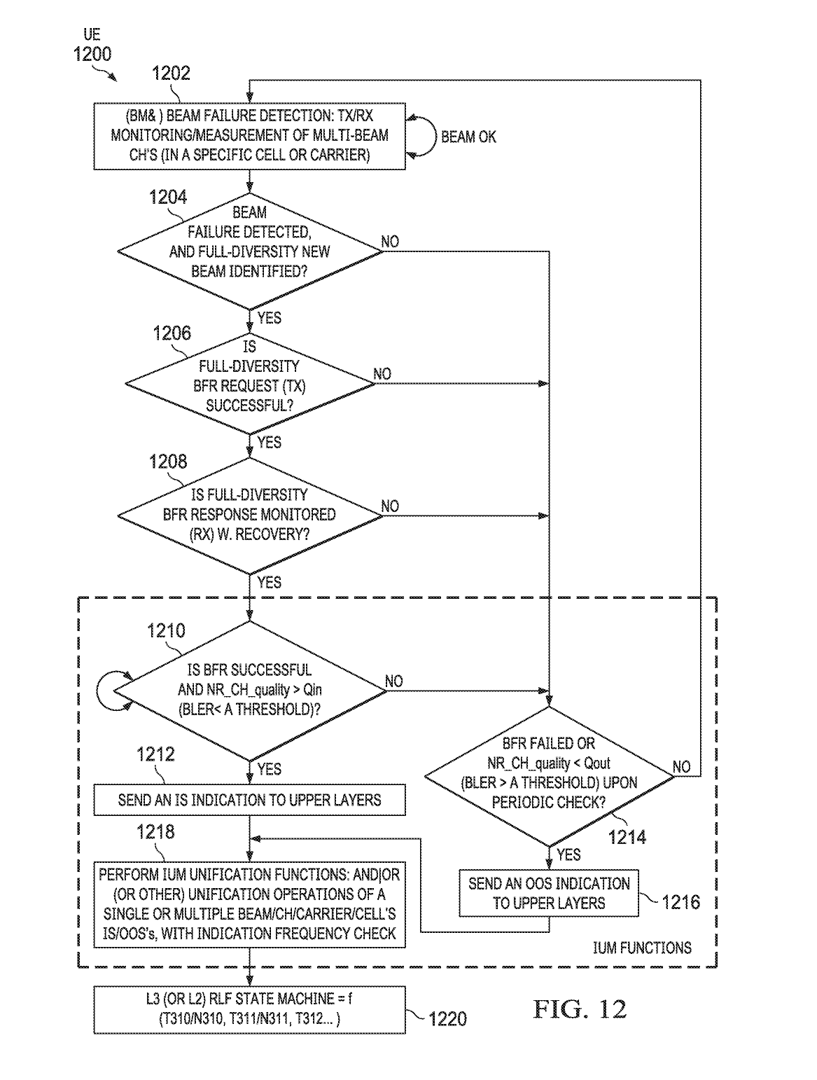

FIG. 12 illustrates a flowchart of an embodiment method 1200 or RLF detection. FIG. 12 illustrates a logic procedure for BFR operation process that enables detecting RLF at a UE in multi-beam communications. In this example, multi-beam measurement functions, which may reuse a multi-beam RLM measurements for NR, are performed to derive a serving channel quality metrics, i.e., NR_CH_quality. The quality metrics may be determined using beam consolidation or selection criteria that are used for the being standardized multi-beam RRM. The serving channel quality metrics may then be compared with thresholds, i.e., Qin and Qout, which may be network-configured for BFR and/or RLM. Based thereon, RLM-derived and/or BFR-generated IS and OOS indications are generated. A RLM-derived indication may generally refer to an indication generated based on metrics obtained using RLM criteria. A BFR-derived indication (or a BFR indication) may generally refer to an indication generated during a BFR process using BFR criteria. In one embodiment, based on multi-beam RLM measurements, RLM-derived IS or OOS indications may be combined with BFR-derived status indications (success or failure). In another embodiment, all indications are only based on BFR criteria, and include IS or OOS or BFR success or failure status. In this case, RLM measurements may be used as inputs to determine indications according to BFR criteria. In different embodiments, multi-beam RLM functions may be embedded in an (multi-beam) IUM as part of the IUM; The multi-beam RLM functions may also be performed by a (multi-beam) RLM module independent of the IUM or the BFR; IUM functions may be integrated in the RLM module.

IS and OSS indications may be generated in the multi-beam IUM or RLM or BFR module in a way similar to that in LTE. That is, an IS or OOS indication may be generated based on a hypothetical PDCCH that is mapped to link quality metrics, such as, NR₁₃ CH_quality (e.g., RSRQ in dB) in a lookup table, or based on direct comparison of the NR_CH_quality (e.g., RSRQ in dB, RSRP in dBm, or unit power in Watt) with a threshold (e.g., Qin or Qout). A hypothetical BLER of a PDCCH in NR BFR may be defined similarly to LTE. Generation of an IS or OOS indication may also be event-driven or timer-driven. For example, an OOS indication may be generated when the Criteria 1, 2 or 3 discussed above are satisfied, and an IS indication may be generated when the Criteria 4, 5 or 6 discussed above are satisfied. RLM-derived timer or event-driven IS and OOS indications may be unified with BFR-generated IS and OOS indications, and the link or BFR failure or success indications, in order to generate a unified stream of IS and OOS indications, which are then reported to a L3 RLF module.

In some embodiments, a NR_CH_quality may be defined as:

NR_CH_quality=average_of_(feasible or selected beams' quality, i.e., beams_of_quality_above_a_threshold)+offset (N).

A feasible beam refers to a beam that is available for a UE for reliable communication. The “feasible or reliable beams' quality” refers to quality metric of the beams being above the configured threshold. N may be a number of feasible beams that have beam quality above the threshold. N may be per-CH, per reference signal, per-carrier, per-cell, or across multiple CHs, carriers, or cells. All of the N feasible beams may be selected for link recovery operations. If none of the available beams have beam quality above the threshold, a best beam among the available beams or none of the beams may be selected. The offset(N) may be any non-decreasing discrete or continuous function of N. For example, the offset(N) may increase with N to reflect that multi-beam channel quality gets better when more (N) feasible beams are available. The average function used to calculate the NR_CH_quality may be implemented using any weighted sum of the feasible beams quality. The weighted sum of the feasible beams quality may be linear or non-linear functions of the feasible beams quality, e.g., linear sum of per-beam quality, and averaged by the selected number of beams (e.g., N). A per-beam quality metrics may be measured in Watt, dBm, or in dB. Measurement of per-beam quality metrics may be based on multiple signals, e.g., one or more RLM or RLF xSS and/or xRS. In one example, RSRP may be used as the NR_CH_quality. The NR_CH_quality may be compared with existing RLM or newly defined BFR thresholds (e.g., Qin or Qout) with or without mapping to BLER.

Steps in FIG. 12 may be viewed to correspond to operations in the layers on a UE side as illustrated in FIG. 10. The lower-layer or underlying BFR state machine triggers IS, OOS, link or BFR operation status (of success or failure) indications (corresponding to steps 1202, 1204, 1206, and 1208). An IUM may work independently or as a part of a multi-beam RLM module or RLF module, e.g., through a logical function, to unify (aperiodic or event-driven) BFR indications with (first and periodic) multi-beam RLM NR_CH_quality based indications (corresponding to steps 1210, 1212, 1214, 1216, 1218). The IS and OOS indications inputs to the IUM functions may be for multi-cell, per-cell, per multi-beam CH, per-beam, one or multiple xSSs or xRSs per beam, or a combination thereof. The unification of the indications may help speed up or generally optimize the upper layer RLF state machines (corresponding to step 1220), e.g., by influencing the IS and OOS counters or timers and RLF declaration.

In the embodiment method 1200 shown in FIG. 12, the exemplary (four) steps of the full diversity BFR process, as described above, are executed sequentially at steps 1202, 1204, 1206, and 1208. That is, the method 1200 performs the BFR process at steps 1202, 1204, 1206, and 1208. At step 1202, the method 1200 performs beam failure detection (and Beam Management) based on monitoring (and measurement) of serving beams of a target link in a cell or carrier. Step 1202 corresponds to Step 1 of the BFR process. At step 1204, the method 1200 determines whether a beam failure is detected, and upon the beam failure is detected, determines whether a new beam is identified as feasible by checking a plurality of communication paths. Step 1204 corresponds to Step 2 of the BFR process. The newly identified beam may be referred to as a “diversity” new beam. If there is a (serving) beam failure detected and at least one “diversity” new beam is identified, the method 1200 proceeds to step 1206, otherwise the method 1200 proceeds to step 1214. At step 1206, the method 1200 determines whether a full-diversity BFR request is transmitted successfully, i.e., whether the BFR request may be sent through any one of the diversity beam, or multiple diversity beams in combination, within a time or request retry count limit. Step 1206 corresponds to Step 3 of the BFR process. If the full-diversity BFR request (TX) is successful, the method 1200 proceeds to step 1208, otherwise, the method proceeds to step 1214. At step 1208, the method 120 determines whether a full-diversity BFR response is received in response to transmitting the full-diversity BFR request. If the full-diversity BFR response is received with recovery request acknowledgement, the method 1200 proceeds to step 1210, otherwise, the method 1200 proceeds to step 1214. Note in this embodiment, only one dimension of the diversity paths associated with the Step 3 (BFR request) is considered, excluding other diversity such as message format (RACH preamble or MAC CEs, etc.).

At step 1210, the method 1200, e.g., periodically, checks whether the BFR process is successful (i.e., all of the steps have succeeded within the time or count limits) and determines whether at least one selected path has NR_CH_quality >Qin (or BLER<an IS threshold). If the BFR process is successful and NR_CH_quality >Qin (or BLER<an IS threshold), the method 1200 proceeds to step 1212, and otherwise, the method 1200 proceeds to block 1214. At step 1212, the method 1200 sends an IS indication (which may be periodic or timer-based, aperiodic, or event-based) to the upper layer and the method 1200 moves to step 1218. In another embodiment, the IS indication may be generated independently of the BFR steps since failure detection. For example, the IS indication is timer or event-driven and reflects the signal quality of identified paths against some threshold. At step 1214, the method 1200 periodically determines whether the BFR process fail, or whether multi-beam NR_CH_quality<Qout (or BLER>an OOS threshold). If the BFR process fail, or multi-beam NR_CH_quality<Qout (or BLER>an OOS threshold), the method 1200 proceeds to step 1216, and otherwise, the method 1200 returns to step 1202. At step 1216, the method 1200 sends an OOS indication to an upper layer, and the method 1200 proceeds to step 1218. Likewise in another embodiment, the OOS indication may also be timer or event-driven in parallel to the BFR steps since failure detection. At step 1218, the method 1200 performs IUM unification functions, e.g., to generate unified indications. For example, the method 1200 may perform the IUM unification functions by applying logical operations, such as AND and/or OR, or other operations, on IS and OOS indications across a single or multiple beams, CHs, carriers and/or cells. The method 1200 may also perform indication frequency check (e.g., periodicity check). At step 1220, the method 1200 performs RLF functions, and updates the RLF state machine according to the unified indications. For example, the method 1200 may set timers and/or counters (e.g., T310, N310, T311, N311, or T312) for IS and OOS indications, similar to LTE. IUM enables a single stream of IS and OOS indications reported (periodically or aperiodically) to a RLF, and thus helps simplify the RLF state machine.

Note that the multi-beam function used in method 1200 (RLM or measurements) for calculating the link quality metrics, and comparing them against a threshold , can be similar to those in multi-beam RRM. However, parameters involved in method 1200 may be configured (e.g., by RRC configuration) differently than RRM. RLF state machine may be initialized (or reset) by a BFR success status in the method 1200.

In different embodiments, the method 1200 above may be revised to generate cell-level IS and OOS indications, which are only based on a control CH (e.g., using a hypothetical PDCCH BLER as in LTE), for multi- or single-beam communications. In this case, “cell” quality metrics may be determined by selection and consolidation of channel quality metrics among multiple cells.

In different embodiments, the method 1200 above may be adopted for failure recovery and RLF with a link defined across multiple beams, CHs, or cells. The IUM may be distributed or centralized at different layers. In other embodiments, one or more steps in method 1200 may vary. For example, the steps (i.e., 1202-1208) for performing the BFR process involved may be different. In one example, each BFR step at 1202-1208 when their logic check result is Yes may directly trigger a special (aperiodic) IS indication or a BFR success state indication sent to the IUM.

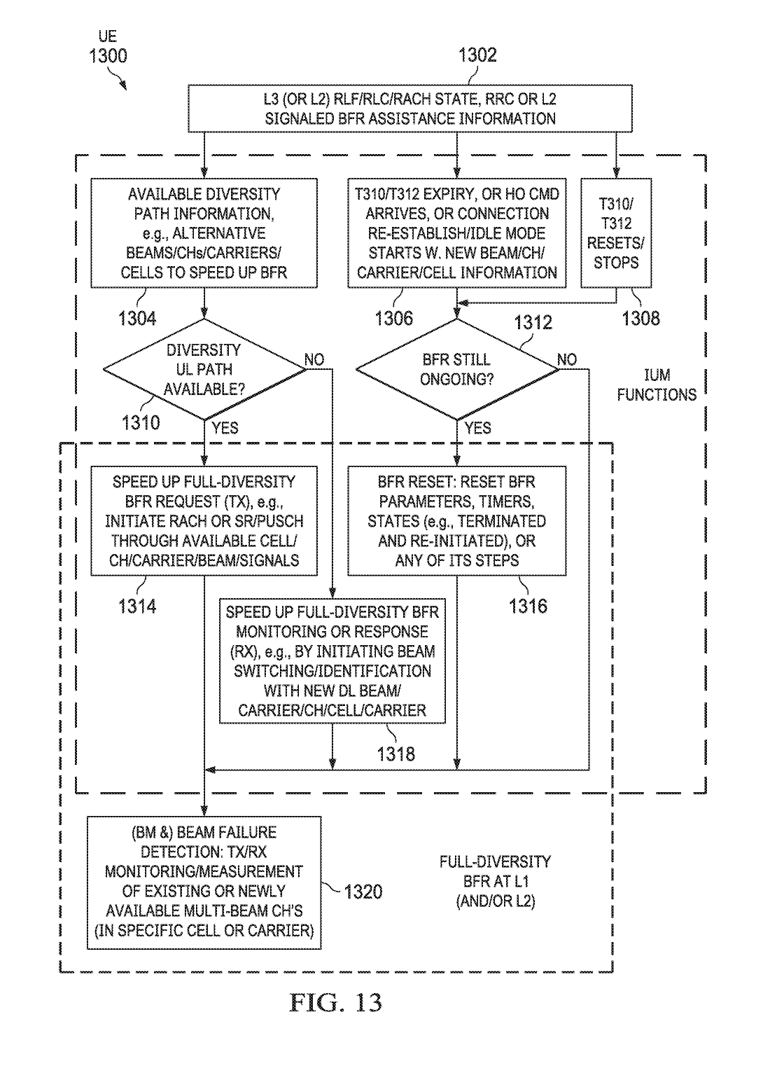

FIG. 13 illustrates a flowchart of another embodiment method 1300 for the interaction between RLF and BFR at a UE. The method 1300 may be viewed to correspond to operations in different layers on UE side as shown in FIG. 11. In this example, assistance information from upper-layers is used for optimizing the lower-layer BFR. The BFR process performed in the layer 1106 (corresponding to steps 1310, 1312, 1314, 1316, 1318, 1320) may be generally optimized based on assistance information provided by the upper layers (of RLF, RLC, HO state, or RRC signaling) (corresponding to steps 1302, 1304, 1306, 1308). Thus, the BFR process (including BFR state machine) in the layers 1106 and 1104 (corresponding to steps 1310-1320) may be sped up or early terminated based on the upper layer information.

The upper-layer assistance information may include the state information from multiple cells (e.g., PCells, PSCells, and/or SCells) or multiple carriers, available as alternative communication paths to accomplish RLC ARQ retransmission, RACH, RRC or L2 signaling, RLF timeout check (e.g., by independent T310 or T312), or HO signaling. The upper layer RLF timeout (by T310/T312) or HO command may trigger an early termination of the lower-layer BFR process, suggesting the BFR process may be not necessary any more. Others may help speed up the low-layer BFR process. As shown at step 1302, the UE in L3 (or L2) may use RLF state, RLC state, RACH state, or RRC or L2 signals as the BFR assistance information. Logical IUM in-between the upper layer (L3) and the lower layer (L1) may perform a variety of functions, including those illustrated at steps 1304, 1306, and 1308. Note that these functions may be considered logically as part of RLF functions, RLM functions, or BFR functions.

At step 1304, the method 1300 queries available diversity path information, e.g., defined by alternative beams, CHs, carriers and/or cells that are available to the UE. The diversity path information may be utilized to speed up the BFR process. At step 1306, the method 1300 checks upper-layer events, such as T310 or T312 (the T310 and T312 may be timers substantially similar to those timers defined in LTE) expiry, detection of a newly received HO command, connection reestablishment, or an idle mode, or the configuration or availability of a new beam, channel, carrier or cell. At step 1308, the method detects occurrence of events such as timer T310 or T312 being reset or stopped. The method 1300 obtains the upper-layer event information at steps 1302-1308. The information obtained at step 1306 and 1308 may be used to early terminate an ongoing BFR process. Whether a BFR process is ongoing may be determined at step 1312. The events monitored by IUM functions at steps 1304, 1306, and 1308 may occur simultaneously or at different time. At step 1310, the method 1300 determines whether there is a diversity UL path available. If there is a diversity UL path available, the method 1300 may speed up transmission of a diversity BFR request by initiating a RACH, a scheduling request (SR), and/or a PUSCH through the diversity UL path, instead of being blocked or delayed in the failing paths in the lower layer. The diversity UL path is an upper-layer notified alternative communication path (e.g., another cell, channel, carrier, beam or other signals). If a diversity UL path is not available as determined at step 1310, the method 1300 may speed up monitoring and receiving (DL) a diversity BFR response (RX) by initiating beam switching or identification with an alternative DL beam, carrier, channel, cell, or other signals at step 1318. This may be done because it is known by the upper layer from step 1310 that UL transmission is problematic. At step 1312, the method 1300 determines whether a BFR process is ongoing in the lower layer. If the BFR process is ongoing as determined at step 1312, at step 1316, the method 1300 resets the BFR process, which consequently resets BFR parameters, timers, and/or states (e.g., early termination and re-initiation of BFT state machine). After steps 1312, 1314, 1316, and 1318, the method 1300 may continue to perform beam failure detection at the physical layer at step 1320, e.g., by use of the upper-layer assistance information or upper-layer optimized BFT states.

In some embodiments, the assistance information used for helping performing a BFR process may include information obtained across all available beam links, across or based on one or multiple xSSs and/or xRSs, across different frequency carriers, e.g., as used in intra-cell CA, across multiple cells (e.g., a PCell, a PSCell, a SCell), e.g., as used in DC, CA or LF assisted HF, across one or more UL channels, DL channels or both, based on upper layer timeout event (e.g., RLF T310, or T321 expiry), and/or based on in-device or over-the-air (RLF) HO trigger, and other information that can be used to terminate the BFR process or reset parameters of the BFR process.

In different embodiments, the assistance information, that is used to help derive, speed-up, reset, or generally help a BFR process, may be based only on a control CH of a PCell or a PSCell (e.g., using hypothetical PDCCH BLER as used in LTE to detect a beam failure), or may be based on any available data CH (e.g., granted resources through semi-persistent scheduling (SPS) in a PUSCH or a PDSCH, a PUCCH, a RACH, a SR, or a MAC CE piggyback, etc.), or may be based on any detectable signals (e.g., a xSS or a xRS, including a DL SS-block, a CSI-RS, a DMRS, a UL sounding reference signal (SRS), etc.) .

In different embodiments, the method 1300 may be applied to serving or candidate beams, carriers, CHs, and/or cells. The IUM may be distributed or centralized at different layers. One or more steps in method 1300 may also vary. For example, the BFR steps involved may be different. Upper layer's indications (e.g., assistance information) may be used to assist a specific step of BFR in the BFR process, helping generally optimize the corresponding BFR operations.

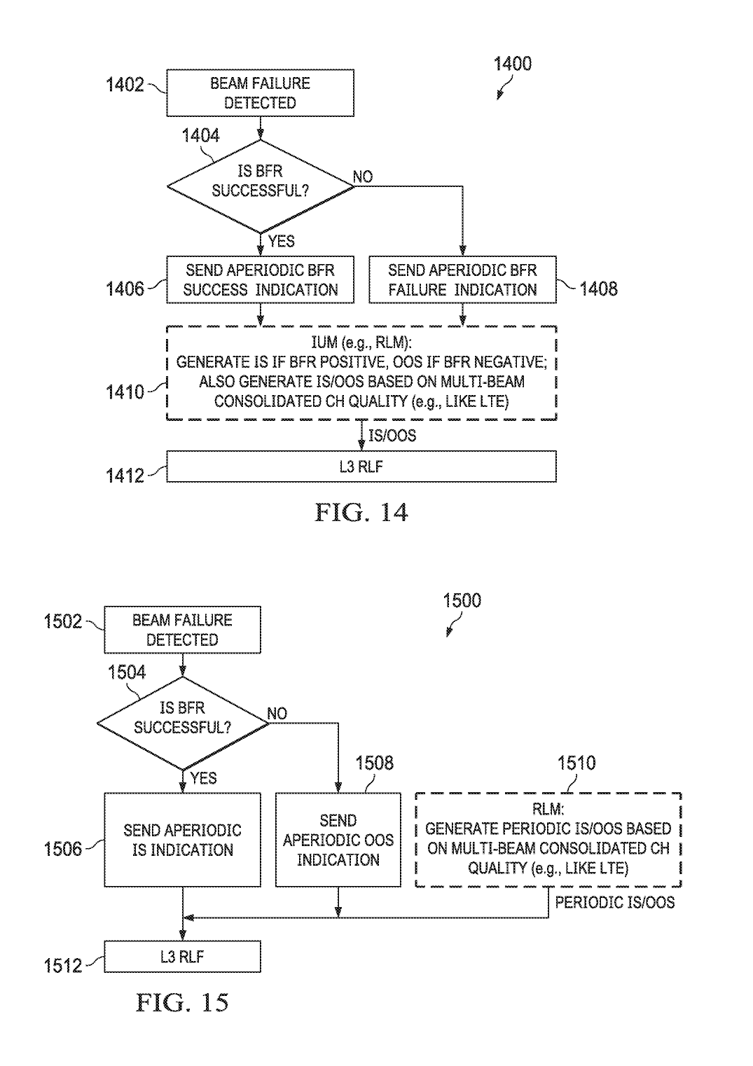

FIG. 14 illustrates a flowchart of an embodiment method 1400 for RLF detection at a UE. FIG. 14 illustrates interactions between a BFR module, a RLM module, and a RLF module. The RLM module, in this example, is configured to perform IUM functions of an IUM. That is, the IUM may be a part of the RLM module. The IUM, i.e., the RLM module, unifies or converts RLM-generated IS indications and OOS indications, and BFR-generated status (e.g., BFR success or failure) indications into a single stream of IS or OOS indications before sending the indications to the RLF module in L3. In this example, same xRS or xSS is used by the RLM module and the BFR module on the UE side. Steps 1402-1408 are performed by the BFR module. Step 1410 is performed by the IUM.

As shown, at step 1402, the method 1400 performs beam failure detection. If a beam failure has been detected at step 1402, the BFR module does not indicate anything to the upper layer until determination is made about whether a BFR process, performed by the BFR module to recover the beam failure, succeeds or fails. At step 1404, the method 1400 determines whether or not the BFR process is successful. If the BFR process is successful, at step 1406, the method 1400 may send a positive indication, e.g., an aperiodic BFR success indication, or a special or aperiodic IS indication, to the RLM module. If the BFR process fails, at step 1408, the method 1400 may send a negative indication, e.g., an aperiodic BFR failure indication or a special or aperiodic OOS indication to the RLM module.

The RLM module (having the IUM embedded) may, at step 1410, derive IS indications or OOS indications from the BFR success or failure indications received from the BFR module. Derivation of these IS indications or OOS indications may be decoupled from the RLM module's normal process, and the RLM module may derive a merged (unified) IS and OOS indication stream based solely on the multi-beam monitored (serving) channel quality. The RLM module may use the inputs, e.g., IS or OOS indications, at steps 1406 and 1408. Note that an aperiodic BFR (success or failure) indication sent at step 1406 or 1408 may trigger, or be converted to, or influence the successive or periodic (e.g., IS, OOS) indications at step 1410, by use of unification criteria defined previously. The RLM module may send the unified stream of IS and OOS indications to the L3 RLF module. At step 1412, the RLF module may determine whether a RLF is to be declared. The same RLF method as used in LTE may be performed by the RLF module for determining and declaring a RLF. In some embodiments, step 1410 may be implemented as part of the BFR module, i.e., integrated into the BFR module and performed at steps 1406 and 1408. In this case, the BFR module may influence or generate periodic IS and OOS indications (with or without aperiodic IS and OOS indications), and link or BFR success or failure status indications, and sends these indications directly to the RLF module.

FIG. 15 illustrates a flowchart of another embodiment method 1500 for RLF detection at a UE. FIG. 15 illustrates interactions between a BFR module, a RLM module, and a RLF module. In this example, RLM indications (e.g., first and periodic IS or OOS indications) and BFR indications (e.g., aperiodic IS or OOS indications) may be generated and sent in parallel to the L3 RLF module for further processing (corresponding to steps 1502, 1504, 1506, 1508 and 1510). Unification functions described above in an IUM are, in this example, a part of the RLF state machine. In another word, an IUM (not shown) may be integrated with the RLF, and the IUM passes whatever it has received from the BFR module directly to the L3 RLF module (at step 1512). In this example, the same xRS or SS, or different xRSs or SSs may be used by the RLM module (at step 1510) and the BFR module on the UE side.

As shown, at step 1502, the method 1500 performs beam failure detection. When a beam failure is detected, the BFR module may not indicate anything to the upper layer (i.e., L3) until determination is made about whether a BFR process, performed by the BFR module to recover the beam failure, succeeds or fails. At step 1504, the method 1500 determines whether or not the BFR process is successful. If the BFR process is successful, then the UE sends, from the BFR module, an aperiodic IS to the RLF module at step 1506. If the BFR process fails, at step 1508, the UE may send, from the BFR module, an aperiodic OOS indication to the RLF module. The BFR module sends IS and OOS indications directly to the L3 RLF module at steps 1506 and 1508, respectively, without passing through an IUM. In parallel, at step 1510, the method 1500 performs RLM functions at the RLM module, which may be an independent or decoupled module, and generates the first and periodic IS and OOS indications based on the multi-beam monitored (serving) channel quality, e.g., NR_CH_quality, as described above or as defined in LTE. The RLM module also sends the generated IS and OOS indications to the RLF module.

At step 1512, the method 1500 obtains, at the RLF module (with the embedded unification functions), and combines the IS and OOS indications from different sources (including, but not limited to, the BFR module, the RLM module, at steps 1506,1508, and 1510). At the RLF module, the obtained and combined IS and OOS indications may be processed the same as or similarly as processed in LTE, to determine whether a RLF is to be declared (e.g., by use of timers and counters N310, N311, T310, T311, T312, etc.). For example, an aperiodic OOS indication arriving in the middle of periodic IS indications may reset the count of N311 (hence delaying stop of T310). In another example, an aperiodic IS indication arriving in the middle of periodic OOS indications may reset the count of N310 (hence delaying start of T310). Note that processing of any of the elements illustrated in FIG. 15 may use different logic or mathematical operations in different embodiments.

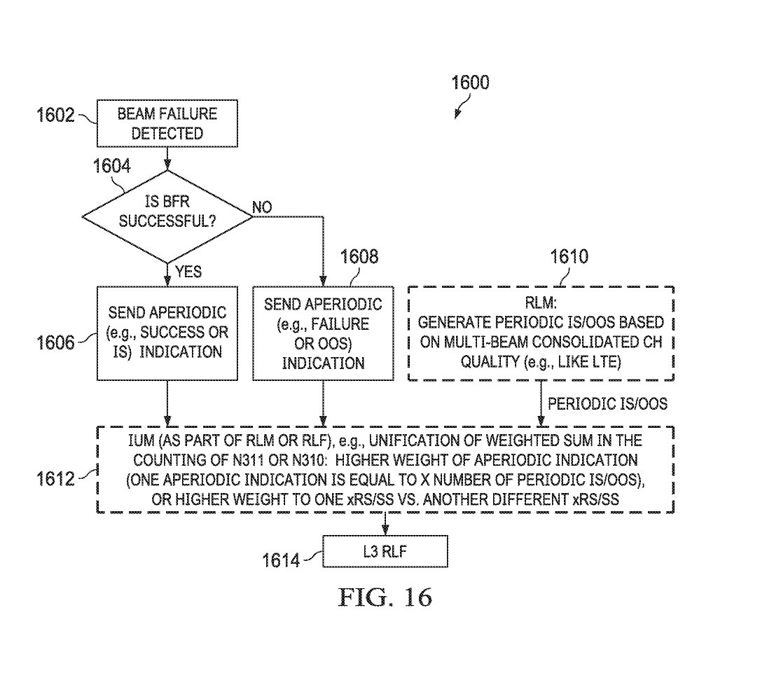

FIG. 16 illustrates a flowchart of another embodiment method 1600 for RLF detection at a UE. FIG. 16 illustrates interactions between a BFR module, a RLM module, an IUM, and a RLF module. In this example, RLM indications (e.g., first and periodic IS or OOS indications) and BFR indications (e.g., aperiodic IS or OOS indications, or BFR success or failure indications) may be generated and sent to the L3 RLF module through the IUM module. The IUM module may be part of the RLM module or the RLF module, or may be an independent module. The IUM may unify received indications in a weighted manner, e.g., based on types of the indications, source of the indications, and/or reference signals based on which the indications are generated. The same xRS or SS, or different xRSs or SSs may be used by the RLM module and the BFR module on the UE side. The IUM filters or unifies the indications from the RLM module and from the BFR module, either as part of the RLF module or as inputs to the RLF module. Steps 1602-1608 may correspond to operations performed by the BFR module, step 1610 may correspond to operations performed by the RLM module, step 1612 may correspond to operations performed by the IUM module, and step 1614 may correspond to operations performed by the RLF module.

As shown, at step 1602, the method 1600 performs beam failure detection at the BFR module. When a beam failure is detected, the BFR module may not indicate anything to the upper layer (i.e., L3) until determination is made about whether a BFR process, performed by the BFR module to recover the beam failure, succeeds or fails based on one or more xRSs and/or SSs configured. At step 1604, the method 1600 determines whether or not the BFR process is successful. If the BFR process is successful, then the UE sends, from the BFR module, an aperiodic IS to the RLF module at step 1606. If the BFR process fails, at step 1608, the UE may send, from the BFR module, an aperiodic OOS indication to the RLF module. The RLM module, independent or decoupled from the BFR module, derives, at step 1610, periodic IS and OOS indications based on the multi-beam monitored serving channel quality, like what is defined in multi-beam RLM, and based on one or more xRSs and/or SSs configured. The RLM module also sends the generated IS and OOS indications to the RLF module.

The IUM (or the RLF module in a case where the IUM is integrated with the RLF module), at step 1612, combines the IS and OOS indications from different sources (including, but not limited to, the BFR module, the RLM module, at steps 1606, 1608, and 1610). At the IUM module, the obtained and combined IS and OOS indications may be processed the same as or similarly as processed in LTE, to determine whether a RLF is to be declared (e.g., by use of timers and counters N310, N311, T310, T311, T312, etc.). In one example, the IUM (or the RLF module) may process indications that are generated based on different xRSs and/or SSs differently by use of weights (or priority). For example, a higher weight may be given to an indication generated based on an xRS or SS than another indication generated based on another xRS or SS. In another example, indications from different sources (e.g., the RLM module or the BFR module) may be processed by the IUM (or the RLF module) by use of different weights (or priority). A higher weight or an absolutely higher priority (e.g., in a strict prioritization method) may be given to aperiodic indications sent at steps 1606 and 1608 (i.e., by the BFR module) than RLM-generated periodic indications at step 1610 (i.e., by the RLM module). For example, one aperiodic indication (e.g., IS or OOS) may be equal to X number of periodic indications (e.g., IS or OOS). Note that equal weights means that the indications may be treated the same. That is, when equal weights are used, the indications will be considered with the same amount of weight for determining a RLF. In a case where the IUM is a part of the RLF module, the IUM may directly operate on N311, N310 or other relevant timers. Note that processing of the indications at the IUM may use any weighting methods that are applicable. Note that in different embodiments, the RLM module and the RLF module (and IUM) may be considered as a single module.

The embodiment methods and apparatus (e.g., IUM, RLF, RLM, and BFR) on the UE side may be embodied and applied to different scenarios with various details. In some embodiments, similar to LTE's RLM, the metrics (beam or link quality metrics) used herein, e.g., RSRP (or RSSI) or RSRQ (or SINR) per beam (in dBm, watts or dB), may be measured from beam specific xSS and/or xRSs. The metrics may be extended to single or multi-beam metrics for each CH, cell, or carrier. Multi-beam RLM and/or RLF with combination of multiple measured beam metrics may be used to derive a single RLM metrics. Beam or CH-specific RLM metrics may be used to derive beam, CH, or cell-specific IS and OOS indicators, using IS and OOS generation condition and IUM functions. Design of IUM, RLM, BFR, or RLF on the UE side may be mirrored to the network device (e.g., TRP, gNB, CU, or DU, etc.) side, with UL signal, beam, or CH based IUM, RLM, BFR, or RLF corresponding to DL signal, beam, or CH based IUM, RLM, BFR, or RLF. In different embodiments, the details in the embodiment methods above may be applied to serving or candidate beams, carriers, CHs, and/or cells. The IUM functions may be distributed or centralized at different layers. One or more elements or steps in the embodiment methods and in the framework design, e.g., NR_CH_quality, may also vary.

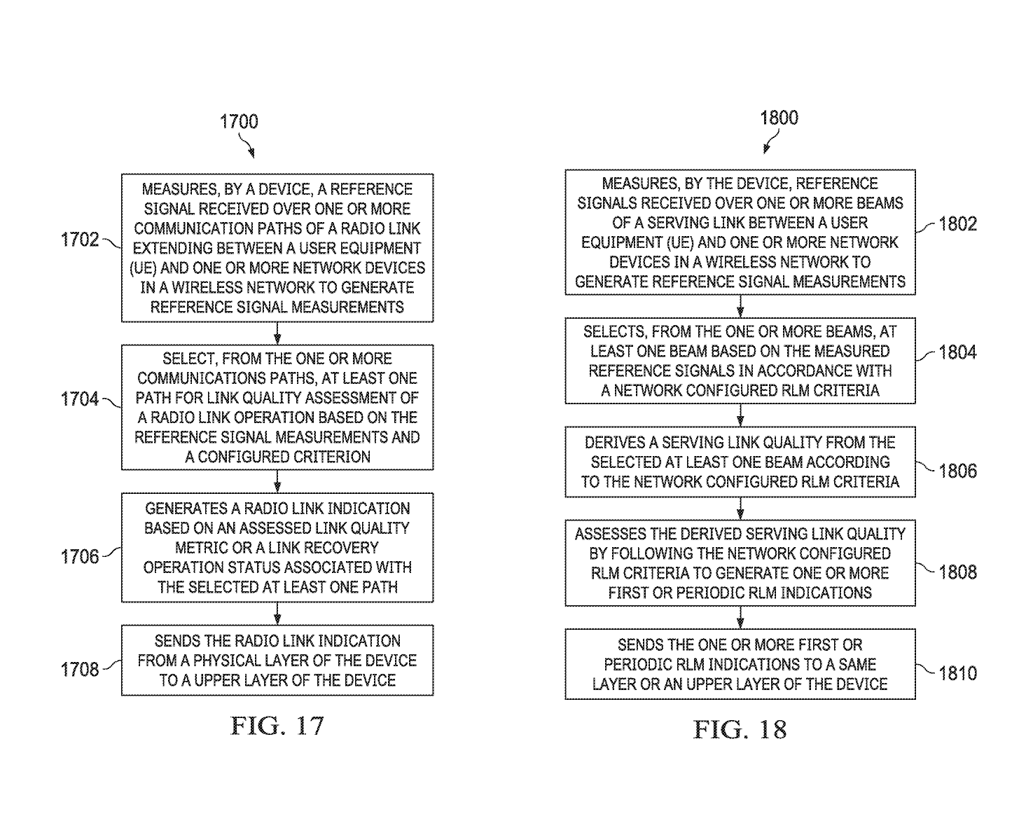

FIG. 17 illustrates a flowchart of an embodiment method 1700 for determining radio link recovery or beam failure recovery (BFR) indications in a device. As shown, at step 1702, the method 1700 measures, by a device, a reference signal received over one or more communication paths of a radio link extending between a user equipment (UE) and one or more network devices in a wireless network to generate reference signal measurements. The one or more communication paths are configured by the network. At step 1704, the method 1700 select, from the one or more communications paths, at least one path for link quality assessment of a radio link operation based on the reference signal measurements and a configured criterion. At step 1706, the method 1700 generates a radio link indication based on an assessed link quality metric or a link recovery operation status associated with the selected at least one path. At step 1708, the method 1700 sends the radio link indication from a physical layer of the device to an upper layer of the device.

FIG. 18 illustrates a flowchart of an embodiment method 1800 for radio link monitoring (RLM) in a device. As shown, at step 1802, the method 1800 measures, by the device, reference signals received over one or more beams of a serving link between a user equipment (UE) and one or more network devices in a wireless network to generate reference signal measurements. At step 1804, the method 1800 selects, from the one or more beams, at least one beam based on the measured reference signals in accordance with a network configured RLM criteria. At step 1806, the method 1800 derives a serving link quality from the selected at least one beam according to the network configured RLM criteria. At step 1808, the method 1800 assesses the derived serving link quality by following the network configured RLM criteria to generate one or more first or periodic RLM indications. At step 1810, the method 1800 sends the one or more first or periodic RLM indications to a same layer or an upper layer of the device.

In some embodiments, a method for determining beam failure recovery (BFR) indications in a user equipment (UE) means, comprising receiving and processing downlink (DL) reference signals from multiple beams at a physical layer, determining a beam quality metric for each of the multiple beams, evaluating the determined beam quality metrics of multiple diversity of physical-layer transmission paths (in terms of a separate beam, reference or synchronization signal, direction, carrier, data or control channel, cell) for executing BFR operations of signaling, beam identification, and beam failure recovery. In addition, the method further includes accomplishing the BFR operations by fully exploiting the diversities (of signaling options or communication paths) at the physical layer, e.g., under network configuration, or counter-, or timer-based constraints, during the BFR process, determining the finalized BFR operation status (success, failure), generating explicit BFR indications (an aperiodic IS corresponding to a BFR success, or an aperiodic OOS corresponding to a BFR failure, or an explicit BFR success or failure status) only when BFR operation status is final and sending the BFR indication(s) to the other module(s) (e.g., RLM or RLF).

In one embodiment, a method for detecting network radio (NR) radio link failure (RLF) in a user equipment (UE), that includes receiving an indication (where the indication may be the BFR generated (aperiodic) IS, OOS, or explicit BFR success/failure status indication, receiving the RLM generated (periodic) IS, OOS indication, receiving both indications in parallel), and unifying one or multiple of the received indication(s) for the detected radio link for a specific reference signal or beam or channel or carrier or cell, or across multiple of them. This method also includes sending the unified indication(s) to a RLF and utilizing the unified indication(s) to influence (e.g., speed up, delay, or optimize) the RLF state machine (N310, T310, N311, T311, T312, etc.) for fast and reliable RLF declaration.

In another embodiment, a method for detecting network radio (NR) radio link failure (RLF) in a user equipment (UE) is disclosed that includes receiving an indication, wherein the indication is at least one of a BFR generated IS, OOS, explicit BFR success/failure status indication; or a RLM generated (periodic) IS, OOS indication, unifying the received indication for the detected radio link, sending the unified indication(s) to a RLF; and utilizing the unified indication(s) to alter the RLF state machine. This method may be located at one of RLF, RLM, or BFR modules, or across them or different protocol layers, and wherein the BFR and RLM indications may be input into the method in parallel, or only through RLM after RLM-based procedural unification.

In yet another embodiment, a method for determining beam failure recovery (BFR) indications in a user equipment (UE) is disclosed that includes receiving and processing downlink (DL) reference signals from multiple beams at a physical layer, determining a beam quality metric for each of the multiple beams, evaluating the determined beam quality metrics of multiple diversity of physical-layer transmission paths (in terms of a separate beam, reference signal, synchronization signal, direction, carrier, data or control channel, cell, or any combination of them) for executing BFR operations of signaling, beam identification, and beam failure recovery, accomplishing the BFR operations by fully exploiting the diversities at the physical layer, e.g., under network configuration and timer-based constraints; during the BFR process, determining the finalized BFR operation status (success, failure), generating explicit BFR indications (an aperiodic IS corresponding to a BFR success, or an aperiodic OOS corresponding to a BFR failure, or an explicit BFR success or failure status) only when BFR operation status is final, and sending the BFR indication(s) to the other module(s) (e.g., RLM or RLF).

In yet another embodiment, a network device is disclosed that includes a receiver means for receiving an indication from at least one network device, wherein the indication is at least one of a BFR generated IS, OOS, explicit BFR success/failure status indication; a RLM generated IS, or an OOS indication; and a processor means that unifies the received indication for the detected radio link, sends the unified indication to a RLF, and to alter the RLF state machine based upon the indication.

Disclosed is a system and method for detecting new radio (NR) link failures and executing RLM and link failure recovery in network equipment, e.g., a user-side UE device (or a network-side device such as TRP or base stations). These systems and methods may include means for measuring over-the-air signals and considering over-the-air signaling and configuration messages to generating and receiving an in-device indication that can be at least one of a link failure recovery (e.g., BFR) generated periodic, event-driven or aperiodic status or indication; or a multi-beam RLM generated (first and periodic) IS, OOS indication. The systems and methods unify the received indication for the detected radio link utilizing the multi-beam RLM and full-diversity or multipath link failure recovery indication(s) for performance optimization.

Disclosed is a system and method for detecting network radio (NR) radio link failures (RLF) and its interactions with RLM and link failure recovery in network equipment, e.g., a user-side UE device (or a network-side device such as TRP or base stations). These systems and methods may include means for measuring over-the-air signals and considering over-the-air signaling and configuration messages to generating and receiving an in-device indication that can be at least one of a link failure recovery (e.g., BFR) generated (periodic, event-driven, or aperiodic) indications such as IS, OOS, or link recovery status(such as success, failure, newly identified beam, detected quality metrics) indication; or a multi-beam RLM generated (first and periodic) IS, OOS indication, or channel quality metrics; or converted indications of BFR to RLM-defined indications; or upper-layer RLF, RRC, RLC, or RACH generated downward indication(s) to optimize the lower-layer link recovery related operations. The systems and methods unify the received indication for the detected radio link utilizing the unified upwards indication(s) to alter the RLF state machine to improve its performance, or the unified downwards indication(s) to alter the BFR state machine for performance optimization.

The following embodiments are also provided.

Embodiment or claim 1. A method for detecting radio link failure (RLF) in a user equipment (UE), comprising: receiving at least one of the BFR generated (aperiodic) IS, OOS, or explicit BFR success/failure status indication, the RLM generated (periodic) IS, OOS indication, or both indications in parallel; and unifying one or multiple of the received indication(s) for the detected radio link over a specific communication path configured as a reference signal or beam or channel or carrier or cell, or combination of multiple of them; sending the unified indication(s) to a RLF; and utilizing the unified indication(s) to influence the change of the RLF state machine (N310, T310, N311, T311, T312, etc.) for fast and reliable RLF declaration.

Embodiment or claim 2. The method of claim 1, wherein the method is located at one of RLF, RLM, or BFR modules, or distributed across them or different protocol layers, and wherein the BFR and RLM indications may be input into the method in parallel, or only through RLM after RLM-based procedural unification.

Embodiment or claim 3. The method of claim 1, wherein a unified indication sent to RLF is solely based on the indication of whether BFR operations were a success or failure, or on BFR generated aperiodic IS or OOS indication, or on RLM generated periodic IS or OOS indication, or all of them.

Embodiment or claim 4. The method of claim 1, further comprising: producing a BFR operations command or a RLF status indication to the physical layer to change the BFR operations.

Embodiment or claim 5. The method according to claim 1, wherein the multiple beams comprises at least one of: multiple beams with a network device of the same or different reference signals, multiple beams on same or different frequency carriers, multiple beams of same or different directions, multiple beams of the same or different reference signals, multiple beams on same or different channels, multiple beams from different network devices in a same or different cells.

Embodiment or claim 6. The method according to claim 1, wherein the BFR indication includes at least one of beam-formed radio link, an indication of a serving channel of one or multiple beams, a reference signal of the beam, an indication of a component carrier, and identification of an associated cell.

Embodiment or claim 7. The method of claim 6, further comprising: producing a BFR operations command or a RLF status indication to the physical layer to change the BFR operations.

Embodiment or claim 8. The method according to claim 1, further comprising deriving carrier-level, channel-level, or cell-level channel quality based on the beam quality metric for each beam and of a specific reference signal.

Embodiment or claim 9. The method according to claim 8, further comprising the mathematical criteria to derive multi-beam channel quality metrics (filtered RSRP or SINR), a number of best beams selection policy to select the beams of quality above configurable thresholds, beam-specific filtering policy, and the criteria to compare with metrics thresholds or hypothetical BLER or their combination to derive and generate RLM In-Sync (IS) indication or out-of-sync (OOS) indications.

Embodiment or claim 10. The method according to claim 1, wherein the individual BFR indication is In-Sync (IS) indication, or out-of-sync (OOS) indication, or BFR status indications.

Embodiment or claim ii. The method according to claim 10, before the receiving from a physical layer, the individual beam failure recovery (BFR) indication for each of the multiple beam signals, the physical layer determines a BFR success/failure status.

Embodiment or claim 12. The method according to claim ii, further comprising: sending, by the physical layer, an aperiodic individual indication for a specific beam signal after the physical layer determines the BFR for the specific beam signal is success status, wherein the aperiodic individual indication is the IS or the BFR success indication.

Embodiment or claim 13. The method according to claim ii, further comprising: sending, by the physical layer, an aperiodic individual indication for a specific beam signal after the physical layer determines the BFR for the specific beam signal is success status, wherein the aperiodic individual indication is the OSS indication or the BFR failure indication.

Embodiment or claim 14. The method according to claim 1, further comprising: deriving, based on RLM indications and the unified BFR indications, a radio link (at beam-level, carrier-level, UL or DL directions, control or data channel-level, or cell-level) indications for a specific reference signal or for combination of multiple reference signals, wherein the radio link is at least one of at beam-level, at carrier-level, in UL direction or in DL directions, at control channel level or at data channel-level, or cell-level.

Embodiment or claim 15. The method according to claim 14, further comprising: combining the IS indication or the OOS indication or BFR indications by OR, AND, weighted sum, or any combination for the radio link corresponding to one or multiple beams, reference signals, carriers, directions, control or data channels, cells.

Embodiment or claim 16. The method according to claim 15, wherein the weight is defined for per-reference signal, for per-beam, for per-channel, for per-direction, for per-carrier, for per-cell, and the weight is a digital number or a linear scalar, the weight sum is linear or non-linear functions.

Embodiment or claim 17. The method according to claim 14, wherein the unifying the individual BFR indications comprises at least one of: determining a common out-of-sync (OOS) which indicates the common or cell-specific DL control channel that meets the OOS indication generation condition; determining a UE-specific OOS indication which indicates the UE-specific DL control channel that meets the OOS indication generation condition; determining a BFR failure status indicating either eventual BFR failure or stepwise failure, wherein the stepwise failure is out of the BFR process; determining a timer or event triggered OOS indication following a configured periodicity or aperiodic event trigger condition; and combining the above indications, and generating a unified OOS indication indicating a common link status.

Embodiment or claim 18. The method according to claim 14, wherein the unifying the individual BFR indications comprises at least one of: determining a common in-sync (IS) indication which indicates the common or cell-specific DL control channel that meets the IS generation condition; and determining a UE-specific IS indication which indicates the UE-specific DL control channel that meets the IS generation condition; and determining a BFR success status indicating BFR success; and determining a timer or event triggered IS indication following a configured periodicity or aperiodic event trigger condition, combining the above indications, and generating a unified IS indication indicating a common link status.

Embodiment or claim 19. The method according to any one of claims 1 to 18, wherein the unified BFR indications comprising at least one of: only the unified (periodic or aperiodic) IS or OOS; or only the (aperiodic) BFR status indication; or only the eventual BFR success status indication; or both the eventual and the stepwise (out of the BFR process) BFR success indication; or only the eventual BFR failure status indication; or both the eventual and the stepwise (out of the BFR process) BFR failure indication; or both the unified IS and OOS, and the eventual BFR success or failure status indication.

Embodiment or claim 20. The method according to claim 1, further comprising: receiving a radio resource control (RRC) configuration signal; determining indications of BFR or RLM at physical layer by following the RRC configuration; and influencing the upper layer RLF state machine (counters, timers, state transitions) based on the indications at configured (beam, reference signal, channel, carrier, direction, or cell) level; and; determining a RLF status at the configured cell or link level of a single or multiple beams.

Embodiment or claim 21. The method according to claim 1, wherein the method further comprising: receiving a radio resource control (RRC) signal; determining an available communication path at RLF or RRC layer based on the RRC signal, wherein the path connects the UE and the network over a specific (UL or DL) direction, cell, carrier, channel, reference signal, or their combinations; and indicating to BFR the availability of the path; and influencing the BFR state machine by redirecting or speeding up a BFR requesting through the path as an alternative to the failed path of the radio link.

Embodiment or claim 22. The method according to claim 1, further comprising: learning RLF, RLC, RACH, or handover status at upper layer; indicating to BFR the status; and influencing the BFR state machine by optimizing, speeding up, or early terminating the BFR process.

Embodiment or claim 23. The method according to claim 1, wherein the receiving from a physical layer, unifying the individual BFR indication(s) and sending the unified BFR indication, is performed by a module of functions at the physical layer, or a module at the second layer(s) or a module at the third layer, or by them jointly.

Embodiment or claim 24 The method of claim 1, wherein the unification may convert a BFR success status indication into one or multiple IS(s) and failure status into OOS(s), before providing them to RLF.

Embodiment or claim 25. The method of claim, wherein the influence of RLF state machine is based on unified indications that are combined across different paths of the link by logic or mathematical summarization of them.

Embodiment or claim 26. A method for determining beam failure recovery (BFR) indications in a user equipment (UE), comprising: receiving and processing downlink (DL) reference signal(s) from multiple beams; at the physical layer, determining a beam quality metric for each of the multiple beams; evaluating the determined beam quality metrics of multiple diversity of physical-layer transmission paths in terms of a separate beam, reference or synchronization signal, direction, carrier, data or control channel, cell, or any combination thereof for executing BFR operations of signaling, new beam identification, or beam failure recovery, accomplishing the BFR operations by fully exploiting the diversities at the physical layer of the radio link between the UE and the network by network configuration(s), or under counter or timer-based constraints; during the BFR process, determining the finalized BFR operation status including success or failure; generating explicit BFR indications, including an aperiodic IS corresponding to a BFR success, or an aperiodic OOS corresponding to a BFR failure, or an explicit BFR success or failure status, only when BFR operation status is final; sending the BFR indication(s) to the other module(s).

Embodiment or claim 27. A method for determining Radio Link Monitoring (RLM) indications in a user equipment (UE), comprising: receiving and processing configured downlink (DL) reference signal(s) from multiple beams for a serving link; at a physical layer, determining a signal quality metric for each of the multiple paths based on beams or signals; evaluating the determined signal quality metrics based on network configured RLM criteria, including beam-specific metrics filtering, X best beam(s) selection based on filtered metrics and configured thresholds, or derivation of a unique serving link metrics from multiple selected beams according to the configured method and specific reference signal, carrier, channel, or cell; evaluating the derived serving radio link metrics by configured RLM criteria (RSRP or RSRQ or SINR or control channel BLER versus thresholds) to generate periodic (IS, OOS) indication(s), sending the RLM indication(s) to the other module(s).

Embodiment or claim 28. A method for detecting radio link failure (RLF) in a user equipment (UE), comprising: receiving an indication, wherein the indication is at least one of a BFR generated IS, OOS, explicit BFR success or failure status, or a RLM generated (periodic) IS or OOS indication; unifying the received indication(s) from BFR, RLM, or multiple paths of each for the detected radio link; sending the unified indication(s) to a RLF; and utilizing the unified indication(s) to alter the RLF state machine.

Embodiment or claim 29. The method of claim 28, wherein the unification function may be located at one of RLF, RLM, or BFR modules, or distributed across them or different protocol layers, and wherein the BFR and RLM generated indications may be parallel inputs of the unification functions or RLF, or input to them only through RLM after RLM-based procedural unification.

Embodiment or claim 30. The method of claim 29 wherein a unified indication sent to RLF is solely based on the indication of whether BFR operations were a success or failure, or on BFR generated aperiodic IS or OOS indication, or on RLM generated periodic IS or OOS indication, or any combinations of them.

Embodiment or claim 31. The method of claim 28, further comprising: producing a BFR operations command or a RLF status indication to the physical layer to change the BFR operations.

Embodiment or claim 32. A network device comprising: a receiver means for receiving an indication from at least one of physical layer communication paths in the same network device, wherein the indication is at least one of a BFR generated IS, OOS, explicit BFR success or failure status indication, or a RLM generated IS or OOS indication; and a processor means that unifies the received indication(s) for the detected radio link failure or failure recovery operations, sends the unified indication to a RLF, or alter the RLF state machine based upon the indication.

Embodiment or claim 33. The device of claim 32 wherein the unification method may be located at one of RLF, RLM, or BFR modules, or distributed across them or different protocol layers, and wherein the BFR and RLM indications may be input into the method in parallel, or only through RLM after RLM-based procedural unification

Embodiment or claim 34. The method of claim 33 wherein a unified indication sent to RLF is solely based on the indication of whether BFR operations were a success or failure, or on BFR generated IS or OOS indication, or on RLM generated IS or OOS indication, or any combinations of them.

Embodiment or claim 35. The method of claim 32, further comprising: producing a BFR operations command or a RLF status indication to the physical layer to influence the BFR operations.

Embodiment or claim 36. A method for determining beam failure recovery (BFR) indications in a user equipment (UE), comprising: receiving and processing downlink (DL) reference signals from multiple beams; determining a beam quality metric for each of the multiple beams; evaluating the determined beam quality metrics of multiple diversity of physical-layer transmission paths (in terms of a separate beam, direction, carrier, data or control channel, cell) for executing BFR operations of signaling, beam identification, and beam failure recovery; accomplishing the BFR operations by fully exploiting the diversities at the physical layer under network configuration and timer-based constraints; during the BFR process, determining the final BFR operation status (success, failure); generating explicit BFR indications (including an IS corresponding to a BFR success, or an OOS corresponding to a BFR failure, or an explicit BFR success or failure status) only when BFR operation status is final; and sending the BFR indication(s) to the other module(s) including RLM or BFR.

Embodiment or claim 37. The method of claim 36 wherein BFR sends nothing in the middle of its process, but only the final indication after it is determined.

Embodiment or claim 38. A method for determining Radio Link Monitoring (RLM) indications in a user equipment (UE), comprising: receiving and processing downlink (DL) reference signals from multiple beams; and determining a beam quality metric for each of the multiple beams; and evaluating the determined beam quality metrics based on network configured multi-beam RLM criteria, including beam-specific metrics filtering, X best beam(s) selection based on filtered metrics versus configured thresholds, derive a unique serving link metrics from multiple selected beams according to the configured method and specific reference signal, carrier, channel, or cell; and evaluating the derived serving radio link metrics by following configured RLM criteria (comparing RSRP or RSRQ or SINR or control channel BLER versus thresholds) to generate the first or periodic (IS, OOS) indication(s); and sending the RLM indication(s) to the other module(s).

Embodiment or claim 39. A method for detecting radio link failure (RLF) in a user equipment (UE), comprising: receiving the BFR generated IS, OOS, or explicit BFR success or failure status indication; or receiving the RLM generated IS or OOS indication; or receiving both indications in parallel; or receiving only from RLM indications that may be generated by BFR but processed by RLM; and unifying one or multiple of the received indication(s) for the detected radio link utilizing a specific reference signal or beam or channel or carrier or cell, or combining multiple of them; and sending the unified indication(s) to a RLF; and utilizing the (unified) indication(s) to influence the change of the RLF state machine for fast or reliable RLF declaration.

Embodiment or claim 40. The method of claim 39 wherein multi-beam RLM operations and RLM indication generations are part of RLF, or vice versa.

Embodiment or claim 41. The method of claim 39 wherein the unification method may be located at one of RLF, RLM, or BFR modules, or distributed across them or different protocol layers, and wherein the BFR and RLM indications may be input into the unification method in parallel, or only through RLM after RLM-based processing or procedural unification

Embodiment or claim 42. The method of claim 39 wherein a unified indication sent to RLF is solely based on the indication of whether BFR operations were a success or failure, or on BFR generated (IS or OOS) indication, or on RLM generated (IS or OOS) indication, or multiple of them.

Embodiment or claim 43. The method of claim 39, further comprising: producing a BFR operations command or a RLF or RLC or RRC or RLM status indication from upper layers to the physical layer to change the BFR operations.

Embodiment or claim 44. The method according to claim 36 or claim 38 or claim 39, wherein the multiple beams comprise at least one of below: multiple beams with a network device of the same or different reference signals, multiple beams on same or different frequency carriers, multiple beams of same or different (DL or UL) directions, multiple beams of the same or different reference signals, multiple beams on same or different channels, multiple beams from same or different network devices in a same or different cell.

Embodiment or claim 45. The method according to claim 39, wherein the BFR indication refers to at least one beam-formed radio link, a serving link or channel of one or multiple beams, a reference signal of the beam, a component carrier, and an associated base station or cell.

Embodiment or claim 46. The method according to claim 39, further comprising detecting link quality by deriving carrier-level, channel-level, or cell-level link quality metric based on the beam quality metric of a single or multiple beam(s) and of a specific reference signal.

Embodiment or claim 47. The method according to claim 46, further comprising multi-beam RLM (IS or OOS) indication operations.

Embodiment or claim 48. The method according to claim 39, wherein the individual BFR indication refers to In-Sync (IS) indication, or out-of-sync (OOS) indication, or BFR success or failure status indication.

Embodiment or claim 49. The method according to claim 48, the individual BFR indication for each of the multiple beamformed signals is generated only after the physical layer determines a final BFR success or failure status.

Embodiment or claim 50. The method according to claim 39, wherein the BFR indications are periodic, aperiodic, or event-driven based on BFR or Beam Management events.

Embodiment or claim 51. The method of claim 39, further comprising converting a BFR success status indication into one or multiple RLM IS(s), converting the failure status into one or multiple RLM OOS(s), or use BFR IS, OOS to replace or be counted as one or multiple RLM's IS or OOS, or treat a BFR IS or OOS indication as a RLM indication but with special weights wherein an aperiodic IS or OOS may be given higher weight than RLM generated periodic IS or OOS, or use BFR aperiodic indications (IS, OOS, success or failure) to change the periodic RLM IS or OOS indications, or use the BFR success or failure status to change RLM state machine (IS or OOS generation) to change RLM's IS or OOS periodicity or their starting time.

Embodiment or claim 52. The method according to claim 39, further comprising a unification method that: combines the (converted or not) IS indications from the same source (RLM or BFR) and corresponding to the same reference signal and radio link by logic (OR or AND) operations or mathematical summarization such as weighted sum (count) across one or multiple beams, carriers, directions, control or data channels, cells. Same to the combination of the (converted or not) OOS indications.

Embodiment or claim 53. The method of claim 39, wherein the unification method combines the (converted or not) indications from different sources (RLM or BFR) or corresponding to different reference signals or beams or carriers or channels or cells of the same link by logic (AND or OR) operations or mathematical operations, such as weighted summarization counting periodic IS from RLM plus aperiodic IS from BFR in a weighted manner but following the same RLF timer and counter, etc., and similarly to OOS.

Embodiment or claim 54. The method according to claim 52 or 53, wherein the weight is defined for per-reference signal, for per-beam, for per-channel, for per-direction, for per-carrier, or for per-cell, and the weight is a digital number or a linear scalar, the weight sum is a linear or non-linear function.

Embodiment or claim 55. The method according to claim 39, 52 or 53, wherein the unification process of the individual BFR indication(s) comprises at least one of, for a configured or a targeted radio link: determining a common out-of-sync (OOS) which indicates the common or cell-specific DL control channel that meets the OOS indication generation condition; determining a UE-specific OOS indication which indicates the UE-specific DL control channel that meets the OOS indication generation condition; determining a BFR failure status indicating either eventual BFR failure or stepwise failure, wherein the stepwise failure is out of the BFR process; determining a timer or event triggered OOS indication following a configured periodicity or aperiodic event trigger condition; and combining the above indications, and generating a unified OOS indication indicating a common link status for the radio link.

Embodiment or claim 56. The method according to any of claim 39, 52 or 53, wherein the unification processing of the individual BFR indication(s) comprises at least one of, for a configured or a targeted radio link: determining a common in-sync (IS) indication which indicates the common or cell-specific DL control channel that meets the IS generation condition; determining a UE-specific IS indication which indicates the UE-specific DL control channel that meets the IS generation condition; determining a BFR success status indicating BFR success; determining a timer or event triggered IS indication following a configured periodicity or aperiodic event trigger condition; and combining the above indications, and generating a unified IS indication indicating a common link status for the radio link.

Embodiment or claim 57. The method according to any one of claims 1 to 56, wherein the unified BFR indications comprising at least one of: only the periodic or aperiodic IS or OOS; only the aperiodic BFR status indication; only the eventual BFR success status indication; both the eventual and the stepwise (out of the BFR process) BFR success indication; only the eventual BFR failure status indication; both the eventual and the stepwise (out of the BFR process) BFR failure indication; or both the IS and OOS, and the eventual BFR success or failure status indication.

Embodiment or claim 58. The method according to any of claims 1 to 57, further comprising configuration methods of at least one of below: receiving a radio resource control (RRC) configuration signal; determining what or how indications of BFR or RLM are generated, used, or unified by following the radio link configuration by the RRC signal; deciding the unification method and parameters according to the configuration; deciding the filtering criteria and parameters and (IS or OOS) indication generation approach for the multi-beam RLM according to the configuration; deciding the upwards and downwards mutual indications between RLF and BFR, and their parallel or cascaded processing relationship with RLM according to the configuration; influencing the BFR state machine (including counters or timers) by the indications based on the configured upper level (RRC, RLC, RLF, RLM, RACH, etc.) status or events; influencing the RLF state machine (including counters or timers) based on the indications at the configured (beam, reference signal, channel, carrier, direction, or cell) level; and determining a RLF status at the configured (cell or link) level of configured (single or Y number of multiple) beams.

Embodiment or claim 59. The method according to claim 43, wherein the method further comprising: receiving a radio resource control (RRC) signal; determining an available (UL or DL) path at RLF or RRC layer; indicating to BFR the availability of the path; and influencing the BFR state machine with optimization by redirecting or speeding up a BFR requesting through the path as an alternative.

Embodiment or claim 60. The method according to claim 39, further comprising: learning RLF, RLC, RACH, or handover status at upper layer; indicating to lower layer the status; and influencing the BFR state machine by optimizing BFR process with speedup or early termination of its states, steps, timers, or counters.

Embodiment or claim 61. The method according to claim 39, wherein the receiving indications from a physical or MAC layer, unifying the individual BFR indications with or without RLM indications, sending the unified (BFR or RLM) indication, or forwarding received indications as is, is performed by a functional module in the physical layer, or a module in the second layer (for MAC), or a module in the third layer (for RLF or RRC), or them jointly.

Embodiment or claim 62. The method of claim 39, wherein the unified indications may be utilized to influence the RLF state machine by optimizing or speeding up RLF declaration or state transition or early termination of a state, reset or stop a timer, reset or stop a counter.

Embodiment or claim 63. The method of any of claims 1-62, wherein the methods related to UE can be mirrored and designed similarly and accordingly to the network devices.

Embodiment or claim 64. A method for determining radio link recovery or beam failure recovery (BFR) indications in a user equipment (UE), comprising: receiving and measuring downlink reference signal(s) associated with multiple communication paths of the radio link between the UE and the network, wherein each path is configured to be of a specific beam pair, (UL or DL) direction, reference signal, channel, carrier, or cell, or their different combinations; evaluating the measured signal quality based on configurations to select one or multiple path(s) for link recovery, or link quality assessment; executing link recovery operations based on configuration or under counter or timer-based constrains, by considering selected path(s) and the link quality, wherein the operations include (UL or DL) signaling, link failure detection, new beam identification, link failure recovery request transmission or response monitoring; generating link recovery indication(s) according to the link recovery operation status to indicate the connectivity status, a success, or a failure of link recovery operations; and sending the link recovery indication(s) from physical layer to an upper layer.

Embodiment or claim 65. The method of claim 64, wherein the link recovery status and corresponding indications can be generated stepwise at any step during the link recovery operation process.

Embodiment or claim 66. The method of claim 64, wherein the link recovery indicates nothing in the middle of its process, but only a final indication after results of all steps of the configured, counter or timer-based link recovery operation status are determined by the physical layer.

Embodiment or claim 67. The method of any of claims 64-66, wherein the success of link recovery is final only if ALL steps in the link recovery process have succeeded under a configuration, or a counter or timer-based constraint, and wherein the failure of link recovery is final if there is a failure of ANY step in the process under a counter or timer-based constraint.

Embodiment or claim 68. The method of claim 64, wherein the signal quality evaluated for executing link recovery operation or assessing link quality based only on a specific reference signal or a serving control channel.

Embodiment or claim 69. The method of any of claims 64-68, wherein the signal quality metrics may be evaluated for executing link recovery operation or assessing link quality (RSRP, RSRQ, RSSI) from multiple configured paths by moving average, weighted sum, or threshold comparison of the metrics; or selecting a recovery (UL or DL) path by configuration or by multi-path metrics comparison against thresholds or against each other.

Embodiment or claim 70. The method according to claim 64, further comprising assessing link quality by deriving carrier-level, channel-level, or cell-level link quality metric based on a single or multiple beam(s) and of a specific reference signal.

Embodiment or claim 71. The method according to claim 64 or 70, wherein the criteria for assessing a serving link by considering multiple paths or selecting a path can be configured as below: filtering the metric of individual path, selecting one for multiple path(s) based on the threshold comparison or metric ranking, deriving a single link quality metric by combining the selected paths by mathematical methods such as a weighted summarization, or assessing the link quality by comparing the derived metric against a threshold.

Embodiment or claim 72. The method according to claim 64, wherein the link failure recovery indication refers to at least one beam (pair), a serving channel of one or multiple beams, a reference signal of the beam, a component carrier, and identification of an associated base station or cell.

Embodiment or claim 73. The method of any of claims 64-72, wherein by considering configured multiple paths (for diversity exploitation), the link failure detection may be accomplished when ALL the reference (SSB, DM-RS, SRS, and CSI-RS) signal metrics of the serving channel drop below a threshold over a configured time period; wherein the link failure recovery may be accomplished when ANY of the (reference (SSB, DM-RS, or CSI-RS) signal metrics of the serving channel exceeds a threshold over a configured time period.

Embodiment or claim 74. The method of claim 64, wherein the link recovery indication is configured as periodic, aperiodic, or event-driven; and wherein the aperiodic indication corresponds to a link recovery success, or a link recovery failure; the periodic or event-driven indications refer to at least one of below: identified beam IDs, measured signal strength, or assessed serving link quality, connectivity status of the selected (beam) path or serving link according to configured criteria, stepwise link recovery success or failure under configuration or a counter or timer-based constraint, or the final success or failure of the whole link recovery process.

Embodiment or claim 75. The method according to claim 64 or 74, wherein the link connectivity status refers to a (IS or OOS) indication based on a configured criterion including comparing the quality metrics against a threshold for a specific path of the link, or a combined indication of multiple paths for the same link by logic (OR or AND) operations.

Embodiment or claim 76. A method for Radio Link Monitoring (RLM) in a user equipment (UE), comprising: receiving and measuring downlink (DL) reference signals from multiple beams of a serving link; and evaluating the measured signal quality metrics based on network configured RLM criteria, including beam-specific metrics filtering, X best beam(s) selection based on filtered metrics above configured thresholds; deriving a unique serving link quality metrics from multiple beams according to the configured method and for a specific reference signal, carrier, channel, or cell; assessing the derived serving link metrics by following configured RLM criteria to generate the first or periodic RLM indication(s); and sending the RLM indication(s) to other functional module(s).

Embodiment or claim 77. The method of any claim of 64, 71, or 76, wherein the configured derivation or assessment of serving link metrics include filtering such as weighted sum or moving average, or SINR-to-BLER table lookup of multiple beam-specific signal metrics.

Embodiment or claim 78. The method of claim 76, wherein the configured RLM criteria for deriving RLM indications may include comparing RSRP, RSRQ, RSSI, SINR, or control channel BLER versus a threshold.

Embodiment or claim 79. The method of any of claims 76-78, wherein the RLM indication(s) include beam-specific signal metrics (RSRP, RSRQ, RSSI, SINR), multi-beam combined link metrics, RLM criteria generated In-Sync (IS) or Out-Of-Sync (OOS).

Embodiment or claim 80. The method of claims 76, wherein the RLM indications including signal metrics or link metrics may be utilized by the link recovery operations such as beam or link failure detection, or new beam identification.

Embodiment or claim 81. The method of claim 64 or claim 76, wherein the RLM and link recovery operations may work independently.

Embodiment or claim 82. The method of claim 64 or claim 77, wherein the multiple beams comprise at least one of: multiple beams with a network device of the same or different reference signals, multiple beams on same or different frequency carriers, multiple beams of same or different (DL or UL) directions, multiple beams of the same or different reference signals, multiple beams on same or different channels, multiple beams from same or different network devices in a same or different cells, on a same or different RATs, or any combination of them.

Embodiment or claim 83. The method according to claim 64 or 77, wherein the weight is configured for per-reference signal, for per-beam, for per-channel, for per-direction, for per-carrier, or for per-cell, and the weight is a digital number or a linear scalar, the weight sum is linear or non-linear functions.

Embodiment or claim 84. The method according to any of claims 64-83, further comprising configuration methods of at least one of below: receiving a radio resource control (RRC) configuration signal; determining what or how indications of link recovery or RLM are generated, used, or multi-path considered (diversity exploited) by following the radio link configuration or by the RRC signal; deciding the multipath consideration (diversity exploitation) method and parameters; deciding the filtering criteria and parameters and IS or OOS indication generation approach for the multi-beam RLM and multi-path link recovery; deciding the upwards and downwards mutual indications between RLM and link recovery (in parallel or cascaded processing) relationship; influencing the change of link recovery state machine based on the indications based on the configured upper level status or events.

Embodiment or claim 85. The method of any of claims 64-84, wherein the methods related to UE can be mirrored or designed similarly and accordingly for the network devices.

Embodiment or claim 86. A method for detecting radio link failure (RLF) in a user equipment (UE), comprising: receiving the physical layer link recovery operations generated single or multiple-path link recovery indication(s) or link quality states according to upper layer configurations, wherein the indication may be periodic, aperiodic, or event-driven, and a path refers to a communication path of a specific reference signal, beam, data or control channel, cell, carrier, etc.; or receiving the RLM generated first and periodic (IS or OOS) indication, wherein the RLM considers single or multiple serving paths; or considering both received indications in parallel; or receiving only from RLM indications that may be generated by the link recovery but processed by RLM; detecting radio link failure and assessing link quality according to configurations of a specific path or across multiple paths; unifying one or multiple of the received indication(s) according to configuration(s); utilizing the indication(s) to influence the change of the RLF state machine with control parameters for RLF declaration, wherein the influence is to speed up, delay, or optimize the RLF state machine, its state transition, its parameters, or early termination of a state reset or early stop of timers, reset or stop counters, etc., and wherein the parameters include RLF counters and timers such as N310, T310, N311, T311, T312, etc.

Embodiment or claim 87. The method of claim 86, wherein the link recovery indications include an aperiodic indication corresponding to a link recovery success; or an aperiodic indication corresponding to a link recovery failure; or a periodic or event-based link recovery status that refers to at least one of the following: failure detection instance, identified new beams, measured reference signal strength or control or data channel quality, feasibility or connectivity status of the identified beam path according to a configured criteria, stepwise success or failure under a counter or timer based constraint, and final success or failure of the whole link recovery process.

Embodiment or claim 88. The method of claim 86, wherein the RLM operations and RLM indication generations are part of RLF, or the RLM operations are part of link recovery operations, or both.

Embodiment or claim 89. The method of claim 86 wherein the unification method may be located at one of RLF, RLM, or link recovery modules or distributed across them, or distributed across different protocol layers or multiple paths, and wherein the link recovery and RLM indications may be input into the RLF in parallel, or only through RLM after RLM-based processing.

Embodiment or claim 90. The method of claim 86 wherein a unified indication sent to RLF is solely based on the indication of whether link recovery operations were a success or failure, or on link recovery generated link status indication, or on RLM generated periodic (IS or OOS) indication, or multiple of them.

Embodiment or claim 91. The method of claim 86, further comprising: producing a link recovery operations configuration command or a RLF or RLC or handover or RACH status indication from upper layers to the physical layer to influence the change of the link recovery operations, wherein the configuration command may refer to a report request, multiple path configuration; or parameter configuration request of the link recovery from upper layer to physical layer, wherein the request may refer to beam reporting in link recovery, wherein the parameters may refer to specific reference signals or transmission paths, timers or counters, or number of newly identified beams and its metrics thresholds.

Embodiment or claim 92. The method according to claim 86, wherein the multiple paths may further refer to at least one of: multiple beams with a network device of the same or different reference signals, multiple beams on same or different frequency carriers, multiple beams of the same or different downlink and uplink directions, multiple beams of the same or different reference signals, multiple beams on same or different channels, multiple beams from same or different network devices in a same or different cells, on a same or different RATs, or any combination of them.

Embodiment or claim 93. The method according to claim 86, wherein the link recovery or RLM indication refers to at least one communication path corresponding to one beam-(paired link), a serving data or control (e.g., a PDCCH) channel of one or multiple beams, a reference signal (CSI-RS or SSB or SRS or DM-RS) of the beam, a component carrier, and an associated base station or cell; wherein the unification method may consider only a single path corresponding to a single reference signal, beam, channel, carrier, or cell, or any of their combination.

Embodiment or claim 94. The method according to claim 86, further comprising assessing a link quality by deriving carrier-level, channel-level, or cell-level link quality metric based on the measured radio quality metric of a single or multiple beam(s) and of a specific or multiple reference signal(s).

Embodiment or claim 95. The method according to claim 86, further comprising the detection operations by RLM channel measurement, beam failure detection or new beam identification in link recovery operations, or independent or shared or combined operations of them.

Embodiment or claim 96. The method according to any one of claims 86 to 95, wherein by configuration the RLM or link recovery indications comprising at least one of: only the periodic or aperiodic link connectivity status (IS or OOS); or only the aperiodic link recovery status indication; or only the eventual link recovery success status indication; or both the eventual and the stepwise BFR success indication, wherein each steps is out of the link recovery process; or only the eventual BFR failure status indication; or both the eventual and the stepwise link recovery failure indication; or both the IS and OOS, and the eventual link recovery success or failure status indication.

Embodiment or claim 97. The method of claim 86, wherein by configuration the unification method may consider the received indications as direct inputs, or convert a link recovery success status indication into one or multiple IS(s), or convert the failure status into one or multiple OOS(s), or use link recovery generated link connectivity (IS or OOS) indication to replace or be counted as one or multiple RLM generated IS or OOS, or treat a link recovery aperiodic IS or OOS indication as a RLM indication but with special weights, or use link recovery indications (IS or OOS or success and failure) to influence the change of the periodic RLM IS or OOS indications, or use the link recovery success or failure status to influence the change of RLM state machine.

Embodiment or claim 98. The method of claim 97, wherein a link recovery generated indication may be given the same or different weight than RLM generated periodic indication (IS or OOS) in upper layer unification or RLF based counting process, and wherein the link recovery indications influences the change of the RLM indications or RLM state machines by triggering, stopping, or resetting any of the state machine parameters, such as the RLM indication generation, report periodicity, report starting points, etc.

Embodiment or claim 99. The method according to claim 86, wherein the unification method may be configured to: combine or select or filter the IS indications from the same or different sources of RLM or link recovery by logic (AND or OR) or mathematical operations, and assess the radio link quality corresponding to the same or different reference signals or beams or alternative paths; filter or combine or select the assessed radio link quality metrics by mathematical summarization such as weighted sum or moving average of one or multiple beams, signals, carriers, directions, control or data channels, cells. Same to the combination of OOS indications.

Embodiment or claim wo. The method of claim 86, wherein the unification method may further comprise counting indications from RLM and from link recovery in a weighted manner but against the same RLF timer and counter, or combining them by logic OR (for IS's) or AND (for OOS's) of RLM and link recovery generated indications.

Embodiment or claim 101. The method according to any claim of 97 to wo, wherein the weight is configured for per-reference signal, for per-beam, for per-channel, for per-direction, for per-carrier, or for per-cell, and the weight is a digital number or a linear scalar, and the weight sum is linear or non-linear functions.

Embodiment or claim 102. The method according to any of claims 86-101, wherein by configuration the unification of the serving link recovery or RLM indications comprises at least one of, for a serving link: determining a common out-of-sync (OOS) which indicates the common or cell-specific DL channel that meets the OOS indication generation condition; determining a UE-specific or dedicated OOS indication which indicates the UE-specific DL channel that meets the OOS indication generation condition; determining a link recovery failure status indicating either eventual link recovery failure or stepwise failure, wherein the stepwise failure is out of the link recovery process; determining a timer or event triggered OOS indication following a configured periodicity or aperiodic event trigger condition; and combining the above indications, and generating a unified OOS indication indicating a common link status for the radio link; and the same unification applies to IS too.

Embodiment or claim 103. A method of radio link failure (RLF) in a user equipment (UE), comprising by configuration: learning RLF, RLC, RACH or handover status at upper layer; indicating to lower layer the upper layer status; and influencing the link recovery state machine by optimizing link recovery process with speedup or early termination of its states, steps, timers, or counters.

Embodiment or claim 104. The method according to any of claims 86 to 103, further comprising configuration methods of at least one of below: receiving a radio resource control (RRC) or MAC CE or physical-layer configuration signal; determining what or how indications of link recovery or RLM are generated, used, or unified; deciding the unification and multiple path combination of the multipath metrics or (RLM and link recovery) indications; deciding the filtering criteria and parameters and (IS or OOS) indication generation approach for the multi-beam RLM; deciding the upwards and downwards mutual indications between RLF and link recovery, and their parallel or cascaded processing relationship with RLM unifying or processing link recovery indications before forwarding them; influencing the link recovery state machine (counters, timers, state transitions) based on the indications based on the configured upper level (RRC, RLC, RLF, RLM, RACH, etc.) status or events; influencing the RLF state machine (counters, timers, state transitions) based on the indications at the configured (beam, reference signal, channel, carrier, direction, or cell) level; determining a RLF status at the configured (cell or link) level for configured single or Y number of multiple beams; and determining an available alternative path after link failure, including an uplink or downlink path, reserved or contention-based RACH resources, at a different carrier or channel or cell, at RLF or RRC layer; and indicating to link recovery the availability of an alternative path; and influencing the BFR state machine with optimization, including redirecting or speeding up a BFR requesting through the path as an alternative.

Embodiment or claim 105. The method of any of claims 86-104, wherein the methods related to UE can be mirrored or designed similarly and accordingly for the network devices.

The following embodiments are also provided.

1. A method for radio link failure operations, the method comprising: measuring, by a user equipment (UE), a reference signal received over one or more network-configured communication paths of a radio link extending between the user UE and one or more network devices in a wireless network; receiving at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the UE; unifying at least the first network-configured indication and the second network-configured indication according to a network configuration to obtain a unified network-configured indication; and performing a radio link failure operation according to the unified network-configured indication.

2. The method of claim 1, wherein the first network-configured indication and the second network-configured indication are unified at the RLF module, a radio link monitoring (RLM) module, or a beam failure recovery (BFR) or link recovery (LR) (BFR/LR) module.

3. The method of any of claim 1 or 2, wherein the first network-configured indication and the second network-configured indication are unified in a distributed manner across different protocol layers.

4. The method of any of claims 1 to 3, wherein the first network-configured indication and the second network-configured indication are unified in a distributed manner across multiple paths.

5. The method of any of claims 1 to 4, wherein the network configuration requires that the first network-configured indication and the second network-configured indication are used as direct inputs to the radio link failure operation.

6. The method of any of claims 1 to 4, wherein the network configuration requires that the first network-configured indication and the second network-configured indication are used as inputs to the radio link failure operation only after unification of the first network-configured indication and the second network-configured indication.

7. The method of any of claims 1 to 6, wherein the network configuration requires that a link recovery success status indication is converted into one or multiple in-sync (IS) indications or a link recovery failure indication is converted into one or multiple out-of-sync (OOS) indications.

8. The method of any of claims 1 to 7, wherein the network configuration requires that a link recovery operation generated link connectivity indication is replaced with one or more in-sync (IS) indications or out-of-sync (OOS) indications.

9. The method of any of claims 1 to 8, wherein the network configuration requires that a link recovery in-sync (IS) indication or out-of-sync (OOS) indication is treated as a weighted RLM indication in the unification, the weight being a digital number or a linear scalar.

10. The method of any of claims 1 to 9, wherein the network configuration requires that one or more BFR/LR generated in-sync (IS) indications or out-of-sync (OOS) indications are used to modify periodic RLM IS or OOS indications or to modify an RLF state machine.

11. The method of any of claims 1 to 10, wherein unifying the first network-configured indication and the second network-configured indication further comprises: combining or filtering at least the first network-configured indication and the second network-configured indication using logic or mathematical operations, or combining or filtering the assessed radio link quality over a mathematical summation of multiple paths or over a moving-average of any specific path, and assessing the combined or filtered radio link quality corresponding to a configured criterion.

12. The method of any of claims 1 to 11, further comprising the network configuration for: determining filtering and combination parameters for link quality states over the one or more network-configured communication paths, the RLM module, the BFR/LR module; or determining filtering and combination parameters for the one or more network-configured indications based on configuration(s) of the RLM module, the BFR/LR module, the one or more network-configured communication paths, or combinations thereof, wherein performing the radio link failure operation according to the one or more network-configured indications and the network configuration comprises filtering or combining the one or more network-configured indications in accordance with the filtering and combination parameters.

13. The method of any of claims 1 to 12, further comprising: selecting a location of unification operations at the RLF module, the RLM module, the BFR/LR module; selecting an application of the unification operations to a specific one of the one or more network-configured communication paths; selecting a module or path for sending the unified indications to the RLF module after performance of the RLM or BFR/LR operation; determining whether the one or more network-configured indications are to be reported in series or parallel by a specific one of the RLF module or the BFR/LR module; or configuring parameters of an RLF state machine based on the one or more network-configured indications.

14. A user equipment (UE) comprising: a processor; and a non-transitory computer readable storage medium storing programming for execution by the processor, the programming including instructions to: measure a reference signal received over one or more network-configured communication paths of a radio link extending between a user equipment (UE) and one or more network devices in a wireless network; receive at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the UE; and unify the first network-configured indication and the second network-configured indication according to the network configuration.

15. The UE of claim 14, wherein the first network-configured indication and the second network-configured indication are unified at the RLF module, a radio link monitoring (RLM) module, or a beam failure recovery (BFR) or link recovery (LR) (BFR/LR) module.

16. The UE of any of claim 14 or 15, wherein the first network-configured indication and the second network-configured indication are unified in a distributed manner across different protocol layers.

17. The UE of any of claims 14 to 16, wherein the first network-configured indication and the second network-configured indication are unified in a distributed manner across multiple paths.

18. The UE of any of claims 14 to 17, wherein the network configuration requires that the first network-configured indication and the second network-configured indication are used as direct inputs to a radio link failure operation.

19. The UE of any of claims 14 to 18, wherein the network configuration requires that the first network-configured indication and the second network-configured indication are used as inputs to a radio link failure operation only after unification of the first network-configured indication and the second network-configured indication.

20. The UE of any of claims 14 to 19, wherein the network configuration requires that a link recovery success status indication is converted into one or multiple in-sync (IS) indications or a link recovery failure indication is converted into one or multiple out-of-sync (OOS) indications.

21. The UE of any of claims 14 to 20, wherein the network configuration requires that a link recovery operation generated link connectivity indication is replaced with one or more in-sync (IS) indications or out-of-sync (OOS) indications.

22. The UE of any of claims 14 to 21, wherein the network configuration requires that a link recovery in-sync (IS) indication or out-of-sync (OOS) indication is treated as a weighted RLM indication, the weight being a digital number or a linear scalar.

23. A method for radio link failure operations, the method comprising: measuring, by a network device, a reference signal received over one or more network-configured communication paths of a radio link extending between the network device and one or more user equipments (UEs) in a wireless network; receiving at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the network device; unifying at least the first network-configured indication and the second network-configured indication according to a network configuration to obtain a unified network-configured indication; and performing a radio link failure operation according to the unified network-configured indication.

24. A network device comprising: a processor; and a non-transitory computer readable storage medium storing programming for execution by the processor, the programming including instructions to: measure, by a network device, a reference signal received over one or more network-configured communication paths of a radio link extending between the network device and one or more user equipments (UEs) in a wireless network; receive at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the network device; unify at least the first network-configured indication and the second network-configured indication according to a network configuration to obtain a unified network-configured indication; and perform a radio link failure operation according to the unified network-configured indication.

25. A method for radio link failure (RLF) operations, comprising: sending, by an RLF module in a device, an RLF status message indicating an RLF, radio resource control (RRC), radio link control (RLC), random access channel (RACH), sounding, or handover states to either a radio link monitoring (RLM) module or a beam failure recovery (BFR) or link recovery (LR) (BFR/LR) module of the device, wherein the RLF status message instructs the RLM module or the BFR/LR module to modify an RLM or BFR/LR operation according to the RLF, RRC, RLC, RACH, sounding, or handover states of a user equipment (UE), the device being either the UE or a network device serving the UE.

26. The method of claim 25, wherein the device is the network device.

27. The method of claim 25, wherein the device is the UE.

28. The method of claim 25, further comprising: determining which path, including an uplink or downlink path, reserved or contention-based RACH resources, are considered to obtain the RLF, RRC, RLC, RACH, sounding, or handover states; indicating to RLF module the availability of an alternative path at upper layer; determining what messages are generated by the RLF module to indicate to the lower layers; and determining how to optimize the BFR/LR module or RLM state machine based the upper level messages.

29. A device comprising: a processor; and a non-transitory computer readable storage medium storing programming for execution by the processor, the programming including instructions to: send, by an radio link failure (RLF) module in the device, an RLF status message indicating an RLF, radio resource control (RRC), radio link control (RLC), random access channel (RACH), sounding, or handover states to either a radio link monitoring (RLM) module of the device or a beam failure recovery (BFR) or link recovery (LR) (BFR/LR) module of the device, wherein the RLF status message instructs the RLM module or the BFR/LR module to modify an RLM or BFR/LR operation according to the RLF, RRC, RLC, RACH, sounding, or handover states of a user equipment (UE), the device being either the UE or a network device serving the UE.

30. A method comprising: receiving a radio link failure (RLF) status message from an RLF module of a device at either a radio link monitoring (RLM) module or a beam failure recovery (BFR) or link recovery (LR) (BFR/LR) module of the device, the RLF status message indicating an RLF, radio resource control (RRC), radio link control (RLC), random access channel (RACH), sounding, or handover states of a user equipment, the device being either the UE or a network device serving the UE; and performing, by the RLM module or the BFR/LR module, an RLM or BFR/LR operation according to the RLF, RRC, RLC, RACH, sounding, or handover states.

31. A device comprising: a processor; and a non-transitory computer readable storage medium storing programming for execution by the processor, the programming including instructions to: receive a radio link failure (RLF) status message from an RLF module of a device at either a radio link monitoring (RLM) module or a beam failure recovery (BFR) or link recovery (LR) (BFR/LR) module of the device, the RLF status message indicating an RLF, radio resource control (RRC), radio link control (RLC), random access channel (RACH), or RACH, sounding, handover status of a user equipment, the device being either the UE or a network device serving the UE; and perform, by the RLM module or the BFR/LR module, an RLM or BFR/LR operation according to the RLF, RRC, RLC, RACH, sounding, or handover states.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a unifying unit/module, a monitoring unit/module, a measuring unit/module, a reporting unit/module, a resetting unit/module, a determining unit/module, a detecting unit/module, a searching unit/module, a selecting unit/module, a timing unit/module, a counting unit/module, a generating unit/module, a deriving unit/module, a link failure detection unit/module, a beam failure detection unit/module, a beam failure recovery (BFR) unit/module, an integration and unification unit/module, a radio link monitoring (RLM) unit/module, a radio link failure (RLF) detection unit/module, a comparing unit/module, a combining unit/module, an indicating unit/module, an evaluating unit/module, a weighting unit/module, a RLF declaring unit/module, and/or a setting unit/module. The respective units/modules may be hardware, software, or a combination thereof. For instance, one or more of the units/modules may be an integrated circuit, such as field programmable gate arrays (FPGAs) or application-specific integrated circuits (ASICs).

The following references are related to subject matter of the present application. Each of these references is incorporated herein by reference in its entirety.
3GPP TS 36.133-d8o, V13.8.0, “Requirements for support of radio resource management”, June 2017.
3GPP 36.300-e30, V14.3.0, “E-UTRAN Overall description”, June 2017.

Although the present disclosure has been described with reference to specific features and embodiments thereof, it is evident that various modifications and combinations can be made thereto without departing from scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. A method for radio link failure operations, the method comprising:
measuring, by a user equipment (UE), a reference signal received over one or more network-configured communication paths of a radio link extending between the user UE and one or more network devices in a wireless network;
receiving at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the UE;
unifying at least the first network-configured indication and the second network-configured indication according to a network configuration to obtain a unified network-configured indication; and
performing a radio link failure operation according to the unified network-configured indication.

2. The method of claim 1, wherein the first network-configured indication and the second network-configured indication are unified at the RLF module, the RLM module, or the BFR/LR module.

3. The method of claim 1, wherein the first network-configured indication and the second network-configured indication are unified in a distributed manner across different protocol layers.

4. The method of claim 1, wherein the first network-configured indication and the second network-configured indication are unified in a distributed manner across multiple paths.

5. The method of claim 1, wherein the network configuration requires that the first network-configured indication and the second network-configured indication are used as direct inputs to the radio link failure operation.

6. The method of claim 1, wherein the network configuration requires that the first network-configured indication and the second network- configured indication are used as inputs to the radio link failure operation only after unification of the first network-configured indication and the second network-configured indication.

7. The method of claim 1, wherein the network configuration requires that a link recovery success status indication is converted into one or multiple in-sync (IS) indications or a link recovery failure indication is converted into one or multiple out-of-sync (OOS) indications.

8. The method of claim 1, wherein the network configuration requires that a link recovery operation generated link connectivity indication is replaced with one or more in-sync (IS) indications or out-of-sync (OOS) indications.

9. The method of claim 1, wherein the network configuration requires that a link recovery in-sync (IS) indication or out-of-sync (OOS) indication is treated as a weighted RLM indication in unifying at least the first network-configured indication and the second network-configured indication, a weight used being a digital number or a linear scalar.

10. The method of claim 1, wherein the network configuration requires that one or more BFR/LR generated in-sync (IS) indications or out-of-sync (OOS) indications are used to modify periodic RLM IS or OOS indications or to modify an RLF state machine.

11. The method of claim 1, wherein unifying the first network-configured indication and the second network-configured indication further comprises:
combining or filtering at least the first network-configured indication and the second network-configured indication using logic or mathematical operations, or
combining or filtering the assessed radio link quality over a mathematical summation of multiple paths or over a moving-average of any specific path, and assessing the combined or filtered radio link quality corresponding to a configured criterion.

12. The method of claim 1, further comprising the network configuration for:
determining filtering and combination parameters for link quality states over the one or more network-configured communication paths, the RLM module, or the BFR/LR module; or
determining filtering and combination parameters for one or more network-configured indications based on configuration(s) of the RLM module, the BFR/LR module, the one or more network-configured communication paths, or combinations thereof,
wherein performing the radio link failure operation according to the one or more network-configured indications and the network configuration comprises filtering or combining the one or more network-configured indications in accordance with the filtering and combination parameters.

13. The method of claim 1, further comprising:
selecting a location of unification operations at the RLF module, the RLM module, the BFR/LR module;
selecting an application of the unification operations to a specific one of the one or more network-configured communication paths;
selecting a module or path for sending the unified network-configured indication to the RLF module after performance of the RLM or BFR/LR operation;
determining whether one or more network-configured indications are to be reported in series or parallel by a specific one of the RLF module or the BFR/LR module; or configuring parameters of an RLF state machine based on the one or more network-configured indications.

14. A user equipment (UE) comprising:
a processor; and
a non-transitory computer readable storage medium storing programming for execution by the processor, the programming including instructions to:
measure a reference signal received over one or more network-configured communication paths of a radio link extending between a user equipment (UE) and one or more network devices in a wireless network;
receive at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the UE; and
unify the first network-configured indication and the second network-configured indication according to a network configuration.

15. The UE of claim 14, wherein the first network-configured indication and the second network-configured indication are unified at the RLF module, the RLM module, or the BFR/LR module.

16. The UE of claim 14, wherein the first network-configured indication and the second network-configured indication are unified in a distributed manner across different protocol layers.

17. The UE of claim 14, wherein the first network-configured indication and the second network-configured indication are unified in a distributed manner across multiple paths.

18. The UE of claim 14, wherein the network configuration requires that the first network-configured indication and the second network-configured indication are used as direct inputs to a radio link failure operation.

19. The UE of claim 14, wherein the network configuration requires that the first network-configured indication and the second network-configured indication are used as inputs to a radio link failure operation only after unification of the first network-configured indication and the second network-configured indication.

20. The UE of claim 14, wherein the network configuration requires that a link recovery success status indication is converted into one or multiple in-sync (IS) indications or a link recovery failure indication is converted into one or multiple out-of-sync (OOS) indications.

21. The UE of claim 14, wherein the network configuration requires that a link recovery operation generated link connectivity indication is replaced with one or more in-sync (IS) indications or out-of-sync (OOS) indications.

22. The UE of claim 14, wherein the network configuration requires that a link recovery in-sync (IS) indication or out-of-sync (OOS) indication is treated as a weighted RLM indication, a weight used in the weighted RLM indication being a digital number or a linear scalar.

23. A method for radio link failure operations, the method comprising:
measuring, by a network device, a reference signal received over one or more network-configured communication paths of a radio link extending between the network device and one or more user equipments (UEs) in a wireless network;
receiving at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the network device;
unifying at least the first network-configured indication and the second network-configured indication according to a network configuration to obtain a unified network-configured indication; and
performing a radio link failure operation according to the unified network-configured indication.

24. A network device comprising:
a processor; and
a non-transitory computer readable storage medium storing programming for execution by the processor, the programming including instructions to:
measure, by a network device, a reference signal received over one or more network-configured communication paths of a radio link extending between the network device and one or more user equipments (UEs) in a wireless network;
receive at least a first network-configured indication and a second network-configured indication over different paths or from different modules at a radio link failure (RLF) module, a radio link monitoring (RLM) module, or a beam failure recovery (BFR) or link recovery (LR) (BFR/LR) module of the network device;
unify at least the first network-configured indication and the second network-configured indication according to a network configuration to obtain a unified network-configured indication; and
perform a radio link failure operation according to the unified network-configured indication.

25. A method for radio link failure (RLF) operations, comprising:
sending, by an RLF module in a device, an RLF status message indicating an RLF, radio resource control (RRC), radio link control (RLC), random access channel (RACH), sounding, or handover states to either a radio link monitoring (RLM) module or a beam failure recovery (BFR) or link recovery (LR) (BFR/LR) module of the device, wherein the RLF status message instructs the RLM module or the BFR/LR module to modify an RLM or BFR/LR operation according to the RLF, RRC, RLC, RACH, sounding, or handover states of a user equipment (UE), the device being either the UE or a network device serving the UE.

26. The method of claim 25, wherein the device is the network device.

27. The method of claim 25, wherein the device is the UE.

28. The method of claim 25, further comprising:
determining which path, including an uplink or downlink path, reserved or contention-based RACH resources, are considered to obtain the RLF, RRC, RLC, RACH, sounding, or handover states;
indicating to RLF module availability of an alternative path at upper layer;
determining what messages are generated by the RLF module to indicate to lower layers; and
determining how to optimize the BFR/LR module or RLM state machine based upper level messages.

29. A device comprising:
a processor; and
a non-transitory computer readable storage medium storing programming for execution by the processor, the programming including instructions to:
send, by an radio link failure (RLF) module in the device, an RLF status message indicating an RLF, radio resource control (RRC), radio link control (RLC), random access channel (RACH), sounding, or handover states to either a radio link monitoring (RLM) module of the device or a beam failure recovery (BFR) or link recovery (LR) (BFR/LR) module of the device, wherein the RLF status message instructs the RLM module or the BFR/LR module to modify an RLM or BFR/LR operation according to the RLF, RRC, RLC, RACH, sounding, or handover states of a user equipment (UE), the device being either the UE or a network device serving the UE.

30. A method comprising:
receiving a radio link failure (RLF) status message from an RLF module of a device at either a radio link monitoring (RLM) module or a beam failure recovery (BFR) or link recovery (LR) (BFR/LR) module of the device, the RLF status message indicating an RLF, radio resource control (RRC), radio link control (RLC), random access channel (RACH), sounding, or handover states of a user equipment (UE), the device being either the UE or a network device serving the UE; and
performing, by the RLM module or the BFR/LR module, an RLM or BFR/LR operation according to the RLF, RRC, RLC, RACH, sounding, or handover states.

31. A device comprising:
a processor; and
a non-transitory computer readable storage medium storing programming for execution by the processor, the programming including instructions to:
receive a radio link failure (RLF) status message from an RLF module of a device at either a radio link monitoring (RLM) module or a beam failure recovery (BFR) or link recovery (LR) (BFR/LR) module of the device, the RLF status message indicating an RLF, radio resource control (RRC), radio link control (RLC), random access channel (RACH), or RACH, sounding, handover status of a user equipment (UE), the device being either the UE or a network device serving the UE; and
perform, by the RLM module or the BFR/LR module, an RLM or BFR/LR operation according to the RLF, RRC, RLC, RACH, sounding, or handover states.
